(19) United States
(12) Patent Application Publication
(10) Pub. No.: US 2025/0004822 A1
(43) Pub. Date: Jan. 2, 2025

(54) Make automatically workable or generating code for Service Worker, replication and rules based web app and suggesting, installing, invoking & managing Progressive Web Apps (PWAs)

(71) Applicant: Yogesh Rathod, Mumbai (IN)

(72) Inventor: Yogesh Rathod, Mumbai (IN)

(21) Appl. No.: 18/689,412

(22) PCT Filed: Sep. 11, 2022
(86) PCT No.: PCT/IB2022/058544

§ 371 Date: Mar. 5, 2024

(30) Foreign Application Priority Data
Sep. 12, 2021 (WO) PCT/IB2021/058281

(51) Int. Cl. G06F 9/48

(52) U.S. Cl. CPC G06F 9/48

(57) ABSTRACT

A methods, systems and apparatus for configuring file and data replication models including snapshot, merge, transactional, one-way (client to server/server to client) publications and subscriptions for different types of strategies and rules for caching and fetching of resources related to particular web app. Other important invention is generating code and component for service worker based on use provided visual configuration settings for caching and fetching strategies and rules and associated values for selected parameters. Other important invention is based on plurality types of user related data from plurality of sources including linked sources and plurality types of user actions and indication of requirements, displaying or automatically installing service worker/replication worker enabled web app(s).

### FIELD OF INVENTION

The present invention relates generally to enabling custom program-less replication worker for synchronizing files and data based on snapshot, one-way, merge files and data replication models and pull and push subscriptions for caching static content and dynamic data based on defined or updated caching strategies and rules, receiving request and sending response from cache or network as predefined replication models and caching strategies in configuration file. Another important invention is enabling developer users to make Service Worker of Progressive Web Apps (PWAs) to work automatically or automatically generating code for Service Worker of Progressive Web Apps (PWAs) based on a visual interface for articulating cache strategies, user provided values for selected parameters and settings. The invention also related to suggesting, installing or automatically installing or invoking Progressive Web Apps (PWAs) based on plurality types of user related data from plurality sources. The invention is also related to intelligently, programmatically or automatically synchronizing from server web app related resources and dynamic data based on snapshot, merge, transactional, pull, push and rule & schedule based synchronization models to make web apps work offline and load faster.

### BACKGROUND OF THE INVENTION

A progressive web application (PWA) is a type of application software delivered through the web, built using web technologies including HTML, CSS and JavaScript. It is intended to work on any platform that uses a standards-compliant browser, including both desktop and mobile devices. Since a progressive web app is a type of webpage or website known as a web application, they do not require separate bundling or distribution. Developers can just publish the web application online, ensure that it meets baseline “installability requirements”, and users will be able to add the application to their home screen. Publishing the app to digital distribution systems like Apple App Store or Google Play is optional. A web application is considered a PWA if it satisfies “installability criteria” and thus can work offline and can be added to device home screen. To meet this definition, all PWAs require a minimum of a service worker and a manifest. Some progressive web apps use an architectural approach called the App Shell Model. In this model, service workers store the Basic User Interface or “shell” of the responsive web design web application in the browser's offline cache. This model allows for PWAs to maintain native-like use with or without web connectivity. This can improve loading time, by providing an initial static frame, a layout or architecture into which content can be loaded progressively as well as dynamically.

A service worker is a web worker that implements a programmable network proxy that can respond to web/HTTP requests of the main document. It is able to check the availability of a remote server and to cache content when that server is available, and serve that content later to the document. Service workers, like any other web workers, work separately from the main document context. Service workers can handle push notifications and synchronize data in the background, cache or retrieve resource requests, intercept network requests and receive centralized updates independently of the document that registered them, even when that document is not loaded. Service workers essentially act as proxy servers that sit between web applications, the browser, and the network (when available). They are intended, among other things, to enable the creation of effective offline experiences, intercept network requests and take appropriate action based on whether the network is available, and update assets residing on the server. They will also allow access to push notifications and background sync APIs.

Service worker syntax is more complex than that of AppCache, but service workers use JavaScript to control AppCache-implied behaviors with a fine degree of granularity, allowing it to handle this problem and many more. Using a Service worker it's possible to easily set an app up to use cached assets first, thus providing a default experience even when offline, before then getting more data from the network (commonly known as Offline First). This is already available with native apps, which is one of the main reasons native apps are often chosen over web apps.

To make PWA by using service worker APIs and related Push & Sync. APIs, developers need to think of different types of strategies, patterns and architectures and write complex program code. It will take a good amount of time, money and energy.

Data replication (e.g., Microsoft™ SQL Data Replication) including snapshot, merge, transactional publication and pull and push subscriptions enables synchronization of data and File synchronization enables one-way or merge file synchronizations.

Present invention enables developers to visually select, draw, edit, update, test, manage one or more strategies, patterns and architecture of caching and fetching resources and based on visually or wizard-based configuration of caching and fetching strategies, rules, architecture and patterns, enabling to fully or semi automatically generating code of service worker, wherein generating code based on service worker APIs, Cache API, Fetch API, Push API, Sync. API and other Web APIs. User is enabled to generate, edit, test, manage code and publish web apps.

Alternatively present invention also enables developers to use program less i.e., settings, wizard and configuration-based service worker or replication worker or data and file replication and rules based static content and dynamic data fetching and caching from/to local storage, server and one or more sources, requesting and responding cached resources for rendering web page or, app page or interface.

Installing a progress web app is very fast (within a few seconds). Progress web app is associated with or accessible via uniform resource locator (URL). Present invention enables mass installation of progress web apps, wherein suggesting to each user, contextual progress web apps based on customers databases of entities, user related data from plurality of source, identification of entities and associated progress web apps.

Therefore, it is with respect to these considerations and others that the present invention has been made.

### OBJECT OF THE INVENTION

The principal object of the present invention is to generate service worker code based on wizard base configuration of or visually drawing, visually describing or selecting of models, strategies, patterns, architecture, rules, selecting of parameters and providing values of parameters for fetching, caching, requesting, responding resources, content, data. Service workers receive requests and respond to requests via program logic which includes said generated code or edited generated code. Based on strategies and rules Service Worker fetch and cache resources or raw data or content or files from local storage of client device or server or server database or one or more sources.

Another main objective of the present invention is to enable to configure data replication and file synchronization including snapshot, merge, transactions publications, pull and push subscriptions, associate schedules, settings and rules and configure file synchronization including one-way or two-way or merge files synchronization, pull or push files or data from client to server or source(s) or server or source(s) to client. Client-side replication component and server-side replication component behaves as per said configuration and enables retrieving, fetching, caching, processing, storing files and data. Client-side replication component receives request and respond request or send response based on local cached raw content or files and data in local storage of user client device, fetch and cache content from one or more sources including server or server storage or folder or directory and database based on configured or automatically determined or selected rules and strategy for caching and fetching resources.

Another main objective of the present invention is to mass installation of progressive web apps (PWAs) or web apps based on user mediated search, match, selections and selections via displayed suggested PWAs based on suggesting or automatically installing PWAs based on user related plurality types of data including user profile, logged user activities, actions, transactions, keywords, digital activities including visiting websites, installing or using applications, received messages, emails, communications, collaborations, sharing, interactions, participations, reactions, user actions or call-to-actions, conducted one or more type of transactions at/in/from/via one or more sources, locations including home or office address, interacted entities, visited or liked or bookmarked places and linked system or database, customer, clients, guests, patients, viewers, visitors databases of entities including brands, companies, shops, college, schools.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” requests, responses, retrieved or fetched resources, contents, and data from a device or component includes receiving the requests, responses, retrieved or fetched resources, contents, and data indirectly, such as when forwarded by one or more other devices or components. Similarly, “sending” requests, responses, retrieved or fetched resources, contents, and data to a device or component includes sending the requests, responses, retrieved or fetched resources, contents, and data indirectly, such as when forwarded by one or more other devices or components.

As used herein, the term “client application” refers to an application that runs on a client computing device. A client application may be written in one or more of a variety of languages, such as [symbol] C [symbol] , [symbol] C++ [symbol] , [symbol] C# [symbol] , [symbol] J2ME [symbol] , Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards executing an application program in the running environment, the execution of the application program starting a replication logic process and a first presentation process corresponding to a first view interface of the application program; receiving by the replication logic process, request to access uniform resource locator (URLs) or link(s) of first view interface associated content, files and resources or request to access data; retrieving by the replication logic process, requested URL or link or matched URL or link associated data, content and resources including URL or link of first view interface associated data, content and resources or requested data from local storage or from server or one or more sources based on first replication logic configuration settings of the first view interface; storing or updating, by the replication logic process, retrieved requested URL or link or matched URL or link associated data, content and resources including URL or link of first view interface associated data, content and resources or requested data from server or one or more sources based on first replication logic configuration settings of the first view interface; acquiring, in the replication logic process, first interface data of the first view interface; transferring via the running environment, initial first interface data of the first view interface from the replication logic process that generates the initial first interface data based on first replication logic configuration settings of the first view interface to the first presentation process, wherein further comprising: transferring via the running environment, updated data for a portion of the first view interface from the replication logic process to the first presentation process; and rendering in the first presentation process, the first view interface according to the initial first interface data of the first view interface, wherein further comprising: re-rendering, in the first presentation process, the portion of the first view interface according to the updated data for the portion of the first view interface.

In some embodiments acquiring, in the replication logic process, an event that triggers a switching from the first view interface to a second view interface; receiving by the replication logic process, request to access URL or link including URL or link of second view interface associated data, content and resources or request to access data; retrieving by the replication logic process, requested URL or link or matched URL or link associated data, content and resources including URL or link of second view interface associated data, content and resources or requested data from local storage or from server or one or more sources based on second replication logic configuration settings of the second view interface; storing or updating, by the replication logic process, retrieved requested URL or link or matched URL or link associated data, content and resources including URL or link of second view interface associated data, content and resources or requested data from server or one or more sources based on second replication logic configuration settings of the second view interface; acquiring, in the replication logic process, second interface data of the second view interface; transferring, via the running environment, the second interface data of the second view interface from the replication logic process to a second presentation process corresponding to the second view interface, the execution of the application program in the running environment starting the second presentation process after the first presentation process starts; and rendering, in the second presentation process, the second view interface according to the second interface data of the second view interface.

In some embodiments acquiring, in the running environment, generated global replication logic configuration settings of the application program based on a program identifier of the application program; starting, in the running environment, the logic process and the first view process according to the generated global replication logic configuration settings of the application program; registering, in the logic process, the first generated replication logic configuration settings of the first view page when the logic process of the application program starts; acquiring, in the logic process, the initial first page data of the first view page, according to the generated first replication logic configuration settings, after completion of an initialization in the first view process; and sending, via the running environment, the initial first page data of the first view page, from the logic process to the first view process corresponding to the first view page.

In some embodiments starting, in the running environment, the logic process according to a generated global replication logic configuration settings in the generated global replication logic configuration settings of the application program; and starting, in the running environment that is provided by the execution of the application program, the first view process according to a global feature of the first view page that is defined by generated global page replication logic configuration settings of the application program, the generated global page replication logic configuration settings defining global features for view pages of the application program.

In some embodiments identifying domain or website uniform resource locator (URL) specific static contents and dynamic data; applying configured one or more types of file and data replication and synchronization models and associated rules related to static contents and dynamic data; receiving and storing static contents in key (request) and values (response) form and dynamic data; receiving request, by the client component, to access uniform resource locator (URL) or link specific web page; identifying, by the client component, requested URL or link specific static contents and dynamic data; generating web page based on requested URL or link specific identified static contents and dynamic data; and rendering web page.

In some embodiments generating code including generating code for Service Worker comprising: identifying any types of digital contents or data including selected or automatically identified static contents and dynamic data related to web app for fetching and caching; accessing defined fetching and caching strategy, rules, patterns related visual program including parameters associated values and data replication models related configuration settings; generating code based on defined fetching and caching strategy, rules, patterns related visual program including parameters associated values and data replication models related configuration settings; and generating file including Service Worker JavaScript file based on generated or edited code.

In some embodiments, it is possible to edit and merge different generated codes related to different defined fetching and caching strategy, rules, patterns related visual programs including parameters associated values and data replication models related configuration settings.

In some embodiments registering a service worker; in the event of installing a service worker, executing said file associated code; based on executed code, accessing or retrieving cached or fetching and caching static contents and dynamic data from client, server or other one or more sources.

In some embodiments receiving from visual graphical user interface, configuration of caching and fetching of contents and data rules, settings and associated values for selected parameters; generating code for program logic process based on received configuration of caching and fetching of contents and data rules, settings and associated values for selected parameters; executing an application program in the running environment, the execution of the application program starting a program logic process and a first presentation process corresponding to a first view interface of the application program; receiving by the program logic process, request to access URL or link including URL or link of first view interface associated data, content and resources or request to access data; retrieving by the program logic process, requested URL or link or matched URL or link associated data, content and resources including URL or link of first view interface associated data, content and resources or requested data from local storage or from server or one or more sources based on first program logic code of the first view interface; storing or updating, by the program logic process, retrieved requested URL or link or matched URL or link associated data, content and resources including URL or link of first view interface associated data, content and resources or requested data from server or one or more sources based on first program logic code of the first view interface; acquiring, in the program logic process, first interface data of the first view interface; transferring via the running environment, initial first interface data of the first view interface from the program logic process that generates the initial first interface data based on first program logic code of the first view interface to the first presentation process, wherein further comprising: transferring via the running environment, updated data for a portion of the first view interface from the program logic process to the first presentation process; and rendering in the first presentation process, the first view interface according to the initial first interface data of the first view interface, wherein further comprising: re-rendering, in the first presentation process, the portion of the first view interface according to the updated data for the portion of the first view interface.

In some embodiments receiving from visual graphical user interface, configuration of caching and fetching of contents and data rules, settings and associated values for selected parameters; generating code for program logic process based on received configuration of caching and fetching of contents and data rules, settings and associated values for selected parameters; acquiring, in the program logic process, an event that triggers a switching from the first view interface to a second view interface; receiving by the program logic process, request to access URL or link including URL or link of second view interface associated data, content and resources or request to access data; retrieving by the program logic process, requested URL or link or matched URL or link associated data, content and resources including URL or link of second view interface associated data, content and resources or requested data from local storage or from server or one or more sources based on second program logic code of the second view interface; storing or updating, by the program logic process, retrieved requested URL or link or matched URL or link associated data, content and resources including URL or link of second view interface associated data, content and resources or requested data from server or one or more sources based on second program logic code of the second view interface; acquiring, in the program logic process, second interface data of the second view interface; transferring, via the running environment, the second interface data of the second view interface from the program logic process to a second presentation process corresponding to the second view interface, the execution of the application program in the running environment starting the second presentation process after the first presentation process starts; and rendering, in the second presentation process, the second view interface according to the second interface data of the second view interface.

In some embodiments acquiring, in the running environment, generated global configuration codes of the application program based on a program identifier of the application program; starting, in the running environment, the logic process and the first view process according to the generated global configuration codes of the application program; registering, in the logic process, the first generated logic code of the first view page when the logic process of the application program starts; acquiring, in the logic process, the initial first page data of the first view page, according to the generated first logic code, after completion of an initialization in the first view process; and sending, via the running environment, the initial first page data of the first view page, from the logic process to the first view process corresponding to the first view page.

In some embodiments starting, in the running environment, the logic process according to a generated global logic code in the generated global configuration codes of the application program; and starting, in the running environment that is provided by the execution of the application program, the first view process according to a global feature of the first view page that is defined by generated global page configuration codes in the generated global configuration codes of the application program, the generated global page configuration codes defining global features for view pages of the application program.

In some embodiments generating replication configuration file or component for Replication Worker comprising: identifying any types of digital contents or data including selected or automatically identified static contents and dynamic data related to web app for fetching and caching; accessing fetching and caching strategies, rules, patterns, visual program configuration settings including parameters associated values and fetching and caching strategy and rule or visual program associated defined files and data replication models; and generating configuration file based on fetching and caching strategies, rules, patterns, visual program configuration settings including parameters associated values and fetching and caching strategy and rule or visual program associated defined files and data replication models.

In some embodiments monitoring, tracking and accessing user related plurality types of data provided by user or from connected or linked sources; identifying keywords from user related data based on web apps related data and identifying user actions from one or more sources including connected or linked sources; identifying identified keywords and user actions related web apps; displaying identified web apps; enabling to select and add web apps from displayed web apps; and in the event of identification of invoking of web app(s) or selecting web app(s) from added web app(s), automatically installing and opening web app(s) from one or more sources.

In some embodiments in the event of identification of receiving of selections, keywords, search query for web app(s) or feature(s) of web app(s) or triggering of triggers or receiving of event or executing of rules or identification of user action(s) including call-to-action(s), transaction, communication, sharing, participation, location or place, voice, scan of code or object(s) or identification of status, displaying related web apps for installation or automatically installing and opening service worker or replication worker enabled web app(s) from one or more sources.

In some embodiments in the event of identification of triggering of triggers or events for instructing uninstalling web apps, automatically uninstalling or removing web apps, wherein triggers comprises detection of requirement of storage or short storage as per set threshold of storage, non-opening of web app for pre-set duration of time, identification of pre-set number of times of usage, identification of inappropriate, reported or spam web applications.

In some embodiments, in the event of selecting a web app, installing a web app and in the event of closing the web app, automatically uninstalling the web app.

In some embodiments the graphical user interface (GUI) comprising: loading first opened web application in first tab and loading second opened web application in second tab; in the event of selection of first tab, display first tab associated first application; loading first feature of first web application in first tab and loading second feature of first web application in second tab; in the event of selection of first tab, display first tab associated feature of first application and in the event of selection of second tab, display second tab associated feature of first application; in the event of selection of second tab, display second tab associated second application; loading second feature of second web application in first tab and loading second feature of second web application in second tab; in the event of selection of first tab, display first tab associated feature of second application and in the event of selection of second tab, display second tab associated feature of second application; and in the event of selecting name or icon or list item or one or more types of control or inputting or selecting uniform resource locator (URL) or web address, loading and opening or invoking associated web application in associated tab in parent application or app browser.

In some embodiments the graphical user interface (GUI) comprising: loading first opened or identified feature of first web application in first tab and loading second opened or identified feature of second web application in second tab; and in the event of selection of first tab, display first tab associated first feature of first application and in the event of selection of second tab, display second tab associated second feature of second application.

In some embodiments the graphical user interface (GUI) comprising: in the event of selection of first application or first feature of first application, loading and displaying first application or first feature of first application in parent interface; in the event of selection of second application or second feature of second application, unloading currently displayed first application or first feature of first application and loading selected second application or second feature of second application in parent interface; and in the event of selection of first application or first feature of first application, unloading currently displayed second application or second feature of second application and loading and displaying first application or first feature of first application in parent interface.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be employed in a system implementing the invention;

FIG. 3 shows one embodiment of a network device that may be employed in a system implementing the invention;

FIG. 4 illustrates exemplary graphical user interface (GUI) for preparing list of files for adding to cache via file manager, generating Manifest file based on form, providing settings, creating data replication for service worker, preparing web app package and publishing management for publishing package on developer or publisher or provider server 135/145;

FIGS. 5A and 5B illustrates service worker lifecycle flowcharts describing registering and installing service worker related generated code file and component and in the event of installation, copying or installing web app package files at client side and in the event of activation of service worker, receiving request to access cached or network resources based on pre-defined strategies in generated or edited service worker related code or compiled custom component;

FIGS. 6-20 illustrates exemplary graphical user interface (GUI) for designing, visualizing, drawing, visually preparing different types of custom or selected template based caching strategies and based on caching strategies and rules diagrams or flowchart or concept map and associated selected parameter(s) associated values provided by user, dynamically and automatically generating code or program or instructions or generating component (program less) for enabling service worker component to cache, fetch and respond as per said generated or edited generated or component. In another embodiment caching strategy specific generating or updating configuration file for replication worker;

FIG. 21 illustrates a service worker can either load requested resources from the cache storage or fetch them through the online network according to the network conditions. These programmable interfaces dramatically improve the online and offline browsing experiences of Web application users;

FIGS. 22A, 22B and 23 illustrates files synchronization and data replication models, topology and architecture, the principal components of snapshot replication, the components used in merge replication and transactional replication;

FIGS. 24-25 illustrates various types of caching strategies for replication worker;

FIG. 26 illustrates a replication worker can either load requested resources from the cache storage or fetch them through the online network according to the network conditions. These programs less interfaces dramatically improve the online and offline browsing experiences of Web application users;

FIGS. 27A and 27B illustrates replication worker lifecycle flowcharts describing registering and installing replication worker related generated program less configuration file and in the event of installation, copying or installing web app package files (from developer or publisher or provider server 135/145) at client side and in the event of activation of replication worker, receiving request to access cached or network resources based on pre-defined strategies defined in generated or edited generated replication worker related custom configuration file;

FIG. 28 illustrating Service Worker/Replication Worker based Web App or PWA/Mini App Internal Architecture;

FIGS. 29-31 illustrating exemplary graphical user interface for wizard, enabling user to provide plurality types of data or receiving and logging user related data plurality types of data from plurality of sources including linked or connected systems, databases, networks, applications, servers, web sites;

FIG. 32 illustrates graphical user interface for service worker (SW) or replication worker (RW) enabled web apps or progressive web apps store, wherein user can search, view details, select from categories directors, access, select and install web apps/PWAs from suggested or updates list of web apps/PWAs and can a mange, filter sort, order, uninstall, upgrade and set auto uninstall and auto update settings. User can manually create various types of lists or categories of web apps/PWAs including service worker/replication worker enabled web apps/PWAs and can install later or at the time of first click or tap on name or icon or control of web app/PWA or selection of one or more web apps/PWAs, automatically in background download, install, update said selected web apps/PWAs.

FIG. 33 illustrates graphical user interface for automatically displaying current location, current location associated place, current location associated place associated one or more types of activities, identification of current prospective transaction, search queries, current interacted entities, user device surround connected or related users, user voice, voice command scanned object or code including QR code, identified user activity(ies), status, incoming one or more types of communications including identified incoming phone call or voice call, SMS, message, email associated service worker or replication worker enabled web apps or progressive web apps (PWAs) and features, actions of service worker or replication worker enabled web apps or progressive web apps (PWAs).

FIGS. 34 (A) and 34 (B) illustrating identifying contextual service worker or replication worker enabled web apps or progressive web apps (PWAs) for each user and on demand install web apps or PWAs.

FIGS. 35 (A)-(F) and 36 (A)-(F) illustrating suggesting to install or automatically downloading and installing web app(s)/PWA(s) based on identifying or triggering of events or triggers or rules detection of installing or uninstalling of native applications, visiting of websites, scanning QR code, user device surround voice, voice command, user device surround connected or related users, visited places, interacted entities, conducted transactions, inputting uniform resource locator (URL), taking of photos, viewing videos, reading content, web pages, blogs, receiving communications, network strengths, identification of customers, subscribers, viewers, members, interests, taking of call-to-actions, participations, locations, sharing or receiving of contents.

FIG. 37 illustrates service worker or replication worker enabled web apps or progressive web apps (PWAs) browser and web apps or PWAs store and management of web apps or PWAs for enabling user to open web app or PWA or feature or page of web app or PWA via uniform resource locator (URL).

### DETAILED DESCRIPTION OF THE DRAWINGS

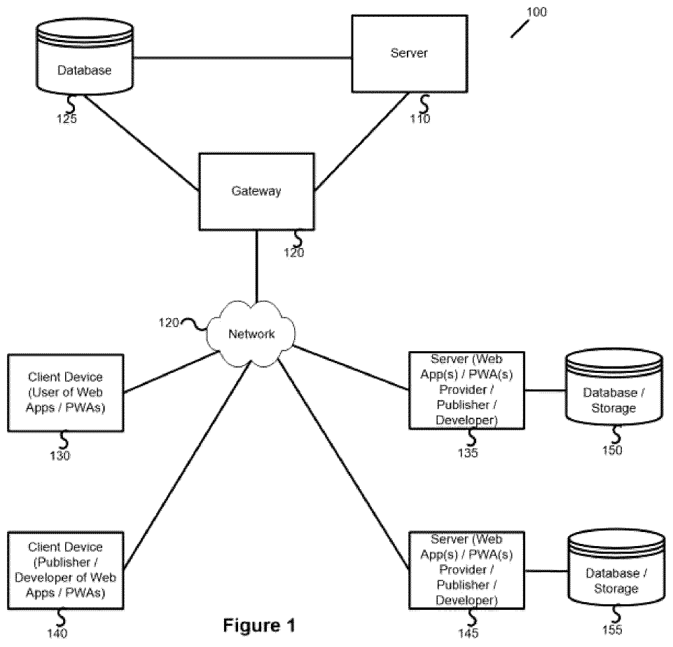

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes a client device, in particular mobile device 130 and 140. The system also includes network or wireless network 120, central server 115, storage/database 125, servers of service worker or replication worker enabled web apps or progressive web apps (PWAs) publishers or providers or developers 135/145.

A variety of client devices may be employed in accordance with the invention. The client devices may include mobile devices, digital home clients such as personal computers and media centers, and other client devices. Generally, mobile device 135 may include virtually any portable computing device capable of receiving and sending a message over a network, such as network 120, or the like. Mobile devices 130/140 may also be described generally as a client device that is configured to be portable. Mobile device 130/140 may have the capability of connecting to a network using wireless technology, wired technology, or a combination of both wired and wireless technologies. Thus, mobile device 130/140 may include virtually any portable computing device capable of connecting to another computing device and receiving information. Such devices include portable devices such as smart phones, handheld computers, sensors, laptop computers, wearable computers, tablet computers, smart watches, integrated devices combining one or more of the preceding devices, and the like. As such, mobile device 130/140 typically ranges widely in terms of capabilities and features.

A web-enabled mobile device may include a browser application (enabled by service worker) that is configured to receive and to send web pages, web-based messages, and the like. The browser application may be configured to receive and display graphics, text, video, multimedia, and the like, employing virtually any web-based language or protocol, including Cascade Style Sheet (CSS), HyperText Markup Language (HTML), JavaScript extensible Markup Language (XML), Web API, Service Workers API, Cache API, Fetch API, Push API, Sync. API, IndexedDB API and the like, to enable publishing, searching, sharing, downloading, installing, updating service worker enabled web apps and progressive web applications (PWAs).

Mobile device 130/140 may include one or more other client applications that are configured to receive content from another computing device. The client application may include a capability to provide and receive textual content, graphical content, audio content, video content, and the like. The client application may further provide information that identifies itself, including a type, capability, name, and the like. In one embodiment, mobile device 130/140 may uniquely identify itself through any of a variety of mechanisms, including a phone number, Mobile Identification Number (MIN) or mobile subscription identification number (MSIN) or international mobile subscriber identity (IMSI), or other mobile device identifier. The information may also indicate a content format that the mobile device is enabled to employ. Such information may be provided in a message, or the like, sent to central server 115 or other computing devices.

Mobile device 130/140 may also be configured to communicate a message, such as through Short Message Service (SMS), Multimedia Message Service (MMS), instant messaging (IM), internet relay chat (IRC), Jabber, and the like, between another computing device, such as central server 115, another web server, or the like. However, the present invention is not limited to these message protocols, and virtually any other message protocol may be employed.

Mobile device 130/140 may be further configured to enable a user to participate in communications sessions, such as IM sessions. As such, mobile device 130/140 may include a client application that is configured to manage various actions on behalf of the client device. For example, the client application may enable a user to interact with the browser application, email application, IM applications, SMS application, and the like. Generally, instant messaging provides the ability for at least two computing devices to exchange messages in real time.

Mobile devices 130/140 may further be configured to include a client application that enables the end-user to log into an end-user account that may be managed by a network application. Such an end-user account, for example, may be configured to enable the end-user to publish, register, list, download, install, manage, register, log-in web applications or PWAs, receive emails, send/receive IM messages, SMS messages, and access selected web pages, maintain a digital wallet, or the like.

Network 120 is configured to couple mobile device 130/140, as well as other client devices not illustrated, and their components, with other network devices, such as central server 115, and the like. Network 120 is configured to couple responder client devices including mobile phone 130/140 with central server 115.

Though for illustrative purposes network and wireless network are shown combined, in various environments employing the present invention, network and wireless network 120 may be the separate or same network, different networks, or different networks including a combination of overlapping components and distinct components. The discussion herein that describes network 120 may therefore be applicable to describe network 120.

Network 120 may include any of a variety of wired or wireless sub-networks that may further overlay stand-alone ad-hoc networks, and the like, to provide an infrastructure-oriented connection for mobile device 135. Such sub-networks may include mesh networks, Wireless LAN (WLAN) networks, cellular networks, and the like. Additionally, network 120 may connect to mobile devices with a wired connection, such as cable, phone lines, Ethernet wires, and the like. Network 120 may include wide area networks, such as the Internet. The invention may be used either generally with networks, specifically with wireless networks, or with various combinations of wireless and wired networks.

Network 120 may further include an autonomous system of terminals, gateways, routers, and the like connected by wireless radio links, and the like. These connectors may be configured to move freely and randomly and organize themselves arbitrarily, such that the topology of network 120 may change rapidly.

Network 120 may further employ a plurality of access technologies including 2nd (2G), 3rd (3G), 4th (4G) and 5th (4G) generation radio access for cellular systems, WLAN, Wireless Router (WR) mesh, and the like. Access technologies such as 2G, 3G, 4G, 5G and future access networks may enable wide area coverage for mobile devices, such as mobile devices 130/140 with various degrees of mobility. For example, network 120 may enable a radio connection through a radio network access such as Global System for Mobile communication (GSM), General Packet Radio Services (GPRS), Enhanced Data GSM Environment (EDGE), Wideband Code Division Multiple Access (WCDMA), and the like. In essence, network 120 may include virtually any communication mechanism by which information may travel between mobile device 130/140 and another computing device, network, and the like.

Network 120 may further include or employ one or more network gateways (not shown) that serve as intermediaries between mobile device 130/140 and other network devices, such as central server 115. A network gateway may receive data from a device or network, transform the data, and forward the data to another device or network. A network gateway may perform a transformation in more than one direction. Transformation may, for example, include modifying protocols or communications mechanisms in order to facilitate communication between two devices or two networks, each of which may employ different protocols. A WAP gateway is one type of network gateway. A WAP gateway may facilitate communication between a first device that uses the Wireless Application Protocol (WAP), and a second device. The second device may, for example, communicate using the HyperText Transfer Protocol Secure (HTTPs). An SMS gateway is a network gateway that facilitates communication between a device using the Short Message Service (SMS) protocol and another device, such as one using HTTP. A WAP/Wireless Internet Protocols and SMS gateway combines the features of a WAP/Wireless Internet Protocols gateway and an SMS gateway.

In one embodiment, network 120 may include one or more components and service that operates to facilitate or enable publish, upload, register, list, search, match, select, register, upload, host, store, process, download, install, subscribe, attach, update, upgrade, share, present and access service worker or newly introduced in this invention replication worker enabled web applications and progressive web applications (PWAs) from plurality of providers 135/145 to client devices including mobile devices and smart device 130/140 and central server 115.

FIG. 1 shows mobile device 130/140 communicating with central server 115, and central server 115 may communicating with Web apps/PWAs Providers Server(s) 135/145. FIG. 1 also shows central server 115 communicating with client devices 130/140. Each of these communications may employ a direct connection, or one or more networks, or a combination thereof. For illustrative purposes, FIG. 1 shows communication between central server 115 and Providers Server(s) 135/145 employing network 120, however environments that include this communication may be employed with the present invention. In particular, central server 115 and Providers Server(s) 135/145 may employ any one or more of direct communication, a local area network, or a wide area network, such as network 120.

A network enabling any one or more of the above communications may employ any form of computer readable media for communicating information from one electronic device to another. Also, the network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the network includes any communication method by which information may travel between central server 115, Providers Server(s) 135/145, and Developers, Sponsors, Advertisers, client devices 130/140, and other computing devices (not shown).

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Client devices 130/140 are computing devices that may be employed by a user, referred to as a user and provider developer or publisher of web apps/PWAs, receiver and sharing user, for receiving and sharing web apps/PWAs. A variety of user and provider developers or publishers of web apps/PWAs and sender and/or receiver client devices may be employed in accordance with the invention. Client devices may include smart devices, mobile devices, digital home clients such as personal computers, laptops, tablets, digital watch and media centers, and other client devices. Generally, clients may include virtually any computing device, portable or non-portable, capable of publishing, listing, registering, searching, downloading, installing web apps/PWAs 243, receiving and sharing link or uniform resource locator (URL) of web apps/PWAs, over a network, such as network 120, or the like. Clients may include devices such as mobile device 130/140 described herein. Though FIG. 1 illustrates only few Clients 130/140, it is envisioned that the invention may be practiced in an environment that includes a large community of sender and receiver clients. Thus, sender and receiver clients may number in the hundreds, thousands, hundreds of thousands, millions, or virtually any number.

Though FIG. 1 illustrates an embodiment of a system having each of the network central server(s) 115 and Providers Server(s) 130/140 as separate computing devices, the invention is not so limited. Software, hardware, or hardware-software combinations implementing any portion of these components may be combined with any other component on a single computing device, or arranged in a different manner among multiple computing devices. Some portion or all of the functionality of any component may be distributed or duplicated among multiple computing devices.

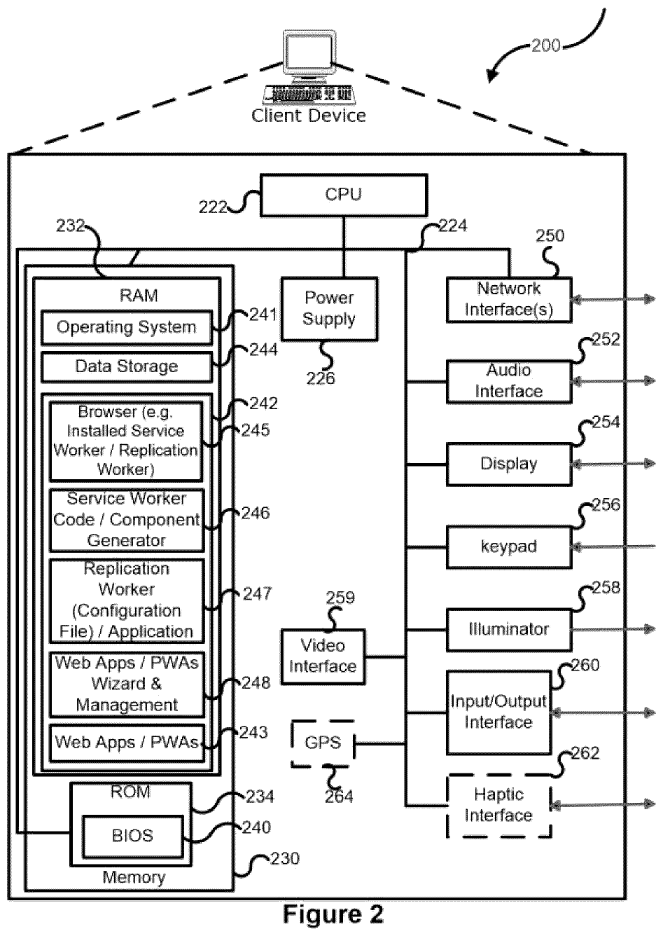

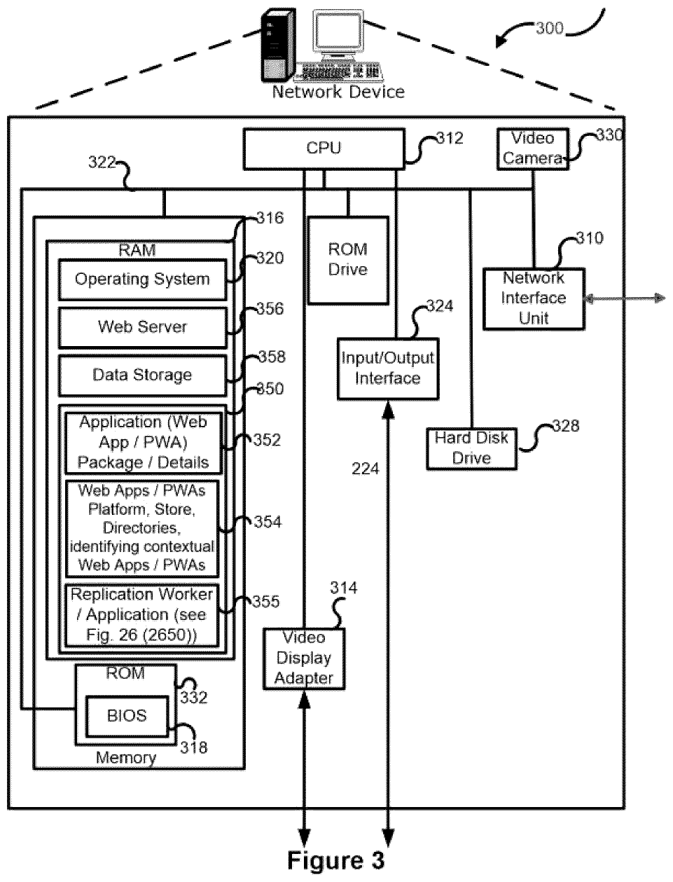

One embodiment of a network device that may be used to implement any one or more of central server 115 or Providers Server(s) 130/140 is described in more detail below in conjunction with FIG. 3. Briefly, however, such network devices may include any computing device capable of communicating with other network devices to enable network applications or web sites to process, send and respond to requests from client devices, such as mobile device 130/140 is described in more detail below in conjunction with FIG. 2. Devices that may operate as these network devices include personal computers, desktop computers, multiprocessor systems, microprocessor-based or programmable consumer electronics, network PCs, servers, and the like, or any combination thereof.

FIG. 1 illustrates an embodiment in which mobile device 130/140 communicates with central server 115. A user of mobile device 130/140, referred to as a user/publisher or developer or provider of web apps/PWAs, may employ mobile device 130/140 to upload, register, list, publish generated code/component of service worker or replication worker enabled web apps/PWAs to central server 115. Central server 115 may receive and process the web apps/PWAs, register and list web apps/PWAs 352 for making them searchable for users of network or browser(s) or operating system (OS) and enabled users of browser or network or OS to search, match, view details, select from categories directories, download, install, update, upgrade, install, uninstall web apps/PWAs 243 from mobile device 130/140. Central server 115 may employ identifiers or addresses of users and publisher devices, or both. It may, for example, employ a login name or email address of a user/publisher or sender and/or receiver. It may employ an IP address, MIN, or other identifier of a device. Central server 115 may employ any one or more of these identifiers or addressing mechanisms when communicating with a user of browsers, web apps, PWAs, publishers or developers or providers of web apps/PWAs or sender and/or receiver device. As used herein, unless the context clearly indicates otherwise, the term “sender” and “receiver” may be used to refer to a person, a device, or a combination of a person and a device.

### Illustrative Client Device

FIG. 2 shows one embodiment of client device 200 that may be included in a system implementing the invention. Client device 200 may include many more or less components than those shown in FIG. 2. Client devices may comprise users of web apps/PWAs 23 and publisher or developer or provider of web apps and PWAs 243. However, the components shown are sufficient to disclose an illustrative embodiment for practicing the present invention. Client device 200 may represent, for example, user client devices 130/140 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), General Packet Radio Service (GPRS), and Enhanced Data Rates for GSM Evolution (EDGE), the 3GPP developed third-generation (3G) UMTS standards, followed by the fourth-generation (4G) LTE Advanced and the fifth-generation 5G standards, code division multiple access (CDMA), “wideband CDMA”, or W-CDMA, as well as TD-CDMA and TD-SCDMA, time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Optional haptic interface 262 is arranged to provide tactile feedback to a user of the client device. For example, the optional haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile devices may, through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® Operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 including browser(s) 245, Service Worker Code/Component Generator 246 Interface, Application & Modules, Replication Worker/Application (Client) 247 and Web Apps/PWAs Wizard & Management 248 Interface, Application & Modules. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store published, uploaded, listed web apps/PWAs (service worker/replication worker enabled) 243, user profile, login information, payment information, contacts and connections 140 or downloaded, installed, updated, upgraded web apps/PWAs (service worker/replication worker enabled) 243, developer profile, listing information, users information 130 or the like, as well as other information including templates, settings, preferences, user related data from one or more sources, or the like. At least a portion of the content/data may also be stored on a disk drive or other storage medium (not shown) within client device 200.

Applications 242 may include computer executable instructions which, when executed by client device 200, transmit, receive, and/or otherwise process including saving, updating, generating custom Service Worker Code/Component, installing custom replication worker an configuration file associated with each corresponding web app/PWA, installing and creating database, creating or opening cache, retrieving, fetching, caching, storing resources, contents, files and data, storing user related plurality types of data and contents.

Applications 242 may further include browser 245. Browser 245 may include virtually any of a variety of client applications configured to download, install service worker, web application and associated resources (copying, synchronizing, caching or storing app shell or required files) 243 from server of web app or web app publisher, receive and/or provide communications of web pages, and other content over a network. Browser 245 typically provides for a graphical display of various web pages, including user interfaces provided, in part, by another computing device over the network. Browser 245 may include a variety of security features, and/or other plug-in applications, modules, applets, scripts, or the like, to enable display of animation, videos, playing of audio files, or the like.

### Illustrative Network Device Environment

FIG. 3 shows one embodiment of a network device 300, according to one embodiment of the invention. The embodiment of network device 300 illustrated in FIG. 3 may be used to storing uploaded, publish web apps and PWAs 352 of developer, publisher, provider (e.g. server 135/145) or listing, making searchable, publishing details of web apps and PWAs (e.g. server 115) for enabling user to select web app(s)/PWA(s) or enter uniform resource locator (URL) and install selected or entered URL associated web app(s)/PWA(s) from associated server or associated developer's or publisher's server which hosting said web app or PWA 352. Network device 300 may include many more components than those shown. It may also have less than all of those shown. The components shown, however, are sufficient to disclose an illustrative embodiment for practicing the invention. One or more network devices, and the application programs integrated with the devices, may be used to implement the processes of the present invention, as illustrated in Figures discussed herein.

In any event, network device 300 includes processing unit 312, video display adapter 314, and a mass memory, all in communication with each other via bus 322. The mass memory generally includes RAM 316, ROM 332, and one or more permanent mass storage devices, such as hard disk drive 328. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology or any other medium which can be used to store the desired information and which can be accessed by a computing device.

The mass memory also stores program code and data. One or more applications 350 are loaded into mass memory and run on operating system 320.

Mass memory further includes web server 356, data stores 358, and applications 350. Applications 350 are shown to include Application including Web App/PWA package or bundles of files 352, Web Apps/PWAs Platform, Store, Directories, identifying contextual Web Apps/PWAs 354 and Replication Worker/Application (Server) 355. Web server 356 (of server 135/145) includes virtually any application configured to deliver Web pages and other content to browsers and other client applications via the HTTP/HTTPs protocol. However, web server 356 may also be configured to provide scripts, user interfaces, accounting interfaces, editors, security, or the like, to the client application. Moreover, web server 356 may employ a variety of other communication protocols, beyond HTTPs. For example, web server 356 may be configured to manage email communication protocols, SMS protocols, IM protocols, or the like. Moreover, web server 356 may employ a variety of scripts, applets, programs, or the like, to enable communications of content with a client application.

Data stores 358 (e.g. server 115) may include any of a variety of storage mechanisms, configured to store details of web app(s)/progressive web app(s) 352 for making web apps and PWAs searchable, enabling users to view details of web apps and PWAs and download and install web app(s)/progressive web app(s) 243 including install service worker, caching required resources, content, files and data from web app(s)/progressive web app(s) provider or publisher or developer's server (e.g. server 135/145). Data stores 358 (e.g., server 135/145) may include any of a variety of storage mechanisms, configured to store packages or files 352 of web app(s)/progressive web app(s) and content, scripts, applets, or the like. As such, data stores 358 may be a database, a file structure, or the like. Data stores 358 may store the content into a category structure, such as folders, albums, graphs, trees, or the like. In one embodiment, data stores 358 may represent the Data Management services illustrated in FIG. 1, and described in more detail below.

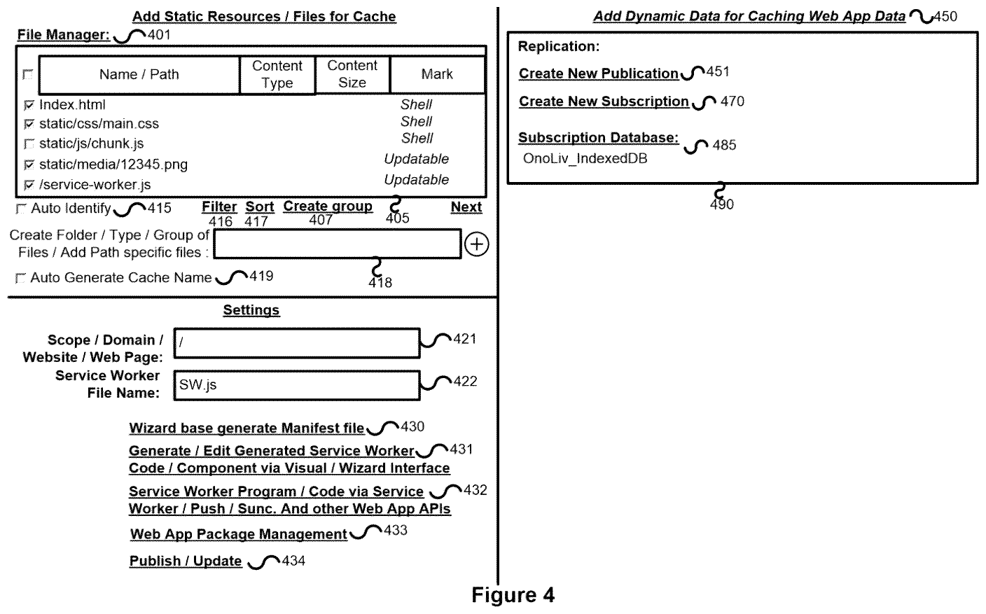

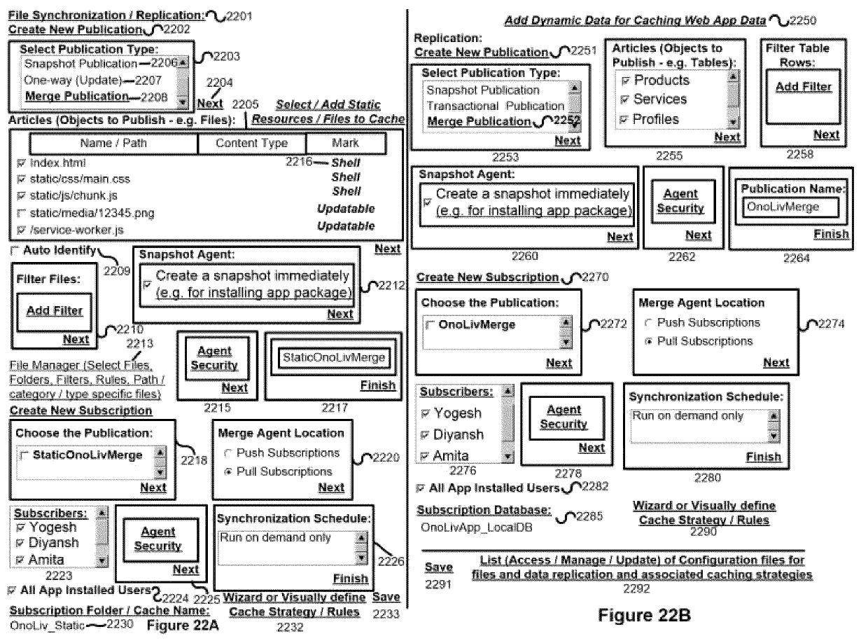

Generating Manifest File, Service Worker code/component related to particular web app or PWA and publishing said web app or PWA 352 based on visualization tools and wizard of user interface is described in more detail below in conjunction with FIGS. 4-21. Configuring custom replication worker for files and data synchronizations and configuring associated rules and strategies is described in more detail below in conjunction with FIGS. 22-28. Service Worker or Replication Worker enabled Web Apps/Progressive Web Apps (PWAs) Platform or Store 354 (115) and various types of logics for identifying contextual web apps or PWAs 354 for each user is described in more detail below in conjunction with FIGS. 29-37. Various embodiments of example user interface screens are described in more detail below.

FIGS. 4-21 illustrates the graphical user interface of Service Worker Code/Component Generator client 140 application 246 for developer user for visually describing, drawing, preparing caching strategy. FIGS. 4-21 showing or providing the most common caching strategies. A caching strategy is a pattern that determines how a service worker generates a response after receiving a fetch event. Service workers are at the core of PWA techniques for resource-caching and push notifications. Caching provides a mechanism for storing request/response object pairs in the browser. FIGS. 4-21 describes few common patterns prepared or drawn by the user or based on a template for caching resources.

By using visualization tool (Service Worker Code/Component Generator client 140 application 246 for developer user) discussed in FIGS. 4-21, user can visually create or draw or edit caching strategies and rules diagrams or flow chart or concept map to implement how script of a service worker or rules or configuration file for replication handles updates to the cache. it offers a wide variety of built-in shapes, logic blocks, types of parameters, values, files selections and like. Visualization tool also provides ready templates of diagrams.

All updates to items in the cache must be explicitly requested. Items will not expire and must be deleted. It's required to periodically purge cache entries. Each browser has a hard limit on the amount of cache storage that a given origin can use. The browser does its best to manage disk space, but it may delete the cache storage for an origin. The browser will generally delete all of the data for an origin or none of the data for an origin. Need to make users to version caches by name and use the caches only from the version of the script that they can safely operate on.

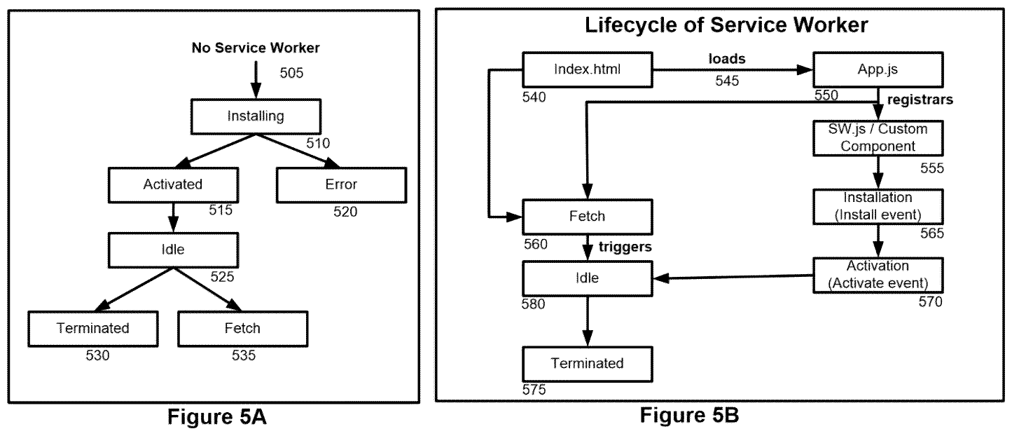

FIG. 5 shows caching files on install, wherein cache sites' static resources in the install event in the service worker. And cache the HTML, CSS, JavaScript, any static files that make up the application's shell, in the install event of the service worker. While the install event is happening, any previous version of service worker is still running and serving pages.

Event.waitUntil takes a promise to define the length and success of the install. If the promise is rejected, the installation is considered a failure, and service workers will be abandoned. If an older version is running, it will be left intact. Caches.open and Cache.addAll returned promises. If any of the resources fail to fetch, the cache.addAll call rejects. There are ways to do this, iterate over the list of keys from the cache, and then delete any caches that don't match the current cache name.

FIG. 4 illustrates graphical user interface for enabling user to use file the manger to search, match, sort, filter, select category specific files including App Shell, select only new or updated files, select date wise files, select type of files, select created group(s) of files or folder(s), and select files and folders. Users can select and add files or folders to cache or for cache. Users can input or enter path or namespace or uniform resource locator (URL) of folder(s) to add all files of folders related to path or namespace or uniform resource locator (URL) of folder(s). In another embodiment, automatically identify and select files or folders of files based on types of files, provided associated indications (e.g., App Shell), size of files, name of files, monitored and tracked past behaviors of files synchronization. Users can further add or remove files from automatically identified files.

User can select generate Web App Manifest option 430 to open form or wizard (not shown in figure) to generate Web App Manifest which is a simple JSON file containing information: name, short_name, description, icons for different device resolution, start_url, display mode, theme color of the application. Users can provide, input or select values of fields related to Web App Manifest via form. Based on filed form (not showing in figure), generating Web App Manifest file. The use of Web App Manifest installs the web app in the user home screen like the native apps. As a result, the user can get quick access and enjoy full-screen display like with the native app.

Like any traditional web application, first, the index.html file loads the app.js file. In the app.js file, to register a Service Worker the developer writes some code and the code exists in a separate JavaScript file. The purpose of the code was to let the client know that the sw.js file is a JavaScript, but does not run immediately as it can be done in other JavaScript files rather than registered as Service Worker in the background. However, to register the Service worker, first, there is a code inside sw.js, which checks whether the browser supports service worker or not.

The service worker installation process begins with the registration of it in JavaScript, which declares the browser where the service worker JavaScript file is registered.

Users can input or select the default service worker script file name 422. System automatically generates service worker registration code and save for later access, edit, packaging and publication:

if (‘serviceWorker’ in navigator) {
window.addEventListener (‘load’, function( ) {
navigator.serviceWorker.register(‘/sw.js’).then(function(registration) {
// Registration was successful
console.log (‘ServiceWorker registration successful with scope: ’, registration.scope);
}).catch(function(err) {
// registration failed :(
console.log(‘ServiceWorker registration failed: ’, err);
}); }); }

Code makes user, whether the service worker API is accessible, and if it is there, the service worker at /sw.js is registered when the page is loaded.

Once the registration process is completed, the browser starts to install the service worker by defining a callback for the install event and setting up an environment to cache the files. During the install event, the service worker caches the static content, and when the caching is successful, the process of activation starts. If the caching process fails, then the activation event gets terminated and the service worker tires to install it in the next attempt.

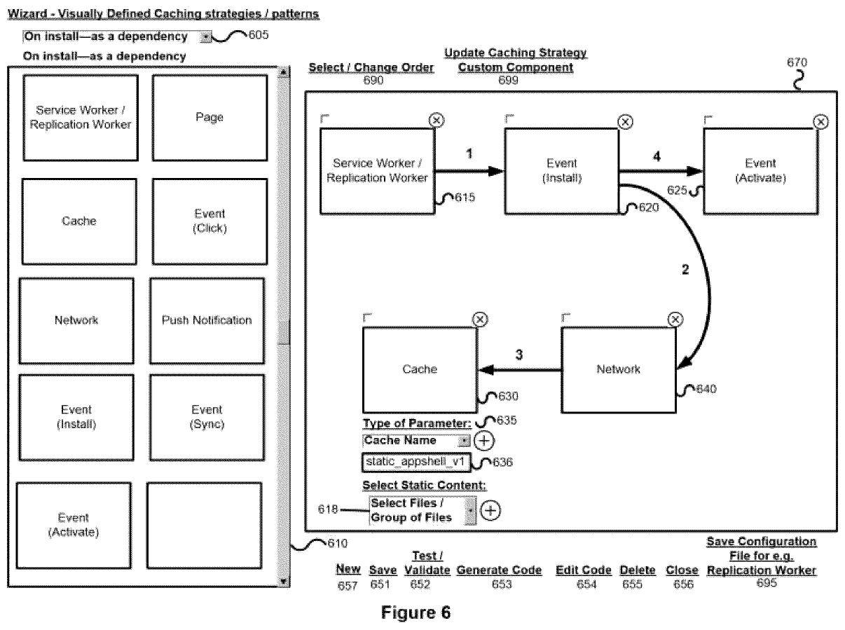

For on-install caching users can define, configure, use or update templates or draw “On install—as a dependency” caching strategy which discuss in detail in FIG. 6.

In an embodiment during installation of service worker, installing and creating local database for pull or push subscriptions of snapshot, merge and transactional publications.

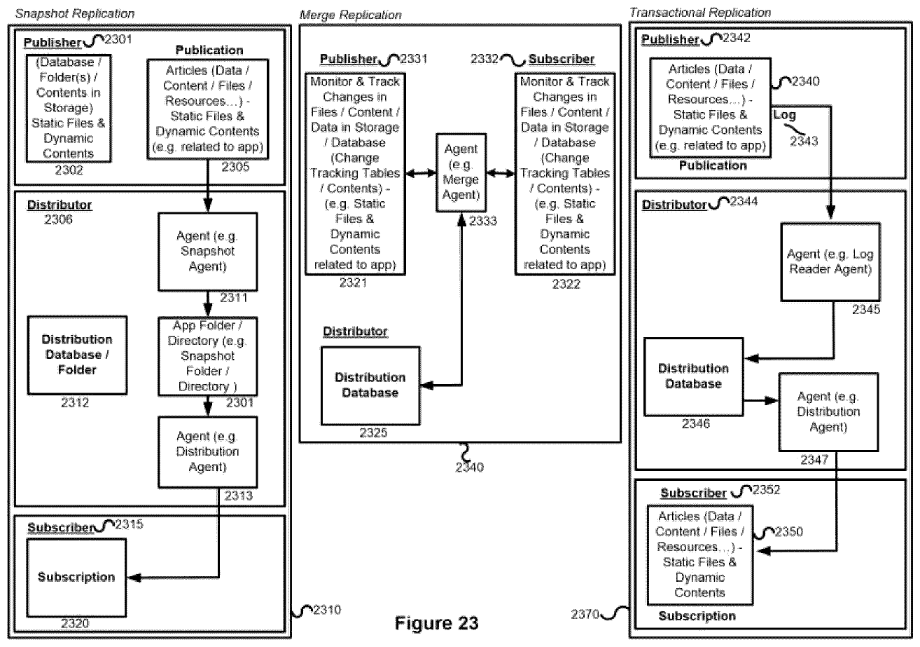

In an embodiment enabling user or admin or developer user to create new or manage or update existing publication 451 including snapshot, merge and transactional publications and create new or manage or update existing subscriptions pull and push subscriptions 470 which discussed in detail in FIGS. 22-23, only change is instead of subscription database 2285 (synchronizing or replicating data relational database of server with local relation database), in this case synchronizing relational database of server with local IndexedDB database.

Indexed Database API, or IndexedDB API, on its own is an API for browsers to support client-side storages. It is a JavaScript application programming interface (API) provided by web browsers for managing a NoSQL database of JSON objects. It allows users to work offline when the network isn't available. An IndexedDB is a persistent data store in the browser, meaning a database on the client side. It allows users to create apps with rich query abilities in both offline and online mode. The core design of IndexedDB API is databases with key-value tables, which are called ObjectStores. However unlike basic localStorage (sessionStorage), caching and other “key-value” alike storage APIs, it supports Indexing, Cursors, Key Generators, and Transactions.

In an embodiment user or admin or developer user can syncing an offline database (IndexedDB) with online relational database by providing or updating values for parameters. System generates code files based on provided values for parameters for synchronization of IndexedDB and SQL Server databases using e.g., ASP.NET Web API.

FIG. 5A illustrates generated or edited code of service worker and service worker registration process. Service workers essentially act as proxy servers that sit between web applications 243, the browser 245, and the network (when available) 120. They are intended, among other things, to enable the creation of effective offline experiences, intercept network requests and take appropriate action based on whether the network is available, and update assets residing on the server. They will also allow access to push notifications and background sync APIs.

A service worker is an event-driven worker registered against an origin and a path 421. It takes the form of a JavaScript file 422, generated and/or by developer or admin or user as discussed in FIGS. 4-20, that can control the web-page/site that it is associated with, intercepting and modifying navigation and resource requests, and caching resources in a very granular fashion to give complete control over how app behaves in certain situations (the most obvious one being when the network is not available).

A service worker is run in a worker context: it therefore has no DOM access, and runs on a different thread to the main JavaScript that powers the app, so it is non-blocking. It is designed to be fully async; as a consequence, APIs such as synchronous XHR and Web Storage can't be used inside a service worker. Service workers only run over HTTPS, for security reasons.

A service worker is first registered using the ServiceWorkerContainer.register( ) method. If successful, service workers will be downloaded to the client and attempt installation/activation (see below) for URLs accessed by the user inside the whole origin, or inside a subset specified by an admin or developer user of a web app or PWA or website.

The service worker is immediately downloaded when a user first accesses a service worker-controlled site/page.

After that, it is updated when a navigation to an in-scope page occurs and an event is fired on the service worker. Installation 510 is attempted when the downloaded file (generated or edited based on wizard or visual user interface as discuss in detail in FIGS. 6-20) is found to be new—either different to an existing service worker (byte-wise compared), or the first service worker encountered for this page/site.

If this is the first time a service worker has been made available, installation 510 is attempted, then after a successful installation, it is activated 515.

If there is an existing service worker available, the new version is installed in the background, but not yet activated—at this point it is called the worker in waiting. It is only activated when there are no longer any pages loaded that are still using the old service worker. As soon as there are no more pages to be loaded, the new service worker activates (becoming the active worker). Activation can happen sooner using Service WorkerGlobalScope.skipWaiting( ) and existing pages can be claimed by the active worker using Clients.claim( ).

It's possible to listen for the install event; a standard action is to prepare service workers for usage when this fires, for example by creating a cache using the built in storage API, and placing assets inside it for running app offline.

There is also an activate devent. The point where this event fires is generally a good time to clean up old caches and other things associated with the previous version of service worker.

Service workers can respond to requests using the FetchEvent event 535. It's possible to modify the response to these requests in any way the user or developer wants, using the FetchEvent.respondWith( ) method.

During the install event 510, service worker caches the static content, and when the caching is successful, the process of activation starts. If the caching process fails, then the activation event gets terminated at 530 and service worker tires to install it in the next attempt. The successful caching and installation process which triggers the activation event. An activated 515 service worker starts to receive fetch 535, push and sync events, when the user maneuvers to a different page.

FIG. 5B illustrates how a Service Worker is registered. Like any traditional web application, first, the index.html file 540 loads 545 the app.js file 550. In the app.js file 550, to register a Service Worker the developer writes some code (generated/edited generated code as discussed in detail in FIGS. 4-21) and the code exists in a separate JavaScript file 555. The purpose of the code was to let the client that the sw.js file 555 is a JavaScript, but does not run immediately as it can be done in other JavaScript files 555 rather registers as Service Worker in the background. However, to register the Service worker, first, there is a code inside sw.js 555, which checks whether the browser supports service worker or not. If the browser supports the API, it registers the sw.js file 555 when the page loaded for the first time. And due to that registration two lifecycle phases are reached. First, the Service Worker will be installed 565 by the client browser and as a result releases an install event, which can evoke to carry out some code inside of the sw.js file 555 and later used to cache static resources. The browser installs a new Service Worker only if there is an update in the existing files or if it is the first time not in every page refresh. Activation 570 event is another event, which is executed as soon as the installation 565 is finished. But not activated immediately instead will be activated depending on the availability of an old version of the Service Worker. If the version of Service Worker running is not old, then it is activated otherwise, closing the existing browser tabs and reopening a new tab installs a new Service Worker. Closing an existing browser tab and reopening a new tab is required to activate the Service Worker since it is not attached to a single page, but to the overall domain or scope and lives, even after the browser is closed. Hence, doing so fires the activate event. After activating the Service Worker, all pages of the given scope will be controlled by the Service Worker.

Once the Service Worker activated, it enters an idle mode 580, which means basically it sits there since Service Worker is a background process handling events and if there is no event coming, it does nothing. Following that, after a time of idling around, it will terminate 575, which does not mean that it is uninstalled or unregistered, but it means it is on sleep mode. A sleeping Service Worker can waken automatically as soon as events are coming in, for instance, a fetch event 560 and all other events. If a fetch event 560 occurs either due to an HTML file requesting a resource or the developer sending a fetch request 560 in the JavaScript code, the Service Worker is woken up and triggers a fetch event 560 and then put back to idle mode 580.

FIG. 6-20 illustrates graphical user interface (GUI) for enabling users to select the type of caching strategy or template of caching strategy e.g. “On install—as a dependency” 670. Users can select, drag and drop one or more blocks or shapes of modules 610 and drop in visual edit area 670 to draw or update diagrams or flowcharts or concept maps related to one or more selected types of caching strategy.

FIG. 6 shows, user can select “New” 657 to create a visual caching strategy diagram or flowchart or concept map. After creating new blank file, User select “Service worker” block 615, “Install (Event)” block 620, “Activate (Event)” block 625, “Network” block 640, “Cache” block 630, draw line between blocks to indicate connections and order, provide values for selected or displayed (suggested) parameter e.g., Cache Name (Parameter or field) and user input values is “static_appshell_v1” and Select Static Content (Parameter or field) and user input values is selected files from FIG. 4 (405). User can also select template of caching strategy (e.g., “On install—as a dependency”) from list 605, which opens template showing ready blocks, connections and order, default values of default relevant selected parameters and enable user to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘install’, function (event) {
event.waitUntil(
caches.open(‘static_appshell_v1’).then(function (cache) {
return cache.addAll([
‘ Index.html’,
‘ static/css/main.css’,
‘ static/css/chunk.css ’,
‘ static/media/12345.png’,
‘ static/media/12345.png’,
]); }), );});

Users can validate and test code by selecting “Validate and test Code” button 652. System runs code against a sample or demo environment. For example, system use demo web app package (on developer or publisher or provider server 135/145) and use said code in service worker script file e.g., “SW.js” in package and Install web app package and show creating of cache and storing or caching of said selected files and show page sending request to service worker for fetching said cached resources from said created cache.

Users can save the generated code 651, edit generated code 654, delete generated code 655.

During the install event 620, service worker 615 caches 630 the static content 618, and when the caching 630 is successful, the process of activation 625 starts. If the caching process fails, then the activation event gets terminated and the service worker tires to install it in the next attempt.

This strategy is useful for e.g., CSS, images, fonts, JS, templates . . . basically anything you'd consider static to that “version” of your site or web app or PWA.

Application shell (architecture) is the minimum HTML, CSS and JavaScript needed to build basic representational User Interface of a progressive web app (PWA). It is one of the main factors that provide instant loading, smooth UI/UX and good performance on repeat visits. An app shell is cached immediately which means that the shell files are loaded once over the network and then saved to the local device. Thus, whenever the user uses the app, the shell files are rendered from the local device's cache, which gives fast startup times. App shell model divides application into shell and content.

The shell includes the static parts of the application needed to show the content. It keeps the UI local and gets all the content dynamically through an API. Thus, the caching of the whole shell ensures that even if there is no internet connection or connectivity is poor, the application loads at least the familiar UI and the user is not conferred with a bare screen or a default connection failure message.

An app shell is the same as the package or bundle of program or code 352 that is published to an app store 115 when publishing a native app. It is the most required component essential to start an app but does not contain any data. The content or dynamic data is presented within the shell. Depending on the application type, the content or data can also be cached.

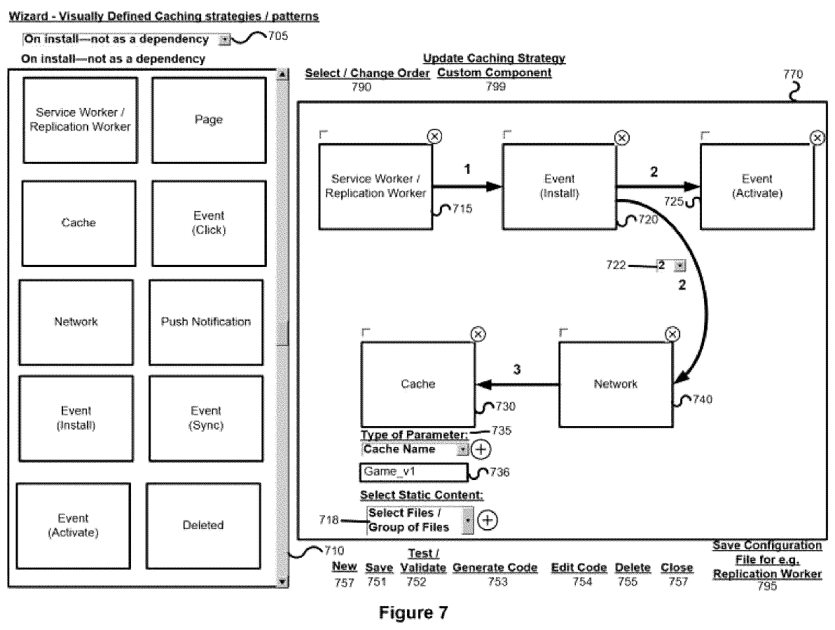

FIG. 7 shows, user can select “New” 757 to create a visual caching strategy diagram or flowchart or concept map. After creating new blank file, User select “Service worker” block 715, “Install (Event)” block 720, “Activate (Event)” block 725, “Network” block 740, “Cache” block 730, draw line between blocks to indicate connections and order, provide values for selected or displayed (suggested) parameter e.g., Cache Name (Parameter or field) and user input values is “Game_v1” and Select Static Content (Parameter or field) and user input values is selected files from FIG. 4 (405). User can also select template of caching strategy (e.g., “On install—not as a dependency”) from list 705, which opens template showing ready blocks, connections and order, default values of default relevant selected parameters and enable user to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘install’, function (event) {
event.waitUntil(
caches.open(‘mygame-core-v1’).then(function (cache) {
cache
.addAll
// levels 6-10
( );
return cache
.addAll
// core assets and levels 1-5
( ); }), );});

This is similar to “On install—as a dependency”, but won't delay install completion and won't cause installation to fail if caching fails. It's useful for large resources that aren't needed straight away, such as assets for later levels of a game.

The above example does not pass the cache.addAll promise for levels 6-10 back to event.waitUntil, so even if it fails, the game will still be available offline.

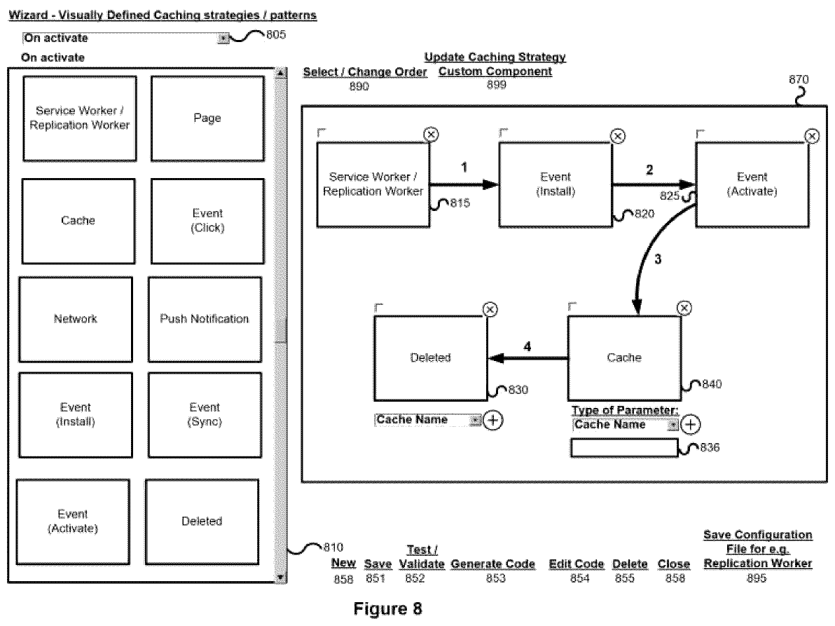

FIG. 8 shows, user can select “New” 857 to create a visual caching strategy diagram or flowchart or concept map. After creating new blank file, User select “Service worker” block 815, “Install (Event)” block 820, “Activate (Event)” block 825, “Deleted” block 830, “Cache” block 840, draw line between blocks to indicate connections and order, provide values for selected or displayed (suggested) parameter e.g. Cache Name (Parameter or field) and user input values is “cacheName” and Select Static Content (Parameter or field) and user input values is selected files from FIG. 4 (405). Users can also select a template of caching strategy (e.g., “On Activate”) from list 805, which opens a template showing ready blocks, connections and order, default values of default relevant selected parameters and enables users to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘activate’, function (event) {
event.waitUntil(
caches.keys( ).then(function (cacheNames) {
return Promise.all(
cacheNames
.filter(function (cacheName) {
// Return true if you want to remove this cache,
// but remember that caches are shared across
// the whole origin
})
.map(function (cacheName) {
return caches.delete(cacheName);
}), ); }), ); });

Once a new Service Worker 815 has been installed and a previous version isn't being used, the new one activates 825, and gets an activated event 825. Because the old version is out of the way, it's a good time to handle schema migrations in IndexedDB and also remove unused caches 840.

On Activate strategy is useful for clean-up and migration. During activation, other events such as fetch are put into a queue, so a long activation could potentially block page loads. Need to keep activation as per requirements, and only use it for required things.

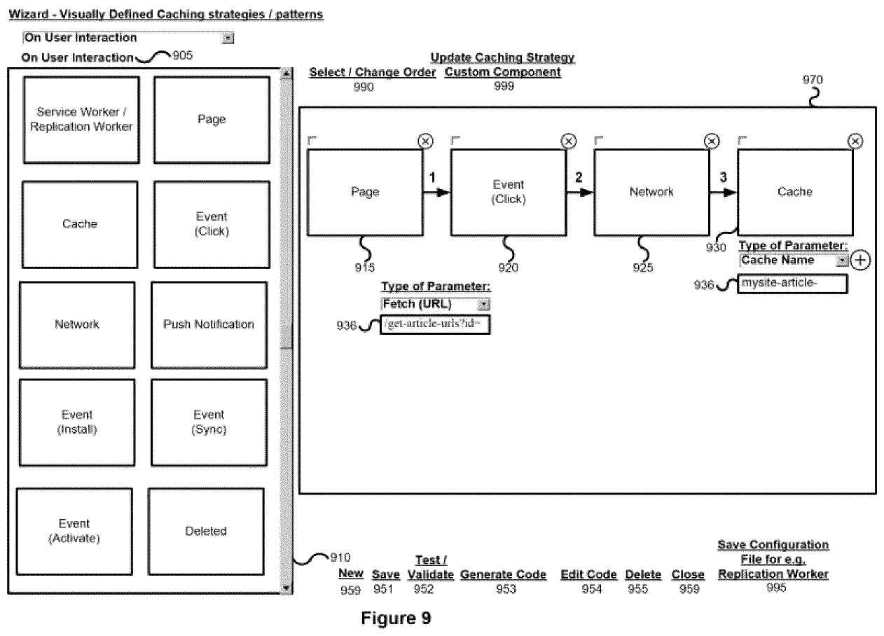

FIG. 9 shows, user can select “New” 957 to create a visual caching strategy diagram or flowchart or concept map. After creating new blank file, User select “Page” block 915, “Click (Event)” block 920, “Network” block 925, “Cache” block 930, draw line between blocks to indicate connections and order, provide values for selected or displayed (suggested) parameter e.g., Cache Name (Parameter or field) and user input values is “mysite-article-” and Select Static Content (Parameter or field) and user input values is selected files from FIG. 4 (405). Users can also select a template of caching strategy (e.g., “On user interaction”) from list 905, which opens a template showing ready blocks, connections and order, default values of default relevant selected parameters and enables users to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

document.querySelector(‘.cache-article’).addEventListener(‘click’, function (event) {
event.preventDefault( );
var id = this.dataset.articleId;
caches.open(‘mysite-article-’ + id).then(function (cache) {
fetch(‘/get-article-urls?id=’ + id)
.then(function (response) {
// /get-article-urls returns a JSON-encoded array of
// resource URLs that a given article depends on
return response.json( );
})
.then(function (urls) {
cache.addAll(urls);
}); }); });

On user interaction strategy is useful when the whole site can't be taken offline, and need to allow the user to select the content they want available offline. E.g., a video on something like YouTube, an article on Wikipedia, a particular gallery on Flickr.

For example, when a user clicks the “Read later” or “Save for offline” button, fetch associated or pre-defined content, resource, file, data from the network and put it in the cache.

The caches API is available from pages as well as service workers to add things to the cache.

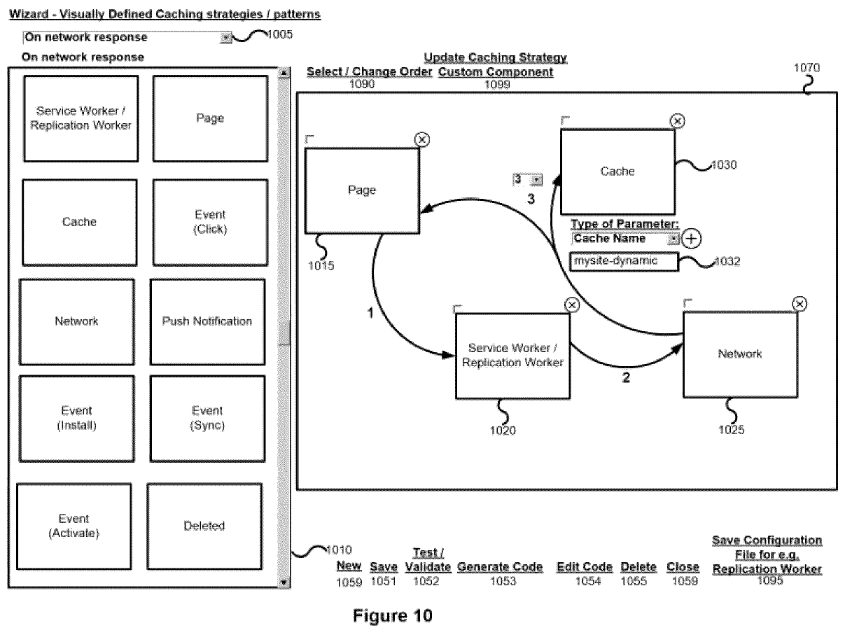

FIG. 10 shows, user can select “New” 1057 to create a visual caching strategy diagram or flowchart or concept map. After creating new blank file, User select “Page” block 1015, “Service worker” block 1020, “Network” block 1025, “Cache” block 1030, draw line between blocks to indicate connections and order, provide values for selected or displayed (suggested) parameter e.g., Cache Name (Parameter or field) and user input values is “mysite-dynamic” and Select Static Content (Parameter or field) and user input values is selected files from FIG. 4 (405). Users can also select a template of caching strategy (e.g., “On network response”) from list 1005, which opens a template showing ready blocks, connections and order, default values of default relevant selected parameters and enables users to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘fetch’, function (event) {
event.respondWith(
caches.open(‘mysite-dynamic’).then(function (cache) {
return cache.match(event.request).then(function (response) {
return (
response ||
fetch(event.request).then(function (response) {
cache.put(event.request, response.clone( ));
return response;
}) ); }); }), );});

On network response strategy ideal for frequently updating resources such as a user's inbox, or article contents. If a request doesn't match anything in the cache, get it from the network, send it to the page, and add it to the cache at the same time.

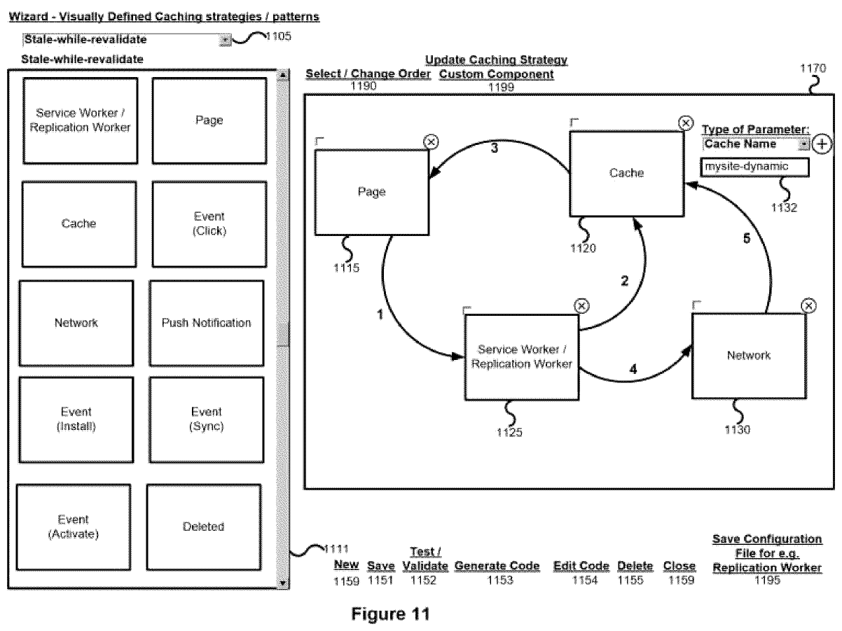

FIG. 11 shows, user can select “New” 1157 to create a visual caching strategy diagram or flowchart or concept map. After creating new blank file, User select “Page” block 1115, “Service worker” block 1120, “Network” block 1125, “Cache” block 1130, draw line between blocks to indicate connections and order, provide values for selected or displayed (suggested) parameter e.g. Cache Name (Parameter or field) and user input values is “mysite-dynamic” and Select Static Content (Parameter or field) and user input values is selected files from FIG. 4 (405). User can also select template of caching strategy (e.g. “Stale-while-revalidate”) from list 1105, which opens template showing ready blocks, connections and order, default values of default relevant selected parameters and enable user to add, remove blocks, select or edit parameters and associated values. Based on said drawing of diagram or flowchart of selected blocks and selected parameter specific inputs or values, system automatically generates code or in the event of selecting “Generates Code” button system automatically generates e.g. following code:

self.addEventListener(‘fetch’, function (event) {
event.respondWith(
caches.open(‘mysite-dynamic’).then(function (cache) {
return cache.match(event.request).then(function (response) {
var fetchPromise = fetch(event.request).then(function (networkResponse) {
cache.put(event.request, networkResponse.clone( ));
return networkResponse;
});
return response || fetchPromise;
}); }), ); });

Stale-while-revalidate strategy is useful for frequently updating resources where having the very latest version is non-essential. Avatars can fall into this category.

If there's a cached version available, use it, but fetch an update for next time.

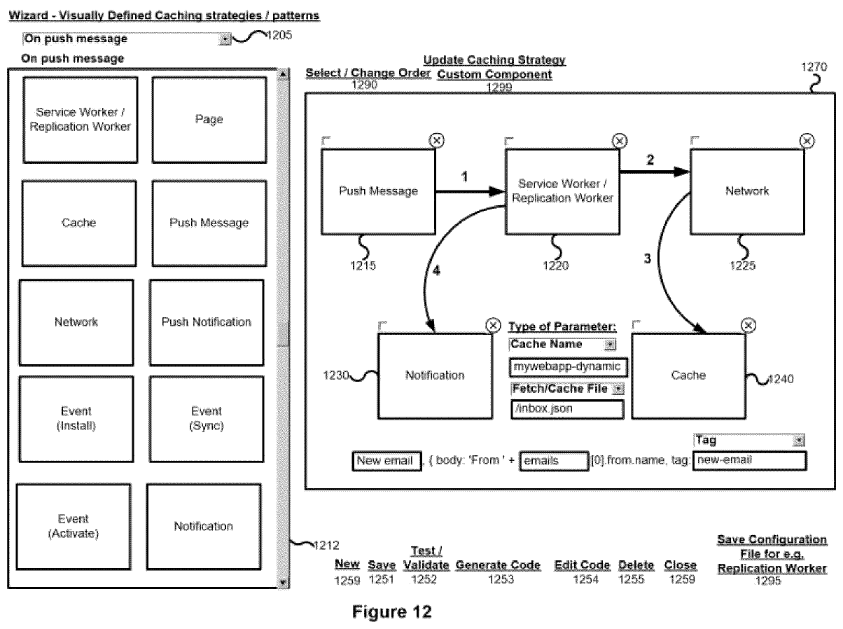

FIG. 12 shows, user can select “New” 1257 to create a visual caching strategy diagram or flowchart or concept map. After creating new blank file, User select “Push Message” block 1215, “Service worker” block 1220, “Network” block 1225, “Notification” block 1230, “Cache” block 1240, draw line between blocks to indicate connections and order, provide values for selected or displayed (suggested) parameter e.g. Cache Name (Parameter or field) and user input values is “mysite-dynamic” and Select Static Content (Parameter or field) and user input values is selected files from FIG. 4 (405). User can also select template of caching strategy (e.g. “Stale-while-revalidate”) from list 1205, which opens template showing ready blocks, connections and order, default values of default relevant selected parameters and enable user to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘push’, function (event) {
if (event.data.text( ) == ‘new-email’) {
event.waitUntil(
caches
.open(‘mywebapp-dynamic’)
.then(function (cache) {
return fetch(‘/inbox.json’).then(function (response) {
cache.put(‘/inbox.json’, response.clone( ));
return response.json( );
}); })
.then(function (emails) {
registration.showNotification(‘New email’, {
body: ‘From ’ + emails[0].from.name,
tag: ‘new-email’,
}); }), ); } });
self.addEventListener(‘notificationclick’, function (event) {
if (event.notification.tag == ‘new-email’) {
// Assume that all of the resources needed to render
// /inbox/ have previously been cached, e.g., as part
// of the install handler.
new WindowClient(‘/inbox/’);
}});

The common final outcome is a notification which, when tapped, opens/focuses a relevant page, but for which updating caches before this happens is important. The user is obviously online at the time of receiving the push message, but they may not be when they finally interact with the notification, so making this content available offline is important.

The Push API allows the Service Worker to be awoken in response to a message from the OS's messaging service. This happens even when the user doesn't have a tab open to site. Only the Service Worker is woken up.

On Push Message caching strategy is useful for content relating to a notification, such as a chat message, a breaking news story, or an email. Also infrequently changing content that benefits from immediate sync, such as a to-do list update or a calendar alteration.

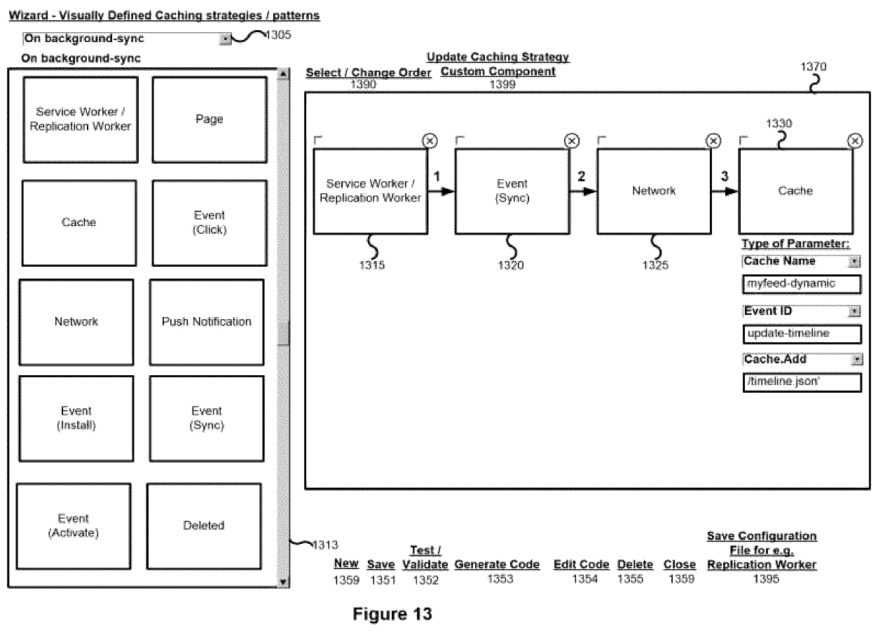

FIG. 13 shows, user can select “New” 1357 to create a visual caching strategy diagram or flowchart or concept map. After creating new blank file, User select “Service worker” block 1315, “Sync (Event)” block 1320, “Network” block 1325, “Cache” block 1330, draw line between blocks to indicate connections and order, provide values for selected or displayed (suggested) parameter e.g., Cache Name (Parameter or field) and user input values is “update-timeline” and Select Static Content (Parameter or field) and user input values is selected files from FIG. 4 (405). User can also select template of caching strategy (e.g., “On background-sync”) from list 1305, which opens template showing ready blocks, connections and order, default values of default relevant selected parameters and enable user to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘sync’, function (event) {
if (event.id == ‘update-timeline’) {
event.waitUntil(
caches.open(‘myfeed-dynamic’).then(function (cache) {
return cache.add(‘/timeline.json’);
}), ); } });

Background sync is a feature of Service Worker, which allows request background data synchronization as a one-off, or on an interval. This happens even when the user doesn't have a tab open to the site. Only the Service Worker is woken up.

It's useful for non-urgent updates, especially those that happen so regularly that a push message per update would be too frequent for users, such as social timelines or news articles.

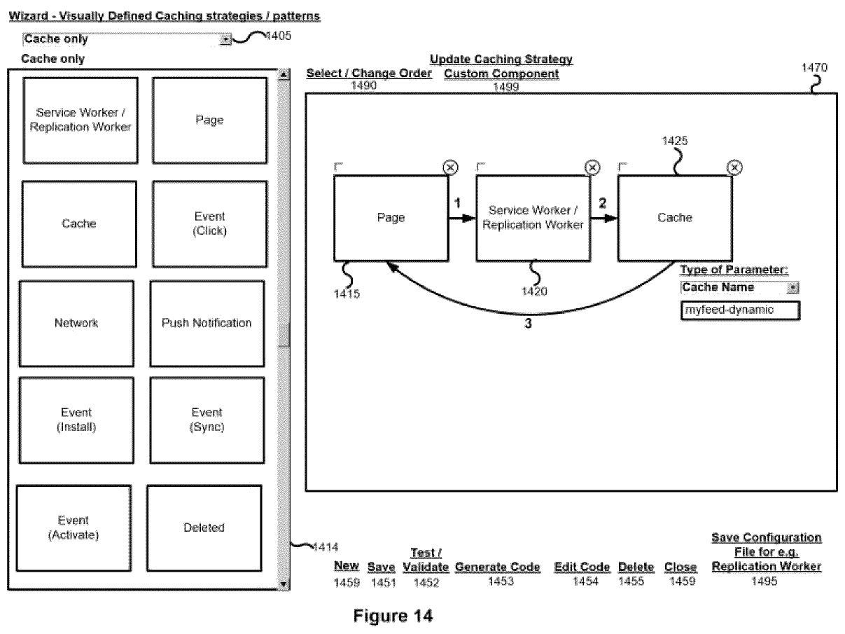

FIG. 14 shows, user can select “New” 1457 to create a visual caching strategy diagram or flowchart or concept map. After creating new blank file, User select “Page” block 1415, “Service worker” block 1420, “Cache” block 1425, draw line between blocks to indicate connections and order, provide values for selected or displayed (suggested) parameter e.g. Cache Name (Parameter or field) and user input values is “Default” and Select Static Content (Parameter or field) and user input values is selected files from FIG. 4 (405). Users can also select a template of caching strategy (e.g., “Cache only”) from list 1405, which opens a template showing ready blocks, connections and order, default values of default relevant selected parameters and enables users to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘fetch’, function (event) {
// If a match isn't found in the cache, the response
// will look like a connection error
event.respondWith(caches.match(event.request)); });

Cache only strategy is useful for static resources related to a particular “version” of a site or web app or PWA. Since resources have cached in the install event, it's available for fetch.

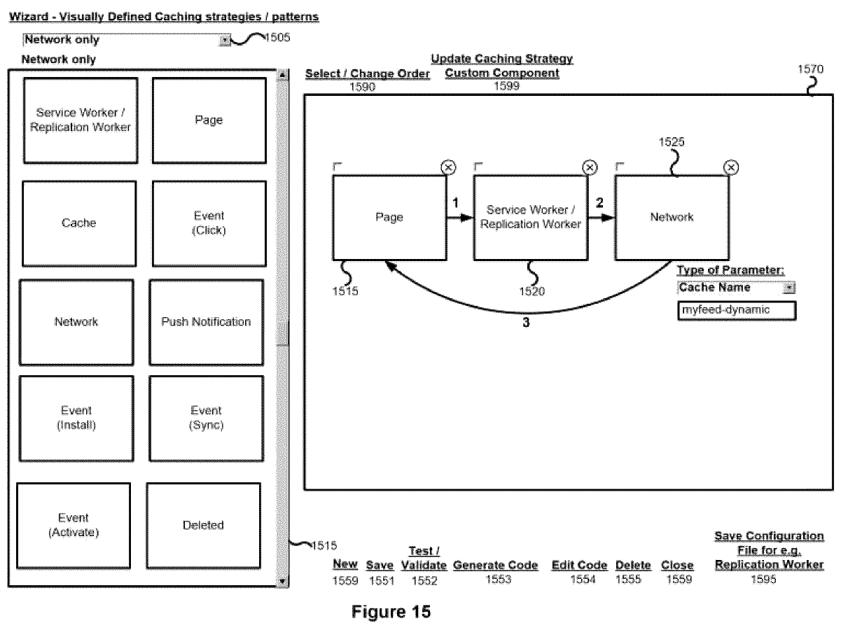

FIG. 15 shows, user can select “New” 1557 to create a visual caching strategy diagram or flowchart or concept map. After creating a new blank file, User selects “Page” block 1515, “Service worker” block 1520, “Network” block 1525, draws a line between blocks to indicate connections and order, and provides values for selected or displayed (suggested) parameters. User can also select template of caching strategy (e.g. “Network only”) from list 1505, which opens a template showing ready blocks, connections and order, default values of default relevant selected parameters and enables users to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘fetch’, function (event) {
event.respondWith(fetch(event.request));
// or simply don't call event.respondWith, which
// will result in default browser behavior
});

Network only strategy useful for things that have no offline equivalent, such as analytics pings, non-GET requests.

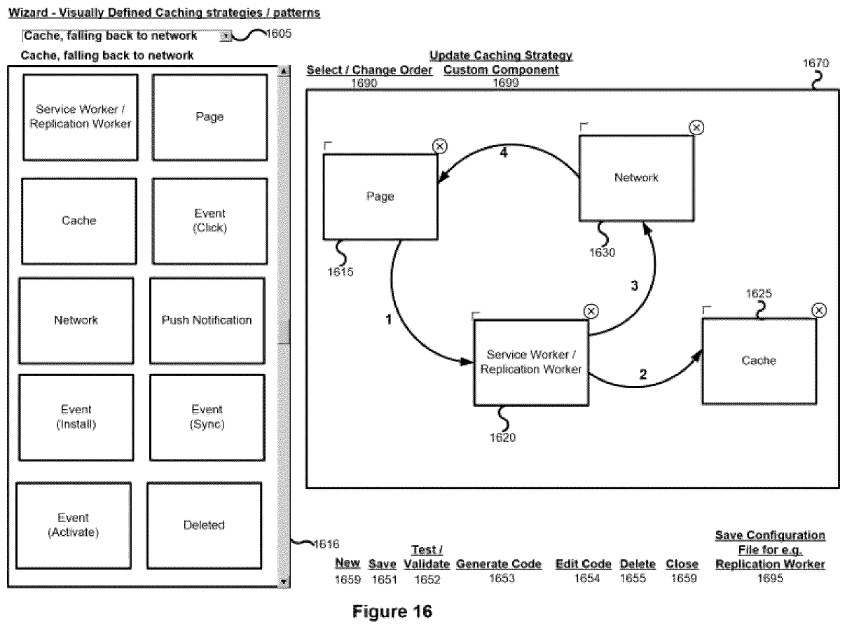

FIG. 16 shows, user can select “New” 1657 to create a visual caching strategy diagram or flowchart or concept map. After creating new blank file, User select “Page” block 1615, “Service worker” block 1620, “Cache” block 1625, “Network” block 1630, draw line between blocks to indicate connections and order, provide values for selected or displayed (suggested) parameter e.g., Cache Name (Parameter or field) and user input values is “Default” and Select Static Content (Parameter or field) and user input values is selected files from FIG. 4 (405). User can also select template of caching strategy (e.g., “Cache, falling back to network”) from list 1605, which opens template showing ready blocks, connections and order, default values of default relevant selected parameters and enable user to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘fetch’, function (event) {
event.respondWith(
caches.match(event.request).then(function (response) {
return response || fetch(event.request);
}), ); });

This strategy is useful for building offline-first. In such cases, this is how you'll handle the majority of requests. Other patterns will be exceptions based on the incoming request. This gives the “cache only” behavior for things in the cache and the “network only” behavior for anything not-cached (which includes all non-GET requests, as they cannot be cached).

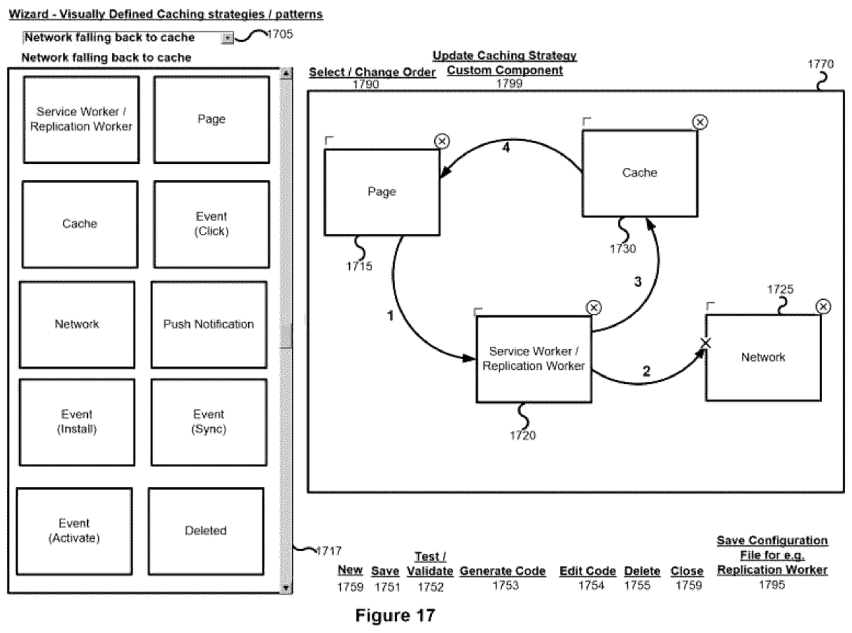

FIG. 17 shows, user can select “New” 1757 to create a visual caching strategy diagram or flowchart or concept map. After creating new blank file, User select “Page” block 1715, “Service worker” block 1720, “Network” block 1725, “Cache” block 1730, draw line between blocks to indicate connections and order, provide values for selected or displayed (suggested) parameter e.g. Cache Name (Parameter or field) and user input values is “myfeed-dynamic” and Select Static Content (Parameter or field) and user input values is selected files from FIG. 4 (405). User can also select template of caching strategy (e.g., “Network, falling back to cache”) from list 1705, which opens template showing ready blocks, connections and order, default values of default relevant selected parameters and enable user to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘fetch’, function (event) {
event.respondWith(
fetch(event.request).catch(function ( ) {
return caches.match(event.request);
}), ); });

This strategy is useful for a quick-fix for resources that update frequently, outside of the “version” of the site. E.g. articles, avatars, social media timelines, and game leaderboards. Online users will get the most up-to-date content, but offline users get an older cached version. If the network request succeeds, it's possible to update the cache entry.

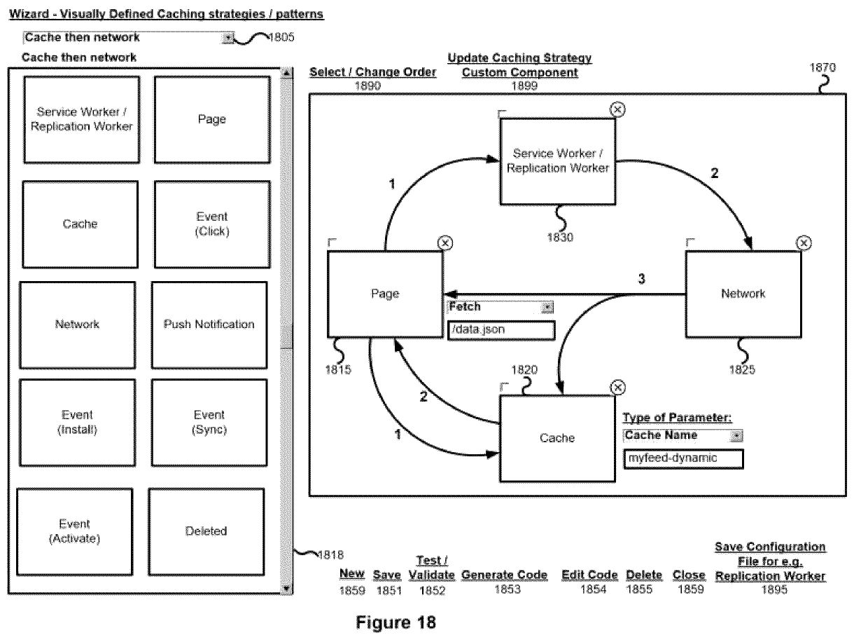

FIG. 18 shows, user can select “New” 1857 to create a visual caching strategy diagram or flowchart or concept map. After creating new blank file, User select “Page” block 1815, “Cache” block 1820, “Network” block 1825, “Service worker” block 1830, draw line between blocks to indicate connections and order, provide values for selected or displayed (suggested) parameter e.g., Cache Name (Parameter or field) and user input values is “Default” and Select Static Content (Parameter or field) and user input values is selected files from FIG. 4 (405). User can also select template of caching strategy (e.g., “Network, falling back to network”) from list 1805, which opens template showing ready blocks, connections and order, default values of default relevant selected parameters and enable user to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code for page and service worker:

### Code in the Page:

var networkDataReceived = false;
startSpinner( );
// fetch fresh data
var networkUpdate = fetch(‘/data.json’)
.then(function (response) {
return response.json( ); })
.then(function (data) {
networkDataReceived = true;
updatePage(data); });
// fetch cached data
caches
.match(‘/data.json’)
.then(function (response) {
if (!response) throw Error(‘No data’);
return response.json( ); })
.then(function (data) {
// don't overwrite newer network data
if (!networkDataReceived) {
updatePage(data); } })
.catch(function ( ) {
// we didn't get cached data, the network is our last hope:
return networkUpdate; })
.catch(showErrorMessage)
.then(stopSpinner);

### Code in the Service Worker:

You should always go to the network and update a cache as you go.

self.addEventListener(‘fetch’, function (event) {
event.respondWith(
caches.open(‘myfeed-dynamic’).then(function (cache) {
return fetch(event.request).then(function (response) {
cache.put(event.request, response.clone( ));
return response;
}); }), ); });

This strategy is useful for content that updates frequently. E.g. articles, social media timelines, and games. leaderboards.

This requires the page to make two requests, one to the cache, and one to the network to show the cached data first, then update the page when/if the network data arrives. It replaces the current data when new data arrives (e.g., game leaderboard). It adds the new content above the old content so the user is uninterrupted. It facilitates getting content on screen as fast as possible, while displaying up-to-date content as soon as it arrives.

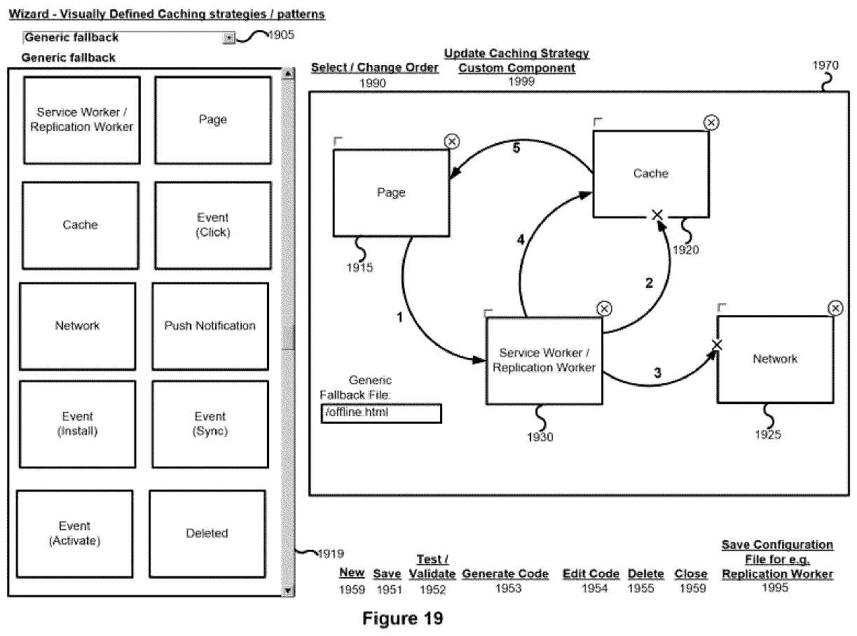

FIG. 19 shows, users can select “new” 1957 to create a visual caching strategy diagram or flowchart or concept map. After creating a new blank file, users select “Page” block 1915, “Cache” block 1920, “Network” block 1925, “Service worker” block 1930, draw a line between blocks to indicate connections and order, and provide values for selected or displayed (suggested) parameters. Users can also select a template of caching strategy (e.g., “Generic Fallback”) from list 1905, which opens a template showing ready blocks, connections and order, default values of default relevant selected parameters and enables users to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

self.addEventListener(‘fetch’, function (event) {
event.respondWith(
// Try the cache
caches
.match(event.request)
.then(function (response) {
// Fall back to network
return response || fetch(event.request); })
.catch(function ( ) {
// If both fail, show a generic fallback:
return caches.match(‘/offline.html’);
// However, in reality you'd have many different
// fallbacks, depending on URL and headers.
// E.g., a fallback silhouette image for avatars.
}), );});

If it fails to serve something from the cache and/or network, better to provide a generic fallback. This strategy is useful for secondary imagery such as avatars, failed POST requests, and an “Unavailable while offline”. page. If page is posting an email, service worker may fall back to storing the email in an IndexedDB ‘outbox’ and respond by letting the page know that the send failed but the data was successfully retained

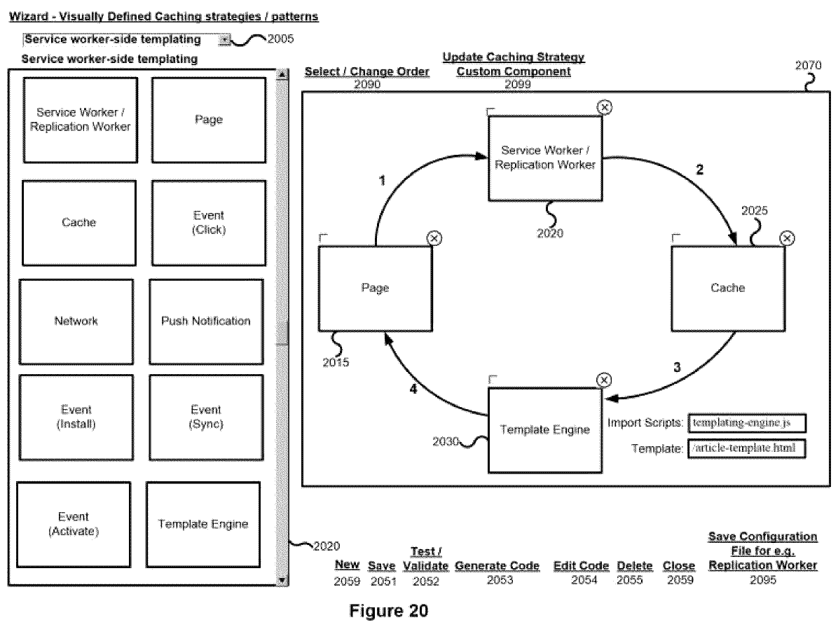

FIG. 20 shows, users can select “New” 2057 to create a visual caching strategy diagram or flowchart or concept map. After creating a new blank file, users select “Page” block 2015, “Service worker” block 2020, “Cache” block 2025, “Network” block 2030, draw a line between blocks to indicate connections and order, and provide values for selected or displayed (suggested) parameters. User can also select template of caching strategy (e.g., “Service worker-side templating”) from list 2005, which opens a template showing ready blocks, connections and order, default values of default relevant selected parameters and enable user to add, remove blocks, select or edit parameters and associated values. Based on said drawing of diagram or flowchart of selected blocks and selected parameter specific inputs or values, system automatically generates code or in the event of selecting “Generates Code” button system automatically generates e.g., following code:

importScripts(‘templating-engine.js’);
self.addEventListener(‘fetch’, function (event) {
var requestURL = new URL(event.request.url);
event.respondWith(
Promise.all([
caches.match(‘/article-template.html’).then(function (response) {
return response.text( ); }),
caches.match(requestURL.path + ‘.json’).then(function (response) {
return response.json( ); }),
]).then(function (responses) {
var template = responses[0];
var data = responses[1];
return new Response(renderTemplate(template, data), {
headers: {
‘Content-Type’: ‘text/html’,
}, }); }), ); });

This strategy is useful for pages that cannot have their server response cached. Rendering pages on the server makes things fast, but that can mean including state data that may not make sense in a cache, e.g., “Logged in as . . . ”. If the page is controlled by a service worker, instead choose to request JSON data along with a template, and render that instead.

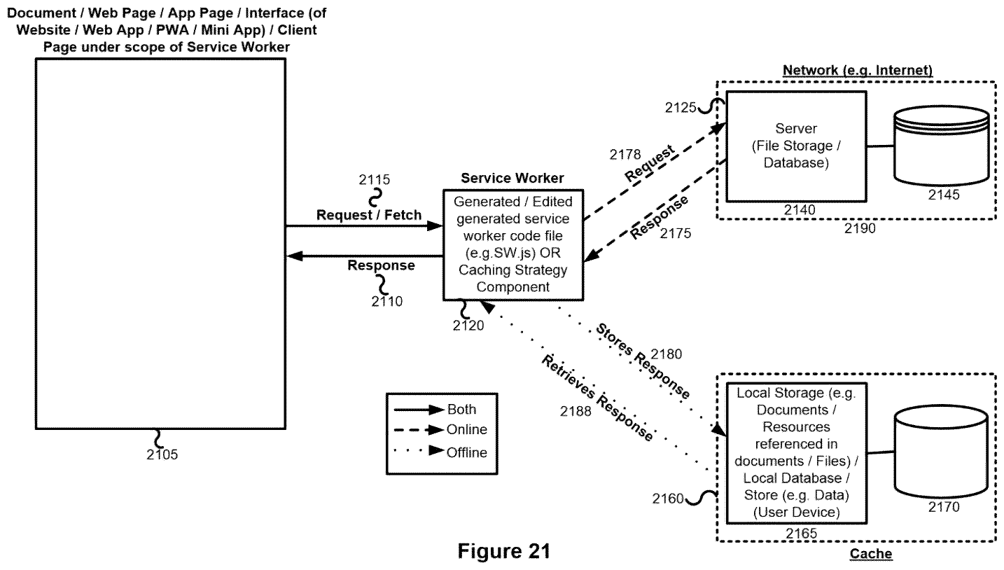

FIG. 21 illustrates service worker 2120 can either load resources from the cache storage 2140 or fetch them through the online network 2190 according to the network conditions. These programmable interfaces dramatically improve the online and offline browsing 2105 experiences of Web application users. After site assets are cached, service workers can access cached content via the fetch event.

Service worker is JavaScript code that runs in a renderer process. When a navigation happens, the network thread checks the domain against registered service worker scopes, if a service worker is registered for that URL, the UI thread finds a renderer process in order to execute the service worker code. The service worker may load data from cache, eliminating the need to request data from the network, or it may request new resources from the network. The renderer process's core job is to turn HTML, CSS, and JavaScript into a web page that the user can interact with. A website usually uses external resources like images, CSS, and JavaScript. Those files need to be loaded from the network or cache. The main thread could request them one by one as they find them while parsing to build a DOM, but in order to speed up, “preload scanner” is run concurrently. When the HTML parser finds a <script> tag, it pauses the parsing of the HTML document and has to load, parse, and execute the JavaScript code.

After registering a service worker 2120 to control a scope, each time a client 2105 in that scope requests a resource from anyplace in the network 2190. The service worker 2120 for that scope receives the request 2115. Through event.respondwith( ) and passing a response object or response 2110, the service worker 2120 can answer the client's 2105 request 2115 with a custom response 2110 made out of different sources: the network 2190, storage 2165/2170 or its own code 2120.

A fetch event fires every time any resource controlled by a service worker is fetched, which includes the documents inside the specified scope, and any resources referenced in those documents.

Need to attach a fetch event listener to the service worker, then call the respondWith( ) method on the event to receive HTTP responses and update them with code. Code for start by responding with the resource whose url matches that of the network request, in each case:

self.addEventListener(‘fetch’, (event) => {
event.respondWith(
caches.match(event.request)
); });

caches.match(event.request) allows to match each resource requested from the network with the equivalent resource available in the cache, if there is a matching one available. The matching is done via URL and various headers, just like with normal HTTP requests.

FIG. 22 (A) illustrates graphical user interface (GUI) for enabling users to configure static content or file or resources replication or synchronization. File synchronization is the process of ensuring that computer files in two or more locations are updated via certain rules. User can create new publication 2202, select publication type 2203 including file snapshot publication including pull or push/server or client wherein copy files from server to client or copy files from client to server, request files (pull) from client to server, request files (pull) from server to client, push files from client to server and push files from server to client, one-way (update) publication, wherein in the event of identification of update or changes in file from server, copy or replace said updated file(s) from server to client or in the event of identification of update or changes in file in client storage, copy or replace said updated file(s) from client to server. In the event of non-availability or low quality of network or internet, client or server keeps updated content or files or data in queue and in the event of network availability of network, sends or updates content or files or data from queuing. In snapshot publication or one-way file synchronization, also called mirroring, updated files are copied from a source location (server or server storage or server database or one or more sources) to one or more target locations or destinations, but no files are copied back to the source location. In merge publication or two-way file synchronization, updated files are copied in both directions, usually with the purpose of keeping the two locations identical to each other, wherein merge publication comprises pull file subscriptions (request to update changed files) and push file subscriptions (push or replace updated changed files) from client or server.

In an embodiment user or admin can select files from a list of files or contents 2205. User or admin is presented with suggested list of files or auto identify files for user selection or auto select files based on type of files, names of files, file associated metadata, path of files within root directory or folder, size of files and user provided auto identify files settings, strategy of caching, domain name, path of project and associated files, web page or app page or interface associated files and resources.

In an embodiment enable user or admin to filter 2210 files based on auto suggested, past selected, new files, date and time, updated, category, size, metadata specific, types of files including html, JavaScript, CSS, icon, .jpeg, .png and like, marked type of file including Shell, Updatable, Downloadable, Fallback, Data and any combinations thereof.

In an embodiment user or admin can use file manager 2213 to search, match, edit, remove, augment, create new, update, view properties, filter, organize in folder, order, mark as Shell, Updatable, Downloadable, Fallback, and Data, share, collaboratively create, import, sort, rename, compress, decompress, encrypt, decrypt, upload, add to particular type or model of publication or synchronization and select and add to list one or more files for caching or storing at local storage of user device for enable to fetch and respond while receiving request.

Then the admin or user or app publisher or developer can select “Create a snapshot immediately” 2212 or “Schedule the snapshot agent to run at particular times” and select Next.

On the Agent Security user interface or page 2215, select Security Settings including login information, account and password.

On the Complete the Wizard user interface page 2217, enter StaticOnoLivMerge in the Publication name box and select Finish.

After the publication is created, select Close and select Refresh to view new merge replication.

Admin or user or app publisher or developer can Connect to the publisher in File Management Application, select Files Replication and then select View Snapshot Agent Status to ensure that the snapshot job has succeeded before continuing to the next.

Admin or user or app publisher or developer then can add a subscription to said created merge publication, can set permissions on the subscription folder and also can manually generate the filtered files snapshot for the new subscription.

To add a subscriber for merge publication, admin or user or app publisher or developer can connect to the subscriber in Files Management application and select New Subscriptions 2218 to create one or more new subscriptions to publication and specify where and when to run the agents that synchronize the subscriptions.

On the Publication user interface or page 2218, select Find Publisher in the Publisher list or select the publication for which admin or user or app publisher or developer want to create one or more subscriptions. For example, admin or user or app publisher or developer select “StaticOnoLivMerge” publication.

In the Connect to Server dialog box, enter the name of the publisher instance in the Server name box, and select Connect.

On the Merge Agent Location user interface or page 2220, Run all agents at the distributor (push subscriptions) or select Run each agent at its Subscriber (pull subscriptions), and then select Next.

On the Subscribers user interface or page 2223, select the subscriber names or app user names or instance name of the subscriber database server or select all app (web app or PWA of publisher or developer) installed users 2224.

Under Subscription Database, select existing or New Database from the list 2230. E.g., In the New Database dialog box, enter e.g., OnoLiv_Static in the Folder or store or Cache name box. Select OK, and then select Next.

On the Synchronization Schedule user interface or page 2226, set Agent Schedule to Run on demand only and select Next.

On the Initialize Subscriptions user interface or page specify whether to initialize each subscription with snapshot of the publication files and metadata, select at first synchronization from the Initialize When list. Select Next to proceed to the Subscription Type user interface or page, and select the e.g., Client subscription type. After you select the subscription type, select Next again. Select Finish, the subscription is created.

### Admin or User or App Publisher or Developer can Set Server Permissions at the Subscriber

A subscription is a request for a copy of the files and associated metadata in a publication. A subscription defines which publication will be received, and where and when it will be received. When planning for subscriptions, Admin or user or app publisher or developer need to consider where they want agent processing to occur. The type of subscription admin or user or app publisher or developer select, controls where the agent runs. With a push subscription, the Merge Agent or Distribution Agent runs at the Distributor, whereas with a pull subscription, agents run at the Subscribers.

With a push subscription, the Publisher propagates changes to a Subscriber without a request from the Subscriber. Changes can be pushed to Subscribers on demand, continuously, or on a scheduled basis. The Distribution Agent or Merge Agent runs at the Distributor. Use of push subscription when files will typically be synchronized continuously or on a frequently recurring schedule and when publications require near real-time movement of files.

With a pull subscription, the Subscriber requests changes made at the Publisher. Pull subscriptions allow the user at the Subscriber to determine when the files changes are synchronized. The Distribution Agent or the Merge Agent runs at the Subscriber.

Usage of pull subscriptions are files or content will typically be synchronized on demand or on a schedule rather than continuously, the publication has a large number of subscribers, subscribers are autonomous, disconnected, and/or mobile, subscribers will determine when they will connect and synchronize changes. It's most often used with merge replication.

All replication types allow push and pull subscriptions. Merge replication uses two additional terms to distinguish subscriptions: client subscriptions and server subscriptions. Both client and server subscription types can be used with push and pull subscriptions.

Snapshot replication is used to provide the initial files set for transactional and merge replication; it can also be used when complete refreshes of files are appropriate.

To synchronize the subscription to the merge publication, start the Merge Agent to initialize the subscription by using Files Management. Connect to the subscriber in Files Management and select View Synchronization Status and select Start to initialize the subscription. After configured both publisher and subscriber for merge replication. It's now possible to add new, update, or delete files in the file folder or store or cache at the publisher or subscriber.

Admin or user or web app publisher or developer can define fetching, caching, replication rules and strategy via wizard and visual graphical user interface 2232. Based on defining fetching, caching, replication rules and strategy said configured files replication or synchronization works or behaves i.e., send or receive files as per define rules and strategy to determine what, where, when, how, and who will fetch, receive, store or cache files which discussed in detail in FIGS. 24-26 and FIGS. 4-21.

FIG. 22 (B) illustrates graphical user interface (GUI) for enabling user or admin or web app publisher or developer to configure dynamic data or data or content of files or links of files replication. Replication is a set of technologies for copying and distributing data and database objects from one database to another and then synchronizing between databases to maintain consistency. User or admin or server admin can configure replication to distribute data to different locations and to remote or mobile users over local and wide area networks, dial-up connections, wireless connections, and the Internet.

User or admin or web app publisher or developer prepare or configure a server for replication including create accounts for replication, prepare the snapshot folder and configure distribution. Users or admin can create replication agents to run replication agents including snapshot agent at publisher, log reader agent at publisher, distribution agent at publisher and subscriber, merge agent at publisher and subscriber. Users or admin create and configure accounts for replication, provide or configure connection strings and login information of server and server database(s) or databases from one or more sources.

User or admin or web app publisher or developer can configure the snapshot folder that's used to create and store the publication snapshot or create a share for the snapshot folder and assign permissions.

FIG. 22 (B) illustrates graphical user interface (GUI) for enabling user or admin to connect to the publisher in database management application or tool and create new publication 2251 then select publication database from list of databases and then select type of publication 2253 to configure different types of replications including snapshot, merge and transactional. For example, ser or admin select merge publication to configure merge replication comprises configure a publisher for merge replication, add a mobile subscriber for merge publication and synchronize the subscription to the merge publication.

Merge replication or synchronization is primarily designed for mobile applications or distributed server applications that have possible data conflicts. Common scenarios include: exchanging data with mobile users. Merge replication is a good solution to the problem of moving data between a central server and mobile clients that are only occasionally connected. By using the replication wizards, user or admin can configure and administer a merge replication topology and can configure a replication topology for mobile clients.

Admin or web app publisher or developer can use merge replication to publish data from a central database to one or more mobile users so that each user gets a uniquely filtered subset of the data.

On the Articles user interface or page 2255, admin or user can select one or more Tables. For example, select the Products, Services and Profiles tables.

On the Filter Table Rows user interface or page 2258, user or admin can select Add Filter and in the Add Filter dialog box, select Products (Cloths) in Select the table to filter. Select the column(s) e.g., StoreLocation column, and modify the WHERE clause. e.g.

WHERE [StoreLocation]=“Los Angeles”. Selecting a row from this table will go to multiple subscriptions. Likewise, users can filter data in any manner and in any combinations by creating structured query language by using filter wizard to filter one or more selected columns and rows of table(s).

Then the admin or user or app publisher or developer can select “Create a snapshot immediately” 2260 or “Schedule the snapshot agent to run at particular times” 2260 and select Next.

On the Agent Security user interface or page 2262, select Security Settings including login information, account and password.

On the Complete the Wizard user interface page 2264, enter OnoLivMerge in the Publication name box and select Finish.

After the publication is created, select Close and select Refresh to view new merge replication.

Admin or user or app publisher or developer can Connect to the publisher in Database Management Application, select Replication and then select View Snapshot Agent Status to

ensure that the snapshot job has succeeded before continuing to the next.

Admin or user or app publisher or developer then can add a subscription to said created merge publication, can set permissions on the subscription database and also can manually generate the filtered data snapshot for the new subscription.

To add a subscriber for merge publication, admin or user or app publisher or developer can connect to the subscriber in Database Management application and select New Subscriptions 2270 to create one or more new subscriptions to publication and specify where and when to run the agents that synchronize the subscriptions.

On the Publication user interface or page 2272, select Find SQL Server Publisher in the Publisher list or select the publication for which admin or user or app publisher or developer want to create one or more subscriptions. For example, admin or user or app publisher or developer select “OnoLivMerge” publication.

In the Connect to Server dialog box, enter the name of the publisher instance in the Server name box, and select Connect.

On the Merge Agent Location user interface or page 2274, Run all agents at the distributor (push subscriptions) or select Run each agent at its Subscriber (pull subscriptions), and then select Next.

On the Subscribers user interface or page 2276, select the subscriber names or app user names or instance name of the subscriber database server or select all app (web app or PWA of publisher or developer) installed users 2282.

Under Subscription Database, select existing or New Database from the list 2285. E.g., In the New Database dialog box, enter, e.g., OnoLivApp_LocalDB in the Database name box. Select OK, and then select Next.

On the Synchronization Schedule user interface or page 2280, set Agent Schedule to Run on demand only and select Next.

On the Initialize Subscriptions user interface or page specify whether to initialize each subscription with a snapshot of the publication data and schema, select at first synchronization from the Initialize When list. Select Next to proceed to the Subscription Type user interface or page, and select the e.g., Client subscription type. After you select the subscription type, select Next again. Select Finish, the subscription is created.

### Admin or User or App Publisher or Developer can Set Server Permissions at the Subscriber

A subscription is a request for a copy of the data and database objects in a publication. A subscription defines which publication will be received, and where and when it will be received. When planning for subscriptions, Admin or user or app publisher or developer need to consider where they want agent processing to occur. The type of subscription admin or user or app publisher or developer select, controls where the agent runs. With a push subscription, the Merge Agent or Distribution Agent runs at the Distributor, whereas with a pull subscription, agents run at the Subscribers.

With a push subscription, the Publisher propagates changes to a Subscriber without a request from the Subscriber. Changes can be pushed to Subscribers on demand, continuously, or on a scheduled basis. The Distribution Agent or Merge Agent runs at the Distributor. Use of push subscription when data will typically be synchronized continuously or on a frequently recurring schedule and when publications require near real-time movement of data.

With a pull subscription, the Subscriber requests changes made at the Publisher. Pull subscriptions allow the user at the Subscriber to determine when the data changes are synchronized. The Distribution Agent or the Merge Agent runs at the Subscriber.

Usage of pull subscriptions is data will typically be synchronized on demand or on a schedule rather than continuously, the publication has a large number of subscribers, subscribers are autonomous, disconnected, and/or mobile, subscribers will determine when they will connect and synchronize changes. It's most often used with merge replication.

All replication types allow push and pull subscriptions. Merge replication uses two additional terms to distinguish subscriptions: client subscriptions and server subscriptions. Both client and server subscription types can be used with push and pull subscriptions.

Snapshot replication is used to provide the initial data set for transactional and merge replication; it can also be used when complete refreshes of data are appropriate.

Transactional replication is typically used in server-to-server scenarios that require high throughput, including: improving scalability and availability; data warehousing and reporting; integrating data from multiple sites; integrating heterogeneous data; and offloading batch processing.

To synchronize the subscription to the merge publication, start the Merge Agent to initialize the subscription by using Database Management. Connect to the subscriber in Database Management and select View Synchronization Status and select Start to initialize the subscription. After configured both publisher and subscriber for merge replication. It's now possible to insert, update, or delete data in the table at the publisher or subscriber.

Admin or user or web app publisher or developer can define fetching, caching, replication rules and strategy via wizard and visual graphical user interface 2290. Based on defining fetching, caching, replication rules and strategy said configured data replication works or behaves i.e. send or receive data as per define rules and strategy to determine what, where, when, how, and who will fetch, receive, store or cache data which discussed in detail in FIGS. 24-26 and FIGS. 4-21.

FIG. 23 illustrates replication models, architecture and topology including Snapshot Replication for Files/Data, Merge Replication for Files/Data and Transactional Replication for data.

Snapshot replication distributes data exactly as it appears at a specific moment in time and does not monitor for updates to the data. When synchronization occurs, the entire snapshot is generated and sent to Subscribers.

Using file snapshot replication by itself is most appropriate when a user installs web app or progressive web app (PWA), update in or version changes of installed web app or progressive web app (PWA). It's also useful for files (app shell) or data changes infrequently, replicating small volumes of data.

Use of data replication is data changes infrequently, it is acceptable to have copies of data that are out of date with respect to the Publisher for a period of time, replicating small volumes of data, a large volume of changes occurs over a short period of time.

FIG. 23 (2310), shows the principal components of snapshot replication. Snapshot replication can be used by itself, but the snapshot process (which creates a copy of all of the files and associated metadata for files synchronization or objects and data for data replication specified by a publication 2305) is also commonly used to provide the initial set of data and database objects for transactional and merge publications.

By default, all three types of replications use a snapshot to initialize Subscribers. The Snapshot Agent always generates the snapshot files, but the agent that delivers the files differs depending on the type of replication being used. Snapshot replication and transactional replication use the Distribution Agent 2313 to deliver the files, whereas merge replication uses the Merge Agent. The Snapshot Agent 2311 runs at the Distributor 2306. The Distribution Agent 2313 and Merge Agent run at the Distributor 2306 for push subscriptions, or at Subscribers for pull subscriptions.

Snapshots can be generated and applied either immediately after the subscription 2320 is created or according to a schedule set at the time the publication is created. The Snapshot Agent 2311 prepares snapshot files containing the files and related metadata for files synchronization/schema and data of published tables and database objects for data replication, stores the files in the snapshot folder 2301 for the Publisher 2301, and records tracking information in the distribution database/Folder 2312 on the Distributor 2306. User or admin or publisher or developer or web app or progressive web app (PWA) to specify a default snapshot folder 2301 when configure a Distributor 2306, but can specify an alternate location for a publication instead of or in addition to the default.

For snapshot publications, each time the Distribution Agent 2313 runs for the publication 2305, it moves a new snapshot to each Subscriber 2315 that has not yet been synchronized, has been marked for reinitialization, or includes new articles.

FIG. 23 (2340), shows the principal components of merge replication.

Merge replication, like transactional replication, typically starts with a snapshot of the publication files and associated metadata for file synchronization or database objects and data for data replication. Subsequent file changes for files synchronization or data changes and schema modifications for data replication made at the Publisher 2331 and Subscribers 2332 are tracked with triggers 2321/2322. The Subscriber 2332 synchronizes with the Publisher 2331 when connected to the network and exchanges all files for file synchronization and data rows for data replication that have changed between the Publisher and Subscriber since the last time synchronization occurred.

Merge replication is typically used in server-to-client environments. Merge replication is appropriate in any of the following situations: Multiple Subscribers or users of web app or progressive web app (PWA) of publisher or developer might update the same data at various times and propagate those changes to the Publisher and to other Subscribers or users of web app or PWAs, Subscribers need to fetch or receive data, cache or store data, make changes offline, and later synchronize changes with the Publisher, Conflicts might occur and, when they do, you need the ability to detect and resolve them, The web application or progressive web application (PWA) or application requires net data change rather than access to intermediate data states. For example, if a file changes for file synchronization or a data row changes (for data replication) five times at a Subscriber before it synchronizes with a Publisher, the row will change only once at the Publisher to reflect the net data change (that is, the fifth value).

Merge replication allows various sites to work autonomously and later merge updates into a single, uniform result. Because updates are made at more than one node, the same data may have been updated by the Publisher and by more than one Subscriber. Therefore, conflicts can occur when updates are merged and merge replication provides a number of ways to handle conflicts.

Merge replication is implemented by the Snapshot Agent and Merge Agent 2333. If the publication is unfiltered or uses static filters, the Snapshot Agent creates a single snapshot. If the publication uses parameterized filters, the Snapshot Agent creates a snapshot for each partition of data. The Merge Agent 2333 applies the initial snapshots to the Subscribers. It also merges incremental data changes that occurred at the Publisher 2331 or Subscribers 2332 after the initial snapshot was created, and detects and resolves any conflicts according to rules configured by web app publisher or developer or admin or user.

To track changes 2321/2322, merge replication (and transactional replication with queued updating subscriptions) must be able to uniquely identify every file in every published file for file synchronization or every row in every published table for data replication. To accomplish this merge replication adds the file GUID for file synchronization or adds the column rowguid to every table, unless the table already has a column of data type uniqueidentifier with the ROWGUIDCOL property set (in which case this column is used). If the table is dropped from the publication, the rowguid column is removed; if an existing column was used for tracking, the column is not removed. A filter must not include the rowguidcol used by replication to identify rows.

FIG. 23 (2370), shows the principal components of transactional replication.

Transactional replication typically starts with a snapshot of the publication files for file synchronization or database objects and data for data replication. As soon as the initial snapshot is taken, subsequent file changes in file synchronization or data changes and schema modifications in data replication made at the Publisher are usually delivered to the Subscriber as they occur (in near real time). The files changes in file synchronization or data changes in data replication are applied to the Subscriber in the same order and within the same transaction boundaries as they occurred at the Publisher; therefore, within a publication, transactional consistency is guaranteed.

Transactional replication is used for incremental changes to be propagated to Subscribers as they occur, the web app or PWA or application requires low latency between the time changes are made at the Publisher and the changes arrive at the Subscriber, the web app or PWA or application requires access to intermediate files or data states. For example, if a files changes in files synchronizing or a row changes in data replication five times, transactional replication allows web app or PWA or an application to respond to each change (such as firing a trigger), not simply the files changes in file synchronizing or net data change to the row in data replication, the Publisher has a very high volume of new files, update in files and removal of files in file synchronizing or very high volume of insert, update, and delete activity in data replication.

By default, Subscribers 2352 to transactional publications should be treated as read-only, because changes are not propagated back to the Publisher. However, transactional replication does offer options that allow updates at the Subscriber 2352.

Transactional replication is implemented by the Snapshot Agent, Log Reader Agent 2345, and Distribution Agent 2347. The Snapshot Agent prepares snapshot files containing files in file synchronization or schema and data of published tables and database objects in data replication, stores the files in the snapshot folder, and records synchronization jobs in the distribution database 2346 or folder on the Distributor 2344.

The Log Reader Agent 2345 monitors the transaction log 2343 of each folder of files configured for transactional replication in file synchronization or each database configured for transactional replication in data replication and copies the transactions marked for replication from the transaction log 2343 into the distribution database 2346, which acts as a reliable store-and-forward queue. The Distribution Agent 2347 copies the initial snapshot files from the snapshot folder and the transactions held in the distribution database tables or folders of files 2346 to Subscribers 2352.

Incremental changes made at the Publisher 2342 flow to Subscribers 2352 according to the schedule of the Distribution Agent 2347, which can run continuously for minimal latency, or at scheduled intervals. Because changes to the files in file synchronization or data in data replication must be made at the Publisher 2342 (when transactional replication is used without immediate updating or queued updating options), update conflicts are avoided. Ultimately, all Subscribers will achieve the same values as the Publisher. If immediate updating or queued updating options are used with transactional replication, updates can be made at the Subscriber, and with queued updating, conflicts might occur.

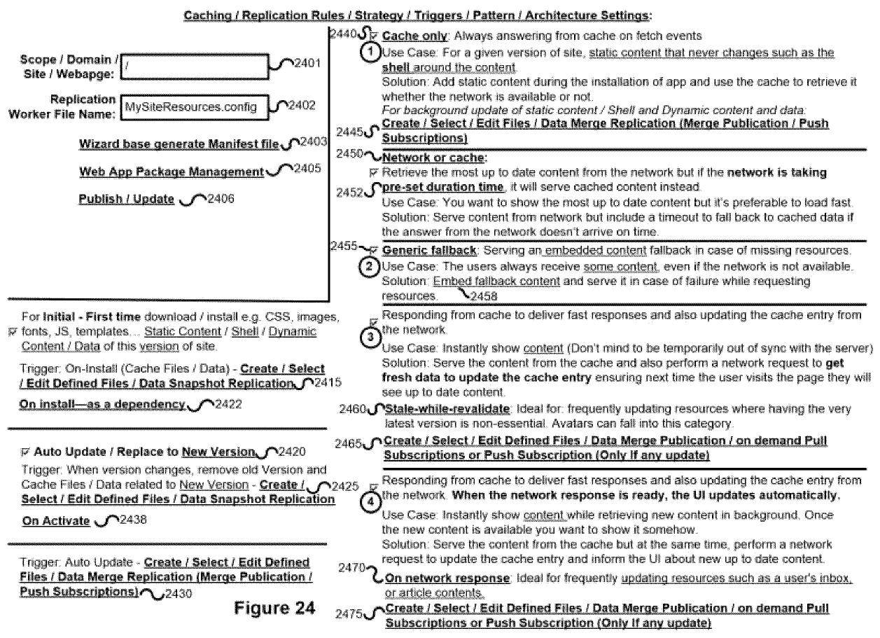

FIG. 24 illustrates graphical user interface (GUI) for enabling user or admin or developer of web app or website or PWA to configure program less caching rules and strategy by creating different types of publications based on different types of replication models discussed in detail in FIGS. 22-23. In other embodiments enabling user or admin or developer of web app or website or PWA to configure program less caching rules and strategy based on ready to use caching strategy templates and enable user to edit or configure including provide values for selected parameters for selected caching strategy. FIGS. 6-20 shows visual tools for enabling user to select caching strategy template or draw caching strategy related to replication worker 247 or service worker 246 and select selected caching strategy associated selected block(s) associated parameter(s) and provide values including cache name, added files or folders or path associated files, included or excluded of filtered files in folder, group of files, automatically identified files, and updated files. User or admin or developer user can save program-less configuration file 695 for selected or updated or created caching strategy for replication worker 247 or in another embodiment for service worker 246.

User or admin or developer user can create or select or edit or configure files synchronization (discussed in detail in FIG. 22A/2310) and data replication (discussed in detail in FIG. 22B/2310) for caching static contents, resources, app shell related files and data (if any) which executes in the event of triggering install event. In another embodiment user or admin or developer user can select “On install—as a dependency” template (discussed in detail in FIG. 6) visually and can configure on-install caching strategy including providing cache name 636 and select or select selected or added files or folders or namespace or path specific files or folders or named group of files or folder (discussed in FIG. 4 (401)).

User can select template of caching strategy (e.g., “On install—as a dependency”) from list 605, which opens template showing ready blocks, connections and order, default values of default relevant selected parameters and enable user to add, remove blocks, select or edit parameters and associated values. FIG. 6 shows, user can select the “new” 657 to create a visual caching strategy diagram or flowchart or concept map. After creating new blank file, User select “Replication Worker” block 615, “Install (Event)” block 620, “Activate (Event)” block 625, “Network” block 640, “Cache” block 630, draw line between blocks to indicate connections and order, provide values for selected or displayed (suggested) parameter e.g. Cache Name (Parameter or field) and user input values is “static_appshell_v1” and Select Static Content (Parameter or field) and user input values are selected files from FIG. 4 (405)/FIG. 22 (2205). Based on said drawing of diagram or flowchart of selected blocks and selected parameter specific inputs or values, the system automatically generates and updates configuration file 695

In an embodiment the replication worker 2620 installation process begins with the registration of it in JavaScript, which declares the browser where the replication worker 2620 configuration file 247 or JavaScript file 247 (contains configuration which describes files and data replication) is registered. Once the registration process is completed, the browser 245 starts to install the replication worker 2620 by defining a callback for the install event and setting up an environment to cache the files 2660.

During the install event, service worker caches the static content by executing pre-defined files synchronization including copying files, folders, resources of app package (from developer or publisher or provider server 135/145 or web apps/PWAs platform or web app store server 115) and data replication as per configuration file including installing database, creating database based on data structure and copying data (discussed in detail in FIGS. 22-23) or executing as per “On-install” caching strategy defined in configuration file 695, and when the caching 2660 is successful, the process of activation starts. If the caching process fails, then the activation event getsterminated and the service worker tires to install it in the next attempt.

The replication worker's 2620 “install” event 2710 is a strategic time to cache static assets 2665. Caching the application shell 2665 on install 2710/2765 ensures that the replication worker 2620 has access to all shell assets 2665. After activating 2770 the replication worker or application or component or replication-based service worker or app service 2620, all pages of the given scope 2401 will be controlled by the replication worker or application or component or replication-based service worker or app service 2620.

The successful caching and installation process which triggers the activation 2770/2715 event.

An activated replication worker 2620 (247) starts to receive fetch, push and sync events 2735/2760, when the user maneuvers to a different page 2605.

User or admin or developer user can prepare files, folders, package and associated replication worker configuration file 352 which includes files synchronization and data replication configuration settings for new version of application or web app or website or PWA. In the event of selecting checkbox 2420 to indicate availability of the new version, the registered replication or synchronization worker gets updated on reload. The browser 245 installs a new Replication or Synchronization Worker only if there is an update in the existing files or if it is the first time not in every page refresh.

Activation event is another event, which is executed as soon as the installation is finished. But not activated immediately instead will be activated depending on the availability of an old version of the Replication or Synchronization Worker. If the version of Service Worker running is not old, then it is activated otherwise, closing the existing browser tabs and reopening a new tab installs a new Replication or Synchronization Worker. Closing an existing browser tab and reopening a new tab is required to activate the Replication or Synchronization Worker since it is not attached to a single page, but to the overall domain or scope and lives, even after the browser is closed. Hence, doing so fires the activate event. After activating the Replication or Synchronization Worker, all pages of the given scope will be controlled by the Replication or Synchronization Worker.

User or admin or developer user can define file and data replication 2425 (as discussed in detail in FIGS. 22 and 23 (2310)) for the new version.

Users can select a template of caching strategy (e.g., “On Activate”) from list 805, which opens a template showing ready blocks, connections and order, default values of default relevant selected parameters and enables users to add, remove blocks, select or edit parameters and associated values. FIG. 8 shows, users can select “New” 857 to create a visual caching strategy diagram or flowchart or concept map. After creating new blank file, User select “Service worker” block 815, “Install (Event)” block 820, “Activate (Event)” block 825, “Deleted” block 830, “Cache” block 840, draw line between blocks to indicate connections and order, provide values for selected or displayed (suggested) parameter e.g., Cache Name (Parameter or field) and user input values is “cacheName” and Select Static Content (Parameter or field) and user input values is selected files from FIG. 4 (405)/FIG. 22 (2205). Based on said drawing of diagram or flowchart of selected blocks and selected parameter specific inputs or values, the system automatically generates configuration file 695. Once a new Replication Worker 815 has been installed and a previous version isn't being used, the new one activates 825, and gets an activated event 825. Because the old version is out of the way, it's a good time to handle schema migrations and also remove unused caches 840.

In another embodiment user or admin or developer user can merge files and data replication—push subscription (as discussed in detail in FIGS. 22 and 23 (2340)) to update files and data in client cache 2660 or storage 2665 or database 2670.

In an embodiment user can mark added files as Shell or cache only 2216 in file manager 2205 to provide indication or define Cache only strategy in which always answering 2610 from cache 2660 on fetch events 2615. In another embodiment enabling to define merge files and data replication-push subscription (as discussed in detail in FIGS. 22 and 23 (2340)) to update files and data in client cache 2660 or storage 2665 or database 2670 and in the event of changes in files marked as Shell or cache only, update said changed files and data in client cache 2660 or storage 2665 or database 2670.

In an embodiment enabling user or admin or developer user to set pre-set duration time 2452 for Network or Cache strategy.

Users can also select a template of caching strategy (e.g., “Cache only”) from list 1405, which opens a template showing ready blocks, connections and order, default values of default relevant selected parameters and enables users to add, remove blocks, select or edit parameters and associated values. FIG. 14 shows, user can select “New” 1457 to create a visual caching strategy diagram or flowchart or concept map. After creating new blank file, User select “Page” block 1415, “Service worker” block 1420, “Cache” block 1425, draw line between blocks to indicate connections and order, provide values for selected or displayed (suggested) parameter e.g., Cache Name (Parameter or field) and user input values is “Default” and Select Static Content (Parameter or field) and user input values is selected files from FIG. 4 (405). Based on said drawing of diagram or flowchart of selected blocks and selected parameter specific inputs or values, the system automatically generates and updates configuration file 1495.

In an embodiment enabling user or admin or developer user to provide generic fallback content 2458.

User can also select a template of caching strategy (e.g., “Generic Fallback”) from list 1905, which opens template showing ready blocks, connections and order, default values of default relevant selected parameters and enable user to add, remove blocks, select or edit parameters and associated values. FIG. 19 shows, users can select “New” 1957 to create a visual caching strategy diagram or flowchart or concept map. After creating a new blank file, users select “Page” block 1915, “Cache” block 1920, “Network” block 1925, “Service worker” block 1930, draw a line between blocks to indicate connections and order, and provide values for selected or displayed (suggested) parameters. Based on said drawing of diagram or flowchart of selected blocks and selected parameter specific inputs or values, system automatically generates code or in the event of selecting “Generates Code” button system automatically generates configuration file 1495.

In an embodiment user or admin or developer user is check and define content under this strategy 2460. Replication Worker 2620 (247) automatically behave as per this strategy i.e., serve said defined content from the cache 2660 and also perform a network request 2625 to get fresh content or data to update the cache entry 2660 ensuring next time the user visits the page 2605 they will see up to date content. In another embodiment user or admin or developer user can create or select or edit defined files/data merge publication/on demand pull subscriptions or push subscription (If any update) discussed in detail in FIGS. 22 and 23 (2340) and in the event of identifying request for content under this strategy, automatically execute or start said defined pull subscriptions for said defined content under this strategy.

In another embodiment user or admin or developer user can select template of caching strategy (e.g., “Stale-while-revalidate”) from list 1105, which opens template showing ready blocks, connections and order, default values of default relevant selected parameters and enable user to add, remove blocks, select or edit parameters and associated values. FIG. 11 shows, user can select “New” 1157 to create a visual caching strategy diagram or flowchart or concept map. After creating new blank file, User select “Page” block 1115, “Replication worker” block 1120, “Network” block 1125, “Cache” block 1130, draw line between blocks to indicate connections and order, provide values for selected or displayed (suggested) parameter e.g., Cache Name (Parameter or field) and user input values is “mysite-dynamic” and Select Static Content (Parameter or field) and user input values is selected files from FIG. 4 (405). Based on said drawing of diagram or flowchart of selected blocks and selected parameter specific inputs or values, the system automatically generates and updates configuration file 1195.

In an embodiment user or admin or developer user is check and define content under this strategy 2470. Replication Worker 2620 (247) automatically behave as per this strategy i.e., serve said defined content from the cache 2660 and but at the same time, perform a network request 2625 to update the cache entry 2660 and inform the UI/Page 2605 about new up to date content.

In another embodiment user or admin or developer user can create or select or edit defined files/data merge publication/on demand pull subscriptions or push subscription (If any update) discussed in detail in FIGS. 22 and 23 (2340) and in the event of identifying request for content under this strategy, automatically execute or start said defined pull subscriptions for said defined content under this strategy.

In another embodiment user or admin or developer user can select template of caching strategy (e.g., “On network response”) from list 1005, which opens template showing ready blocks, connections and order, default values of default relevant selected parameters and enable user to add, remove blocks, select or edit parameters and associated values. FIG. 10 shows, user can select “New” 1057 to create a visual caching strategy diagram or flowchart or concept map. After creating new blank file, User select “Page” block 1015, “Service worker” block 1020, “Network” block 1025, “Cache” block 1030, draw line between blocks to indicate connections and order, provide values for selected or displayed (suggested) parameter e.g., Cache Name (Parameter or field) and user input values is “mysite-dynamic” and Select Static Content (Parameter or field) and user input values is selected files from FIG. 4 (405). Based on said drawing of diagram or flowchart of selected blocks and selected parameter specific inputs or values, the system automatically generates and updates configuration file 1095.

In an embodiment user or admin or developer user can define On user interaction strategy 2505 and define content which allow the user to select the content they want available offline. e.g., a video on something like YouTube, an article on Wikipedia, a particular gallery on Flickr. For example, users can click on a “Read later” or “Save for offline” button from page 2605, when it's clicked, replication worker 2620 (247) receives a request to fetch said clicked button associated content from the network 2625 and store it in the cache 2660.

In an embodiment user or admin or developer user can also select template of caching strategy (e.g., “On user interaction”) from list 905, which opens template showing ready blocks, connections and order, default values of default relevant selected parameters and enable user to add, remove blocks, select or edit parameters and associated values. FIG. 9 shows, user can select “New” 957 to create a visual caching strategy diagram or flowchart or concept map. After creating new blank file, User select “Page” block 915, “Click (Event)” block 920, “Network” block 925, “Cache” block 930, draw line between blocks to indicate connections and order, provide values for selected or displayed (suggested) parameter e.g., Cache Name (Parameter or field) and user input values is “mysite-article-” and Select Static Content (Parameter or field) and user input values is selected files from FIG. 4 (405). Based on said drawing of diagram or flowchart of selected blocks and selected parameter specific inputs or values, system automatically generates and updates configuration file 995.

In an embodiment user or admin or developer user can select or define or create parameter based one-way server to client file synchronization 2507 to download clicked button associated defined uniform resource locator (URL) e.g., 936 associated identified file or content.

In an embodiment user or admin or developer user can create or select or edit Merge Replication (Merge Publication/Push Subscriptions) 2510 for receiving or fetching and storing or caching subscribed push notification and associated contents.

A notification is a message that pops up on the user's device. It can either be triggered locally by an open application or be pushed from the server when the app is in idle state. A push notification provides timely updates of content and data, which the user selects to opt-in. It plays an important role in re-engaging users and bringing them back to apps repeatedly. Push notification consists of: Notification API and Push API. The Notification API allows a web page, or a replication worker or a service worker, to create and control the display of system notification. Notifications appear on the device's UI (outside the browser) and thus exist outside of the context of any tab or browser window. Since they are independent of any tabs or browser windows, they can be created even after a user has left the site. The Notification API allows users to display notifications to the users. A permission is needed from the user to display notifications. The Push API allows handling messages that are pushed to the client from a server via the push service used by the browser. When a replication worker or service worker gets registered by the push service, it gives push events inside the replication worker or service worker. On this event, a replication worker or service worker fetches data that needs to be shown in the notification and uses Notification API to display a notification.

In an embodiment user or admin or developer user can select Cache, falling back to network 2515 to instruct the “cache only” behavior for things in the cache 2660 and the “network only” 2625 behavior for anything not-cached.

In an embodiment user or admin or developer user can select template of caching strategy (e.g., “Cache, falling back to network”) from list 1605, which opens template showing ready blocks, connections and order, default values of default relevant selected parameters and enable user to add, remove blocks, select or edit parameters and associated values. FIG. 16 shows, user can select “New” 1657 to create a visual caching strategy diagram or flowchart or concept map. After creating new blank file, User select “Page” block 1615, “Service worker” block 1620, “Cache” block 1625, “Network” block 1630, draw line between blocks to indicate connections and order, provide values for selected or displayed (suggested) parameter e.g., Cache Name (Parameter or field) and user input values is “Default” and Select Static Content (Parameter or field) and user input values is selected files from FIG. 4 (405). Based on said drawing of diagram or flowchart of selected blocks and selected parameter specific inputs or values, system automatically generates and updates configuration file 1695.

In an embodiment user or admin or developer user can select Network falling back to cache 2520 to instruct get defined content from network. This strategy is useful for resources that update frequently, outside of the “version” of the site. E.g., articles, avatars, social media timelines, and game leaderboards, give online users the most up-to-date content, but offline users get an older cached version. If the network request succeeds it's possible to update the cache entry. However, If the user has an intermittent or slow connection, they'll have to wait for the network to fail before they get the perfectly acceptable content already on their device. So, Cache then network strategy is a better solution.

In an embodiment user or admin or developer user can create or select or edit Merge Replication (Merge Publication/Push Subscriptions) 2522 for defined content for this strategy. In the event of identifying update contents in defined resources, contents, files and data, server-side replication application or module 2650 automatically runs or starts said defined files synchronization and/or data replication to push updated contents from network. In another embodiment user can also configure pull subscriptions to on request get updated content from the network.

In an embodiment user or admin or developer user can select template of caching strategy (e.g., “Network, falling back to network”) from list 1805, which opens template showing ready blocks, connections and order, default values of default relevant selected parameters and enable user to add, remove blocks, select or edit parameters and associated values. FIG. 18 shows, user can select “New” 1857 to create a visual caching strategy diagram or flowchart or concept map. After creating new blank file, User select “Page” block 1815, “Cache” block 1820, “Network” block 1825, “Service worker” block 1830, draw line between blocks to indicate connections and order, provide values for selected or displayed (suggested) parameter e.g., Cache Name (Parameter or field) and user input values is “Default” and Select Static Content (Parameter or field) and user input values is selected files from FIG. 4 (405). Based on said drawing of diagram or flowchart of selected blocks and selected parameter specific inputs or values, system automatically generates and updates configuration file 1895.

In an embodiment user or admin or developer user can select Cache then network 2525 to enable this strategy wherein, this requires the page 2605 to make two requests, one to the cache 2660, and one to the network 2625 for pre-defined content, files, data. The idea is to show the cached data first, then update the page when/if the network data arrives. Sometimes it needs to replace the current data when new data arrives (e.g., game leaderboard).

In an embodiment user or admin or developer user can create or select or edit Merge Replication (Merge Publication/Pull Subscriptions) 2530 for defined content for this strategy. In the event of receiving requests from clients and identifying update contents in defined resources, contents, files and data, server-side replication application or module 2650 automatically runs or starts said defined files synchronization and/or data replication to get most updated contents from the network.

In an embodiment user or admin or developer user can use templating strategy 2540 for pages that cannot have their server response cached. If the page is controlled by a service worker, choose to request defined JSON data along with a defined or selected template, and render that instead.

In an embodiment user or admin or developer user can select this strategy 2545 and define background synchronization 2550 (discussed in detail in FIGS. 22-23), it allows to request background data synchronization. This happens even when the user doesn't have a tab open to a site or web app or PWA. Only the Service Worker is woken up. This strategy is useful for non-urgent updates, especially those that happen so regularly that a push message per update would be too frequent for users, such as social timelines or news articles.

In another embodiment, a user can define one-way files and/or data synchronization 2555 from client/cache 2660 to server 2625 (2635) or server 2625 (2635) to client 2660.

Another important embodiment automatically synchronizes files and data related to websites or web apps or progressive web apps (PWA). User or admin or developer user needs to provide domain name or uniform resource locator (URL) or path of folders and associated files (static content) of named web app package on server and client and identified named server and client database. Initially or at the time of installation of web app or PWA, automatically copy or synchronize files (one-way from server to client) and full partial data (snapshot replication) related to web app from server. After that, automatically snapshot (in the event of new version), merge (updates in files/data) publications and pull and push (subscription), one-way or two-way, rules and schedule base files synchronization and data replications are happen based on page requests from client, identification of events including fetch, push and sync events, monitoring and tracking of updates in files and data in client or server, network conditions or quality, types of files and data, logged history of requests, user interactions, responses and visits, data storage availability, most frequently used page or feature or part of application, type or name of button (e.g. save offline, view later), identification of frequent updated contents, name of files, size of files, rank of files or content, files associated metadata including marked files and data (shell, updatable, important, downloadable, updatable, fallback, needed, bookmarked, favorite, liked, most used), identification of new version, user privacy settings and preferences. Based on request or triggering of events including fetch, push and sync., Replication workers (247) automatically use resources or contents or files from local cache from local storage and database or fetch required or unavailable or updated resources, contents, files and data from the network including server storage or database. For example, when user installs microblog or social network or news web app or PWA, during installation, it copies web app package files or required files or app shell files (from developer or publisher or provider server 135/145 or Web apps/PWAs Store or Platform Server 115), so then only need updated files and dynamic contents or data from server. After registration, installation and activation of replication worker (247), replication worker (247) monitors and tracks incoming request, current network condition, non-availability of resources in cache. In the event of receiving request or triggering of fetch event, replication worker (247) first checks cache and if network available then server-side updates (if any), If updates then auto run files and data replication (server to client) and copies or merges updated files and data. If the network is not available then it shows content or data from cache. At the time of receiving the request, if the network is not available then later check and update (if any update) said request associated updated contents and data from server for next time. If request specific cached content is not available and network also not available then display predefined generic fallback contents. If the app is not open and if the network is available then in background synchronize files and data as per merge publication(s) and pull and push subscriptions. In the event of detection of new versions automatically remove old versions or replace with new version associated files and data. In the event of quality of network is not as per required threshold then use cached data and identify flag of updated data, if not update then well good and if update then synchronize rank wise or priority wise or requirements or request or preference wise or specific updated files, contents, resources and data (e.g. updated price of products) or notify user that files or data (price, news, feed, emails, message) are updated but due to poor network condition, at present showing old or earlier version data or files and in the event of detecting good or require network condition, background synchronize updated files and data and notifying user about good network conditions, arrival or availability of new files, contents and data and based on selection of notification or opening of app automatically display updated files or data or automatically open app and automatically display updated files or data. Based on user settings apply in background push subscriptions to update updated files and data or apply pull on-demand or request or preference specific updated files, contents, resources and data. Based on allocated storage for web app cache storage, system automatically assign priority & rank and automatically synchronize updated files and data based on assigned priority & rank, wherein automatically assign priority & rank to one or more or marked files, folders, data, uniform resource locator (URL) or feature is based on request, logged data including user visits to page, user actions, activities, interactions, transactions with/in/within/on visited page(s) or features, network conditions, availability of cached contents, files, and data, identification of updates in contents, files, and data, user preferences and settings, contents or messages or emails sent or posted by identified ranked contacts or connections or followed or subscribed sources or sources, paid contents, system or app required files or data (e.g. updates in app shell), liked or reacted contents, purchased or liked products and services, user profile, most viewed or popular contents (based on number of views or listens or reads and reactions including most liked or commented), current location, QR code scan, voice command, keywords, user related data, global preferences and settings (interests, interacted entities data, user related data from linked system, identified keywords, transactions, reactions, actions, status, locations, sharing, participations). In another embodiment automatically remove contents, files data from cache (local storage of files and local data from database) based on non-availability of storage (system and user allocated storage for particular web app or PWA) or identification of storing more priority or ranked specific contents, files and data, manual removal of selected (searched, matched, filtered and selected) contents, files, and data instruction from user, auto replacing updated contents, files, and data, removal of old version or uninstall of web app, update or upgrade in web app, user settings for automatically remove certain types of contents including remove daily news, remove already read message or news or contents or emails or notifications, selected apps remove after particular period of time (use web app on-demand for non-frequent sue apps), remove not accessed contents, files and data within particular pre-defined period of time (i.e. remove less used or less required contents, files and data).

In an embodiment enabling user or admin or developer user to select network only strategy 2570 for things that have no offline equivalent, such as analytics pings, non-GET requests.

After configuring caching strategies, user or admin or developer user can save configuration file 2581 related to particular website or web app or progressive web app (PWA), test one or more strategies in test or demo or sample project environment 2582, orchestrate or order different configured strategies, user can select and edit configuration file 2584, remove file 2585 and visually draw, define, edit caching strategy based on providing values for selected caching strategy associated parameters.

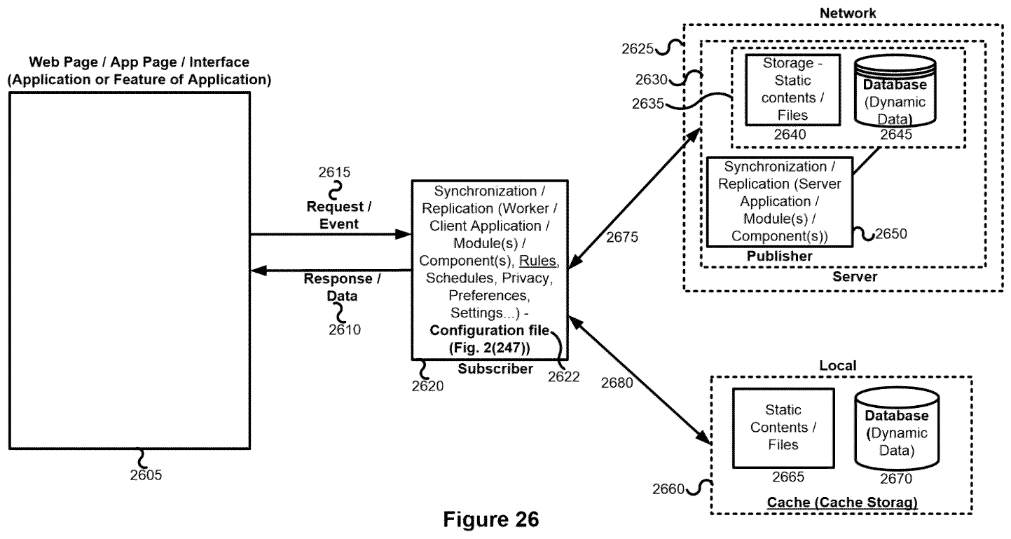

FIG. 26 shows the fetching and caching strategy of replication worker or application or component or replication-based service worker or app service.

In another embodiment in progressive web app (PWA) context, the web as it is today is rich and useful but when users visit a web app; when they have poor connection or have lost their connectivity, they are shown the page ‘there is no internet connection’. The offline state of the web app could not provide any useful information to users. But the introduction of a synchronization component or worker or replication model-based service worker has turned this error into something that can be handled with grace. A Replication Worker or synchronization or static content or files and dynamic contents or data replication models or topology-based Service Worker is an event-driven component that runs in the background separately from the webpage, reacts to events and intercept network requests of application or website with server and resources. It works as a proxy between the network and the browser. It can run even when the application is closed, thus it serves to trigger events even when the site is closed. It also supports push notifications and background sync, periodic sync. Since it can intercept the request, modify content or even completely replace it with new responses, only pages served over secure connections (HTTPS) can register a Replication Worker or replication application or module or component (247).

As illustrated in FIG. 26, the Replication Worker or replication application or module or component 2620 sits (247) in between the web app/PWA/application (243) 2605/2660 and the network 2625 and decides when it should get the content from cache 2660 and when to get from the network 2625 (120).

A simple news web app written without Service Worker or replication worker or application or component or replication-based service worker or app service will show standard “You are offline” message, when the connection is lost or low quality. However, an app, which has replication worker or application or component or replication-based service worker or app service 2620 running, can show cached GUI, run scripts and can even show the user cached contents 2660 from a previous visit. It can also log data sent to server and dispatch when the internet connection is available via sync events, and receive push notifications from the server via push events as shown in FIGS. 22-26. It facilitates caching of the app shell 2665, allowing it to load without the network 2625. Replication worker or application or component or replication-based service worker or app service 2620 caches app shell and content 2665 when an application is loaded over the network and shows it to the users when they have poor connection or are out of network.

As replication worker or application or component or replication-based service worker or app service 2620 is an event-driven component or application or executed set of instructions, it wakes up with events and runs only if it needs to process the event. Through its developer can treat the network as enhancement, control caching of resources in a proper way. Control over the cached resources plays an important role in developing offline applications, which is one of the key features of progressive web apps (PWA). Via replication worker or application or component or replication-based service worker or app service 2620 the webpage 2605 is available even offline and with cached data 2660 loads faster even on a flaky or slow and unstable network 2625. It has a totally separated lifecycle from a web page 2605.

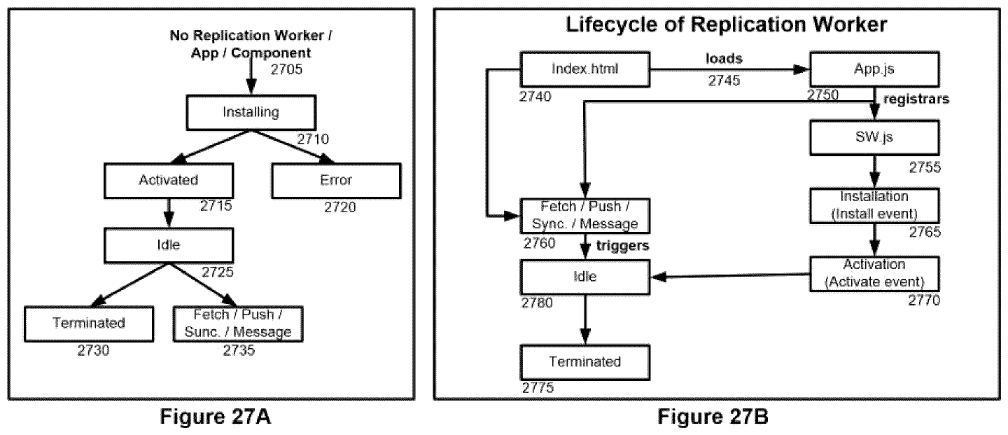

As illustrated in FIG. 27A, the replication worker or application or component or replication-based service worker or app service 2620 installation process 2710 begins with the registration of it in JavaScript, which declares the browser where the replication worker or application or component or replication-based service worker or app service 2620 configuration file 2622 is registered.

It makes user whether the replication worker or application or component or replication-based service worker or app service API is accessible, and if it is there, the replication worker or application or component or replication-based service worker or app service 2620 at configuration file 2622 is registered when the page is loaded 2605.

Once the registration process is completed, the browser 245 starts to install 2710 the replication worker or application or component or replication-based service worker or app service 2620 (247) by defining a callback for the install event 2710 and setup an environment to cache the files 2660. During the install event 2710, the replication worker or application or component or replication-based service worker or app service 2620 caches the static content or caches the static content 2660 based on configured file 2622 snapshot publication or on-way publication and pull or push subscriptions (discussed in detail in FIGS. 22-23 and 24 (2415/2422)), and when the caching is successful, the process of activation 2715 starts. If the caching process fails, then activation event 2715 gets terminated 2730 and the replication worker or application or component or replication-based service worker or app service 2620 tires to install in the next attempt.

The successful caching and installation process which triggers the activation event. An activated 2715 replication worker or application or component or replication-based service worker or app service 2620 starts receiving fetch, push and sync events or request 2615, when the user navigates or interact or maneuvers to a different page 2605.

The replication worker or application or component or replication-based service worker or app service 2620 responding to the fetch, push and sync events or request 2615. As mentioned earlier, the replication worker or application or component or replication-based service worker or app service 2620 is event driven and has a lifecycle totally separated from a webpage 2605, which can be manipulated as per need. The replication worker or application or component or replication-based service worker or app service 2605 can either be terminated 2730 to save memory or carry out the next step where it controls events, fetches and messages 2735.

FIG. 26 shows that layout, style and static content is fetched from the cached data 2665 whereas dynamic content 2645 is fetched from the network 2625 which improves the loading speed and performance of web app 2605.

Application shell (architecture) is the minimum HTML, CSS and JavaScript needed to build basic representational User Interface 2605 of a progressive web app (PWA). It is one of the main factors that provide instant loading, smooth UI/UX and good performance on repeat visits. An app shell is cached 2665 immediately which means that the shell files are loaded once over the network 2625 and then saved to the local device 2665. Thus, whenever the user uses the app 2605, the shell files 2665 are rendered from the local device's cache 2605, which gives fast startup times. App shell model divides application into shell 2665 and content 2645 (network/online)/2670 (offline/cached).

The shell includes the static parts 2665 of the application 2605 needed to show the content. It keeps the UI local and gets all the content dynamically through an API. Thus, the caching of the whole shell 2665 ensures that even if there is no internet connection or connectivity is poor, the application loads at least the familiar UI and the user is not conferred with a bare screen or a default connection failure message.

An app shell is the same as the package or bundle of program or code that is published to an app store when publishing a native app. It is the most required component essential to start app but does not contain any data. The content or dynamic data 2670 is presented within the shell 2665/2605. Depending on the application type, the content or data can also be cached 2670.

Users can define app shell architecture to increase speed, performance, instant loading and updates. There are several models, patterns, rules, and constraints for designing App-shell architecture. App-shell should at least include what resources, UI plug-in and components are required for the app shell like images, styles, JavaScript.

As shown in FIG. 26, the replication worker or application or component or replication-based service worker or app service 2605 can either load resources from the cache storage 2660 or fetch them through the online network 2625 according to the network conditions. These programmable interfaces dramatically improve the online and offline browsing experiences of Web application users.

The Fetch event is an HTTP request event 2615, which is initiated by the client or page 2605 related JavaScript/configuration file 2622. Furthermore, the replication worker or application or component or replication-based service worker or app service 2620 receives Web Push Notifications from the server 2630 and the user interacts with displayed notification. In addition, the replication worker or application or component or replication-based service worker or app service 2620 receives a Background Sync event for instance when an internet connection is restored. Finally, Replication worker 2620 has an event, which changes the life cycle of the replication worker or application or component or replication-based service worker or app service 2620.

FIG. 27A illustrates the Replication Worker registration process. Replication Workers 247 essentially act as proxy servers that sit between web applications 243, the browser 245, and the network (when available) 120. They are intended, among other things, to enable the creation of effective offline experiences, intercept network requests and take appropriate action based on whether the network is available, and update assets residing on the server. They will also allow access to file and data replication as per associated rules and defined strategy, push notifications and background sync APIs.

A replication worker is an event-driven worker registered against an origin and a path 2401. It takes the form of a configuration file 2402, configured or set by developer or admin or user as discussed in FIGS. 22-25, that can control the web-page/site that it is associated with, intercepting and modifying navigation and resource requests, and caching resources in a very granular fashion to give complete control over how app behaves in certain situations (the most obvious one being when the network is not available).

A replication worker is run in a worker context: it therefore has no DOM access, and runs on a different thread to the main JavaScript that powers the app, so it is non-blocking. It is designed to be fully async; as a consequence, APIs such as synchronous XHR and Web Storage can't be used inside a replication worker. Replication workers only run over HTTPS, for security reasons.

A replication worker is first registered using the API method. If successful, service worker will be downloaded to the client and attempt installation/activation (see below) for URLs accessed by the user inside the whole origin, or inside a subset 2401 specified by admin or developer user of web app or PWA or website.

The replication worker is immediately downloaded when a user first accesses a replication worker-controlled site/page/web app/PWA.

After that, it is updated when a navigation to an in-scope page occurs and an event is fired on the replication worker. Installation 2710 is attempted when the downloaded file (configuration file (FIGS. 22-25) or generated or edited based on wizard or visual user interface as discuss in detail in FIGS. 6-20) is found to be new—either different to an existing replication worker (byte-wise compared), or the first replication worker encountered for this page/site/web app.

If this is the first time a replication worker has been made available, installation 2710 is attempted, then after a successful installation, it is activated 2715.

If there is an existing replication worker available, the new version is installed in the background, but not yet activated—at this point it is called the worker in waiting. It is only activated when there are no longer any pages loaded that are still using the old replication worker. As soon as there are no more pages to be loaded, the new replication worker activates (becoming the active worker).

It's possible to listen for the install event; a standard action is to prepare replication workers for usage when this fires, for example by creating a cache using the built-in storage API, and placing assets inside it for running apps offline.

There is also an activated event. The point where this event fires is generally a time to clean up old caches and other things associated with the previous version of replication worker.

Replication workers can respond to requests using the fetch event 2735. It's possible to modify the response to these requests in any way the user or developer want, using the fetch event response method of API.

During the install event 2710, replication worker caches the static content, and when the caching is successful, the process of activation starts. If the caching process fails, then the activation event gets terminated at 2730 and replication worker tires to install in the next attempt. The successful caching and installation process which triggers the activation event. An activated 2715 replication worker starts receiving fetch 2735, push and sync events, when the user maneuvers to a different page.

FIG. 27B illustrates, in an embodiment like any traditional web application, first, the index.html file 2740 loads the app.js file 2750. In the app.js file 2750, to register a replication worker or application or component or replication-based service worker or app service 2620, the developer configure replication (discussed in detail in FIG. 22-23) and associated caching and fetching rules (discussed in detail in FIGS. 24-25 and 6-20) and the configuration settings exists in a separate file 2622/2402.

After activating 2770 the replication worker or application or component or replication-based service worker or app service 2620, all pages of the given scope 2401 will be controlled by the replication worker or application or component or replication-based service worker or app service 2620.

Replication worker or application or component or replication-based service worker or app service 2620, activate 2770 automatically as soon as events are coming in, for instance, a fetch event 2615/2735 and all other events 2615/2735. If a fetch event 2615/2735 occurs either due to an HTML file 2605 requesting a resource 2615 or the developer sending a fetch request in the JavaScript code, the replication worker or application or component or replication-based service worker or app service 2620 is activate 2770 and trigger a fetch event 2760 and then put back to idle mode 2780. Storing data as a key-value pair (Key: Request and Value: Response) 2665 when there is the connection and fetching them when the application is offline. Cache data 2665 can be retrieved instead of network request 2625.

In an embodiment replication worker 2620 can be accessed by many main threads (running in different browser tabs) at the same time. In an embodiment only one replication worker 2620 is allowed per scope (i.e., defined or provided a URL Path) 2401 on the browser.

Unlike web workers, where a web worker is coupled with the main thread, once replication worker 2620 is started by the main thread, it does not get killed even when that thread dies or when the browser is closed. In an embodiment Network requests 2675 coming from the main thread goes through replication worker 2620. Hence replication worker 2620 acts like a man in the middle who has authority to transform network request and response 2675. By using replication worker it's possible to cache web pages and/or web assets 2660 and return this cached data 2610 back instead of transmitting requests over network 2675.

A replication worker 2620 is a type of web worker. It's essentially a replication and cache rules configuration file 2622 (2233/2291/2292) that runs separately from the main browser thread, intercepting network requests 2115, caching or retrieving resources from the cache 2660, and delivering push messages. Because workers run separately from the main thread, replication workers 2620 are independent of the application 2605 they are associated with. The replication worker 2620 works in asynchronous mode. The replication worker 2620 can receive push messages from a server 2630 when the app is not active 2605. This lets app 2605 show push notifications to the user, even when it is not open in the browser 2605.

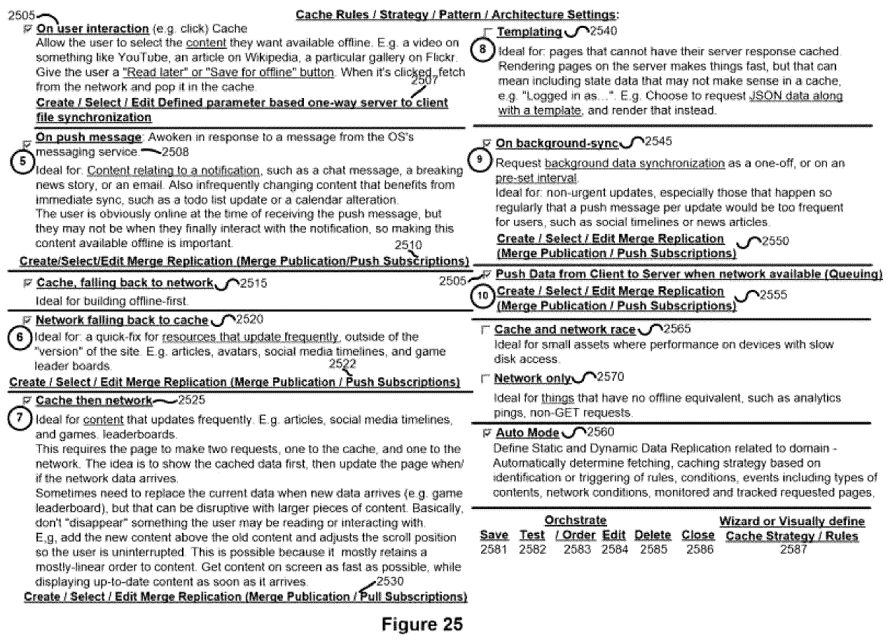

Replication workers 2620 enable applications 2605 to control network requests 2675, cache 2660 those requests to improve performance, and provide offline access to cached content 2660. Replication workers depend on Fetch (a way to retrieve content from the network) 2615 including configured files and data replication models (discussed in FIGS. 22-23) and defined rules and strategies (discussed in FIGS. 24-25) and Cache (a persistent content storage for application data) 2660. This cache 2660 is persistent and independent from the browser cache or network status.

Caching resources 2660 will make content load faster under most network conditions. See FIGS. 22-25 and FIGS. 4-20 for a list of caching strategies, rules, patterns, models, topology and architecture.

Using the Fetch inside a replication worker 2620, intercepting network requests 2615 and then modifying the response 2610 with content other than the requested resource. So, it's possible to use this technique to serve resources 2610 from the cache 2660 when the user is offline.

The replication worker's “install” event 2710 is a strategic time to cache static assets. Caching the application shell on install 2710/2765 ensures that the replication worker 2620 has access to all shell assets 2665 (if any assets fail to cache, the replication worker installation is aborted 2720).

The fetch event 2735 listener intercepts all requests 2615. Replication worker 2620 receives said requests 2615 and creates or responds with a custom response 2610 to the request 2615. Users can use caching strategy including the Cache falling back to network strategy: first check the cache for the requested resource based on received uniform resource locator (URL) or link associated matched resources, values, content, files and data and then, if that fails, send the request to the network.

In addition to caching predetermined files by using replication worker/application/Models, it's also possible to dynamically add files to the cache as they are requested by using replication worker/application/Models.

The scope of the replication worker determines which files the replication worker controls, in other words, from which path the service worker will intercept requests. The default scope is the location of the replication worker file, and extends to all directories below. So, if the replication worker and rules configuration file is located in the root directory, the replication worker will control requests from all files at this domain. In an embodiment user can also set an arbitrary scope by passing in an additional parameter when registering or via replication worker and rules configuration file.

Once activated, the replication worker controls all pages that load within its scope, and starts listening for events from those pages.

By using caching and storage techniques, replication workers enabled web apps, and can pre-cache parts of a web app so that it loads instantly the next time a user opens it. Using a replication worker gives web app the ability to intercept and handle network requests, including managing multiple caches, minimizing data traffic, and saving offline user-generated data until online again. This caching allows developers to focus on speed, giving web apps the same instant loading and regular updates seen in native applications.

In application shell model which contains the local resources that web app needs to load the skeleton of user interface so it works offline and populates its content using JavaScript. The shell of the functionality is loaded and displayed to the user (and potentially cached by the service worker so that it can be accessed offline), and then the page content is loaded dynamically as the user navigates around the app.

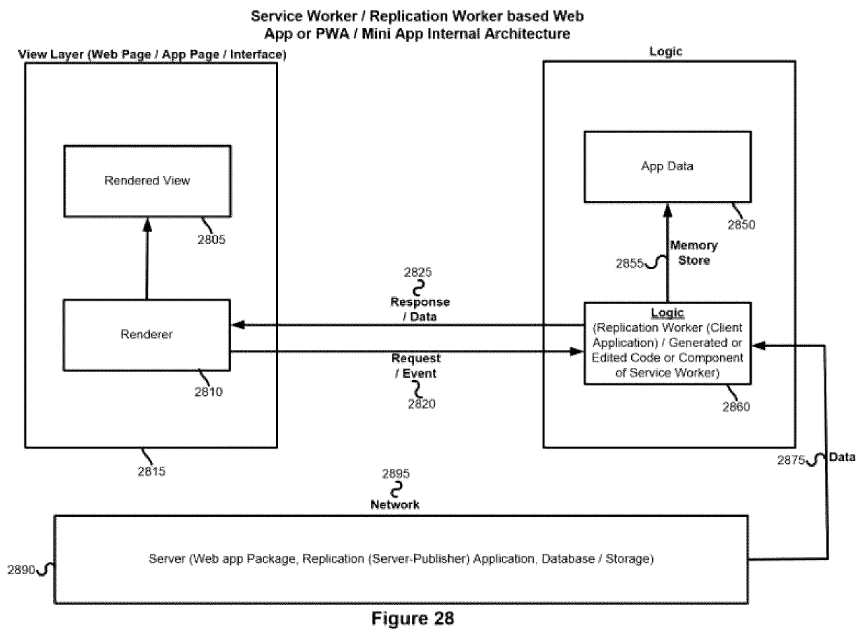

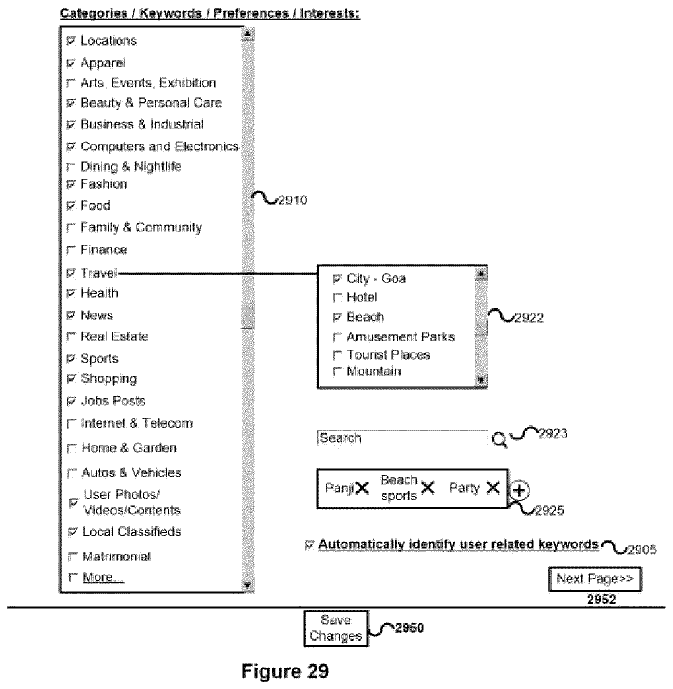

FIG. 28 illustrates block diagrams describing the storage medium that stores a first application program, and other application programs that are downloaded via the network 2895 (2890). Executing the first application program in an operating system. The execution of the first application program provides a running environment for other application programs. Further, executing a second application program in the running environment that is provided by the execution of the first application program. The execution of the second application program starts a replication logic process 2860 and a first view process 2810 corresponding to a first view page 2815 of the second application program. The replication logic process 2860 and the first view process 2815 respectively interface with the running environment that is provided by the execution of the first application program. The replication logic process 2860 generates initial first page data based on first replication logic configuration settings 2860, fetched and cached or strode resources, contents, files and data 2850 of the first view page 2815. Then transferring, via the running environment, the initial first page data 2820 from the replication logic process 2860 to the first view process. Further, rendering, in the first view process, the first view page 2805 according to the initial first page data of the first view page 2815.

In some embodiments transferring, via the running environment, updated data for a portion of the first view page 2615 from the replication logic process 2860 to the first view process 2810. Then, re-rendering, in the first view process 2810, the portion of the first view page 2805 according to the updated data 2850 for the portion of the first view page 2815/2805.

In some embodiments, in the running environment, global replication configuration settings of the second application program are The parent application based on a program identifier of the second application program. Starting, in the running environment, the replication logic process and the first view process according to the global replication configuration settings of the second application program. Further, in the replication logic process, the first replication configuration settings of the first view page when the replication logic process of the second application program starts. Acquiring, in the replication logic process, the initial first page data of the first view page, according to the first replication configuration settings, after completion of an initialization in the first view process, and sends, via the running environment, the initial first page data of the first view page, from the replication logic process to the first view process corresponding to the first view page.

In some embodiments, starting in the running environment, the replication logic process according to a global configuration logic in the global replication configuration settings of the second application program, and starts, the first view process according to a global feature of the first view page that is defined by global page configuration settings in the global replication configuration settings of the second application program. The global page configuration settings define global features for view pages of the second application program.

In some embodiments a parent application program runs on an operating system, the parent application program provides a running environment for the sub-application program replication logic layer unit 2860 and the first sub-application program view layer unit 2815/2810, acquires initial page data 2825 through the sub-application program logic layer unit 2860, and implements rendering 2810 of the first page 2815 through the first sub-application program view layer unit 2815. Thus, when the parent application program is running, a page that belongs to a sub-application program can be executed. Furthermore, when the first page is changed, only an updated part needs to be rendered. Furthermore, the sub-application program logic layer unit 2860 and the first sub-application program view layer unit 2815 separate a view layer 2815 and a logic layer 2860 of the application program.

The parent application program is an application program (not shown in figure) providing an environment for executing a sub-application program comprises pages or app pages or interfaces wherein one or more or group or each page or app page or interface comprising logic layer 2860 and view layer/renderer 2810. The parent application program is a native application program. The native application program is an application program that can run on an operating system directly. The sub-application program is an application program that can be executed in an environment provided by the parent application program. The sub-application program comprises e-commerce application, booking application, ordering application, table reservation application, colander application or any type of application.

The sub-application program logic layer unit 2860 and the corresponding sub-application program view layer unit 2810 are configured to implement an example of a sub-application program. One sub-application program can be implemented by one sub-application program logic layer unit 2860 and at least one sub-application program view layer unit 2810. The sub-application program view layer units 2810 may be one-to-one corresponding to the sub-application program pages 2815. The first sub-application program view layer unit 2810 is one of at least one sub-application program view layer unit 2810, is corresponding to the first page 2815, and is configured to organize the view of the first page 2815 and render the first page 2810.

The sub-application program view layer unit 2810 is configured to organize and render a view 2805 of a sub-application program. The sub-application program logic layer unit 2810 is configured to process the sub-application program and data processing logic 2860 of a corresponding sub-application program page 2815. The unit may be specifically a process or thread, the sub-application program view layer unit (renderer) 2810 is, for example a sub-application program view layer thread, and the sub-application program logic layer unit 2860 is, for example, a sub-application program logic layer thread (e.g. service worker/replication worker and associated independent or separate thread to presentation or view layer or renderer thread). The sub-application program logic layer unit 2860 may run in a virtual machine. The sub-application program view layer unit 2810 and the sub-application program logic layer unit 2860 may conduct caching, fetching, transfer and communications through the parent application program native unit, the parent application program native unit is an interface for communications between the parent application program and the sub-application program, and the parent application program native unit may be a thread or process of the parent application program.

The logic code 2860 of each sub-application program page 2815 includes logic code (e.g. service worker code or generated code as discussed in detail in FIGS. 4-21 or replication worker and replication worker configuration settings file as discussed in detail in FIGS. 22-27) of the first page 2815 and a second page 2815, and may be registered at the time of installation of web app/mini app and service worker or may be registered by the sub-application program logic layer unit 2860 when being started. The first page 2815 may be a home page of a sub-application program, so that the sub-application program logic layer unit 2860 can directly acquire 2855 the initial page data from app data/cache 2850 or from the network (e.g. server 135/145) of the first page 2815 after being started and send the initial page data 2825 of the first page 2815 to the first sub-application program view layer unit 2810 corresponding to the first page 2815. The first page 2815 may also be a sub-application program page specified by the parent application program, so that the sub-application program logic layer unit 2860 can acquire 2855 the initial page data 2850 of the first page 2815 after the parent application program specifies the first page 2815 and send the initial page data 2825 to the first sub-application program view layer unit 2810 corresponding to the first page 2815 for rendering 2805.

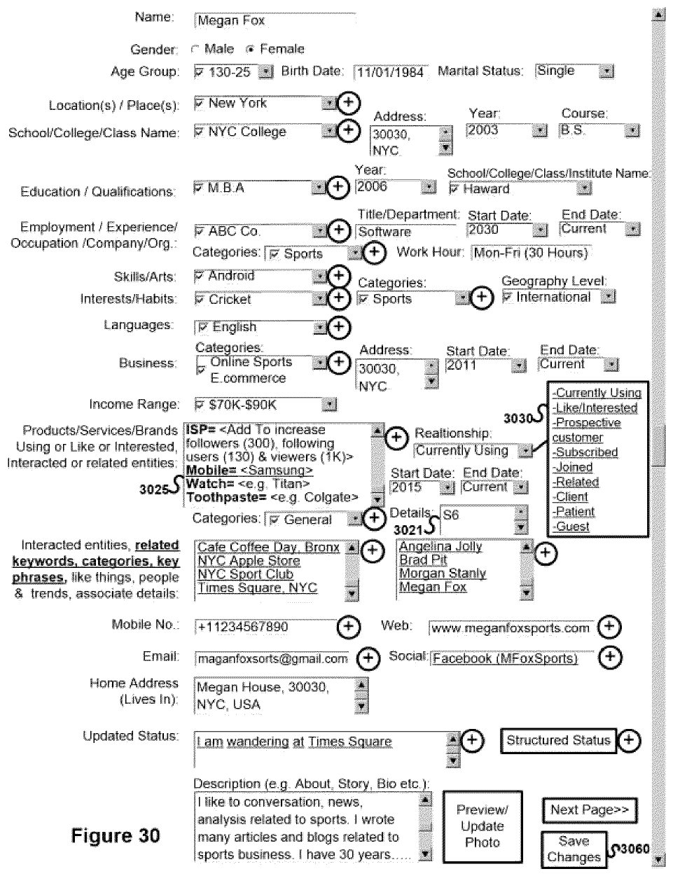

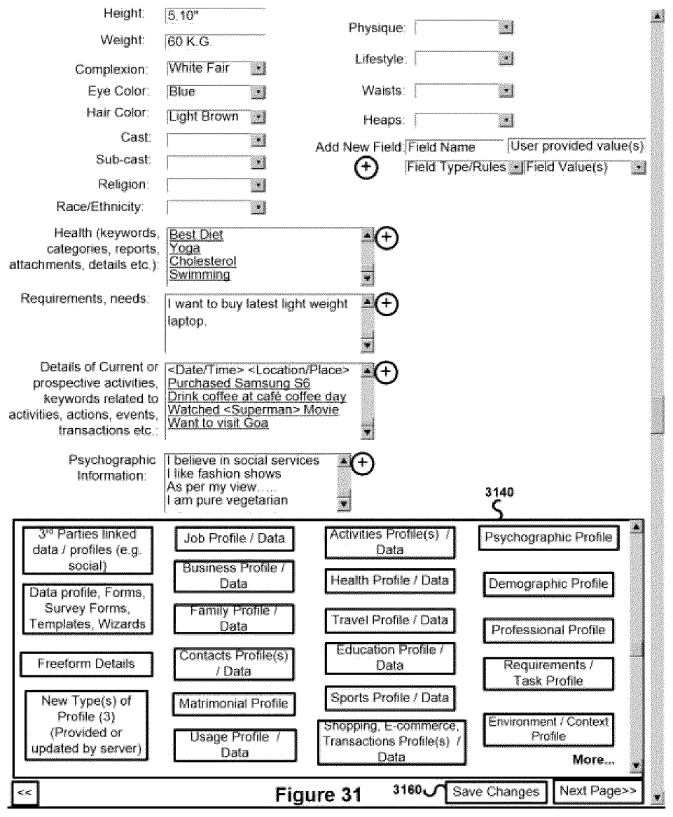

FIGS. 29-31 illustrates exemplary user provided, updated, user related plurality types of data including user related keywords, categories, sub-categories, preferences and interests 2910. Users are enabled to search 2923 and add keywords 2925. User can select automatically identified user related keywords 2905, wherein automatically identifying user related keywords are based on monitored and tracked user related activities, actions, transactions, participations, communications, sharing, reactions, status from one or more sources, linked systems and databases, voice of user, scanning of QR codes or objects, searching, taking call-to-actions, received or viewed or sent or posted messages, SMS, phone calls, emails, reactions, posts, location associated keywords. Users can save changes 2950 and select next 2952 in the wizard or user interface. FIGS. 30-31 shows user is enabled to provide different types of profiles information including personal, business, job, interest profiles like name, age, gender, school, college, skills, activities, contact information, connections, home and office locations, information about interacted entities and associated relationships, used, list of liked, purchased, subscribed, interacted and currently using brands, products and services, and like. Also, the system automatically monitors, tracks and logs user related activities, actions, transactions, status, communications, participations, call-to-actions, locations, places and associated details from one or more sources including 3^{rd} parties linked or connected or accessed systems, databases, networks, applications, devices.

After collecting, storing, updating, analyzing, identifying plurality types of user related data from plurality of sources, the system applies one or more types of rules, triggers and strategies for identifying matched and contextual web sites and applications including web apps and progressive web apps (PWAs).

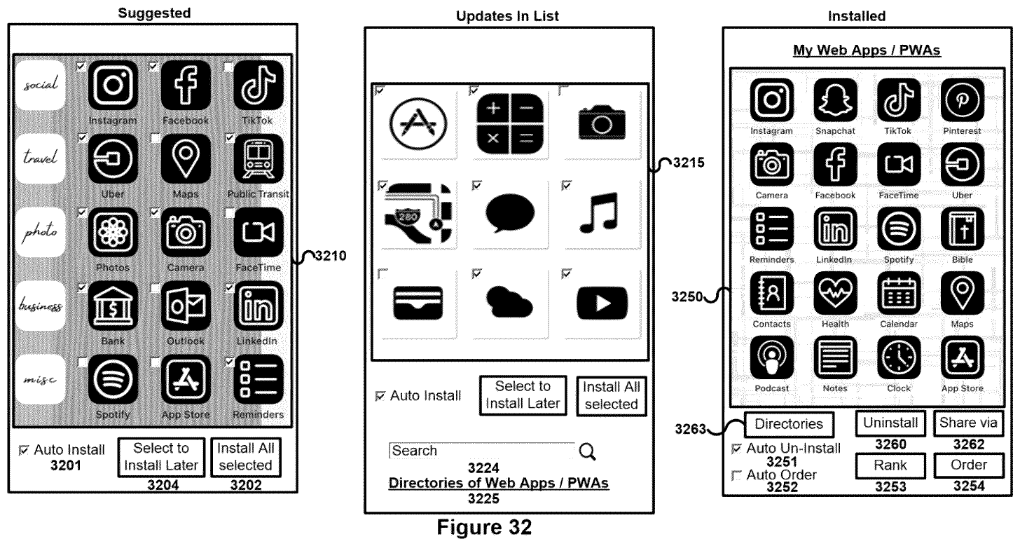

FIG. 32 illustrates displaying of suggested web apps and progressive web apps (PWAs) 3210 (248), wherein suggested web apps and progressive web apps (PWAs) are based on plurality of factors (354) including said user related data from one or more sources including user provided, user received, automatically monitored and tracked from one or more source including linked, connected or accessed systems, databases, networks, devices, applications, websites, servers. In an embodiment enabling user to select or set automatically install option 3201 to automatically install suggested web apps/PWAs 3210. In another embodiment enabling the user to select web apps/PWAs from suggested list of web apps/PWAs 3210 and install all selected web apps/PWAs 3202.

In another embodiment based on updated data related to user from one or more sources including user provided, received by user, user related data from 3^{rd} parties linked, connected or accessed systems, databases, networks, devices, applications, websites, servers, automatically identify and suggest and display updated list of web apps/PWAs 3215. In another embodiment enabling the user to search web apps/PWAs 3202 based on search queries 3224 and select from search results one or more web apps/PWAs and install selected web apps/PWAs 3225.

In another embodiment enabling the user to view and open a list of installed web apps/PWAs 3250. In another embodiment enabling user to select automatically uninstall option 3251 to automatically uninstall web apps/PWAs, wherein automatically uninstall web apps/PWAs based on identification of non-used web apps/PWAs for particular period of duration, identification of shortage of user device storage, due to shortage of user device storage, need to install more prioritize web apps/PWAs, indication from server, reactions of user.

In another embodiment enabling user to select option for automatically order 3252 web apps/PWAs, wherein automatically order web apps/PWAs based on frequency of user or opening of web apps/PWAs, current location, recency of use, triggering of event including action, status, receiving of push notification or message or SMS or phone call or email, identification of transaction, current activity or action, used by connected users, monitored and tracked user behavior, date and time of opening of app, rank of app by server or user or auto identified rank, membership, paid apps, subscription, receiving of new contents, news, posts, message, email, reactions on posted contents, due reminder or calendar entries or alarm. In another embodiment enabling the user to manually order 3254 web apps/PWAs. In another embodiment enabling users to provide rank 3253 to one or more selected web apps/PWAs.

In another embedment user can select one or more web applications or progressive web applications (PWAs) (service worker or replication worker enabled) from one or more types of automatically created lists or directories 3210/3215 including suggested or updates list of web applications/PWAs and can add to one or more lists including system provided or user created list(s) of web applications/PWAs to install added web app(s)/PWA(s) later or when select or when require 3204, wherein list comprises bookmarks, liked, type of activities, type of tasks, home, office, job, business, current, used brands, liked brands, health, travels, new, temp, contacts, social networks, communications and like. In the event of selecting name or icon or link or control or list item of one or more web app(s)/PWA(s), installing web app(s)/PWA(s) and opening installed web app(s)/PWA(s). In an embodiment user can select installed web apps or added web apps and uninstall 3260 installed selected web apps or remove 3260 from list added web apps. In an embodiment user can share a uniform resource locator (URL) of web apps via one or more sharing applications, communication interface or mediums or channels including email, SMS, phone or voice call, email, instant message, social network applications 3262. In another embodiment user can view listing or directories of web apps listed on web apps store and search web apps, view details, install, open, add to user created list(s), sort, order, rank, uninstall, share web apps.

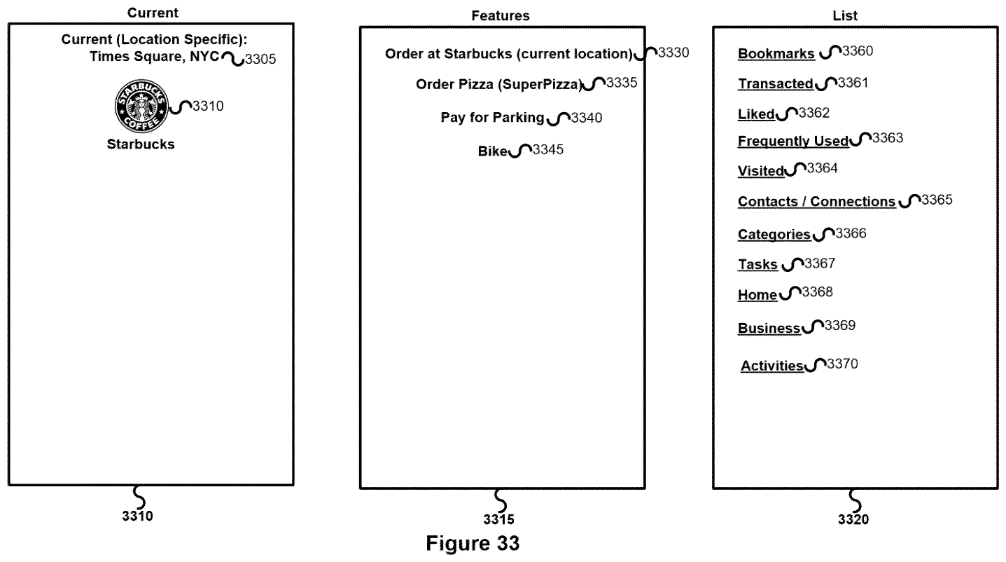

In another embedment FIG. 33 shows displaying list of or automatically installing and opening or invoking currently identified monitored and tracked location or location associated place(s) or place(s) associated type of activities, user device surround identified persons including connected users of user, identified current digital activity, action, tasks, job specific, recognized voice or sound, object, face, QR code specific, current search query, current requirement specific, visited web site, listened music or sound, read content, viewed video, viewed movie at particular place associated theatre, participated event, purchased product or subscribed service (identifying based on monitored and tracked current location, linked or connected systems or databases or applications, user scan, voice, user actions, logged activities, actions, transactions, status, locations, communications, participations) associated web app(s)/PWA(s) or feature(s) or action(s) of web app(s)/PWA(s). FIG. 33 (3320) displays user created or system provided list of service worker or replication worker enabled web apps or PWAs, wherein user can open selected installed web app or in the event of selecting web app(s) (not installed) first time, automatically install and open web app(s).

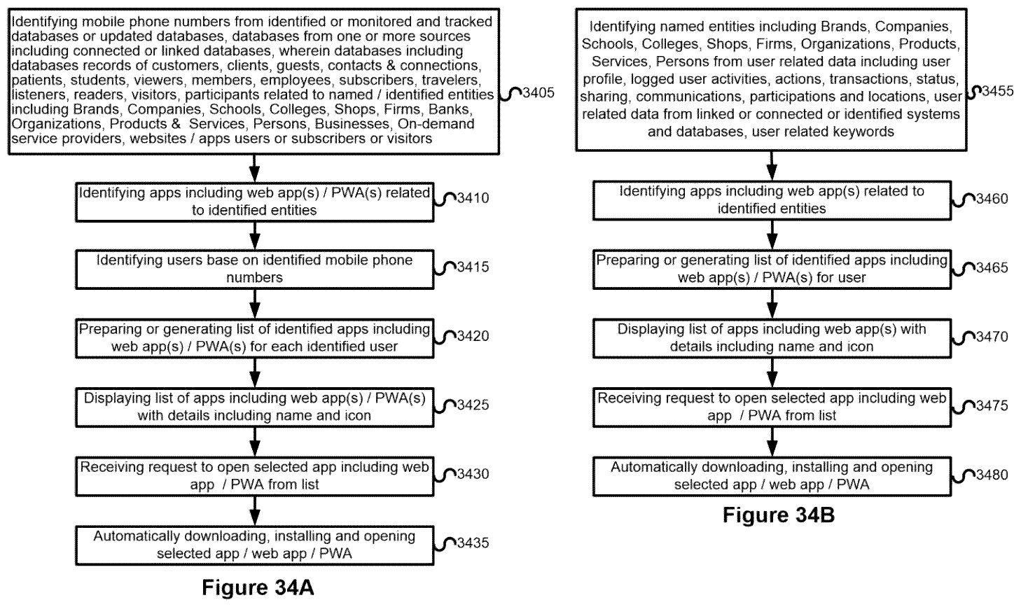

FIG. 34 (A) illustrates flowcharts for describing mass installation of each user relevant apps including web apps/PWAs.

In Step 3405, identifying mobile phone numbers from identified or monitored and tracked databases or updated databases, databases 354 from one or more sources including connected or linked databases, wherein databases including databases records of customers, clients, guests, contacts & connections, patients, students, viewers, members, employees, subscribers, travelers, listeners, readers, visitors, participants related to named/identified entities including Brands, Companies, Schools, Colleges, Shops, Firms, Banks, Organizations, Products & Services, Persons, Businesses, On-demand service providers, websites/apps users or subscribers or visitors. At step 3410 identifying apps including web app(s)/PWA(s) related to identified entities. At step 3415 identifying users based on identified mobile phone numbers. At step 3420,

preparing or generating a list of identified applications including web app(s)/PWA(s) for each identified user. At step 3425, displaying a list of applications 3210 (248) including web app(s)/PWA(s) with details including name and icon. At step 3430, receiving a request to open selected applications including web application/progressive web app (PWA) from list. At step 3435, automatically downloading, installing and opening selected application/web application/PWA (Installing service worker enabled web app and installing replication worker enabled webapp discussed in detail throughout the specification).

FIG. 34 (B) illustrates flowcharts for describing mass installation of each user relevant apps including web apps/PWAs.

In step 3455, Monitoring, tracking, updating and identifying named entities including Brands, Companies, Schools, Colleges, Shops, Firms, Organizations, Products, Services, Persons from user related data or updated data including user profile, user related keywords, logged user activities, actions, transactions, status, sharing, communications, participations and locations, user related data from linked or connected or identified systems, databases, servers, networks, devices. At step 3460, identifying applications including web app(s) related to identified entities. At step 3465, preparing or generating a list of identified apps including web app(s)/PWA(s) for users. At step 3470, displaying a list of applications including web app(s) with details including name and icon. At step 3475, receiving a request to open selected applications including web app/PWA from list. At step 3480, automatically downloading, installing and opening selected application/web application/PWA (Installing service worker enabled web app and installing replication worker enabled webapp discussed in detail throughout the specification).

In an embodiment matching mobile phone numbers of users with mobile phone numbers in identified databases in Blackbox manner (without disclosing data).

In an embodiment automatically uninstalling applications/web apps based on identifying less used apps. In another embodiment due to identifying storage requirements, uninstalling lowest rank wise applications including web apps/PWAs. In an embodiment enabling users to allocate storage space for applications including web apps/PWAs and based on allocated storage space, manually or automatically matching, identifying, downloading, installing and managing including updating and uninstalling web apps/PWAs.

In an embodiment, automatically update applications including web app/PWA based on receiving instruction to open applications including web app/PWA, most used application including web app/PWA.

In some embodiment automatically provides pre-set permissions based on rules including applications including web apps/PWAs having particular types of certificates, ranking, selected name of applications including web apps/PWAs.

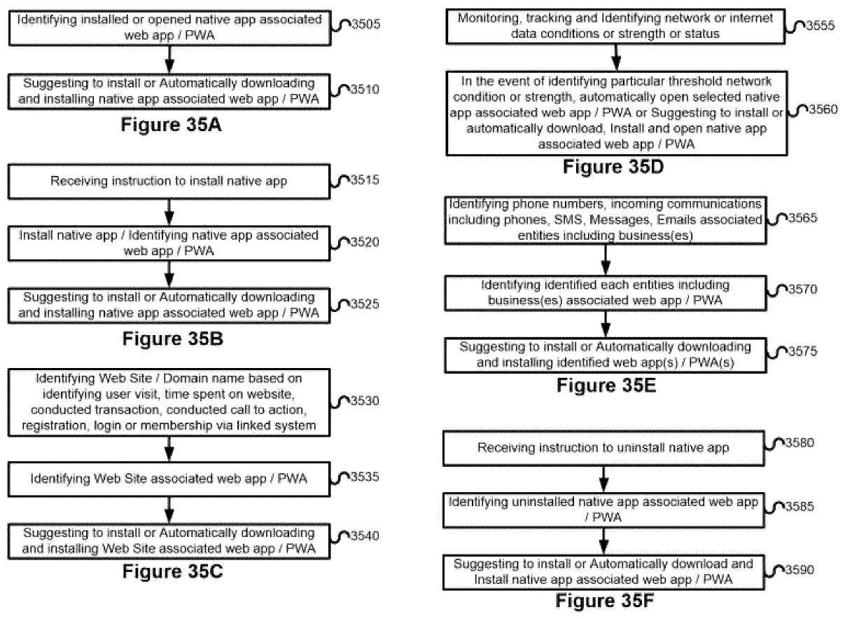

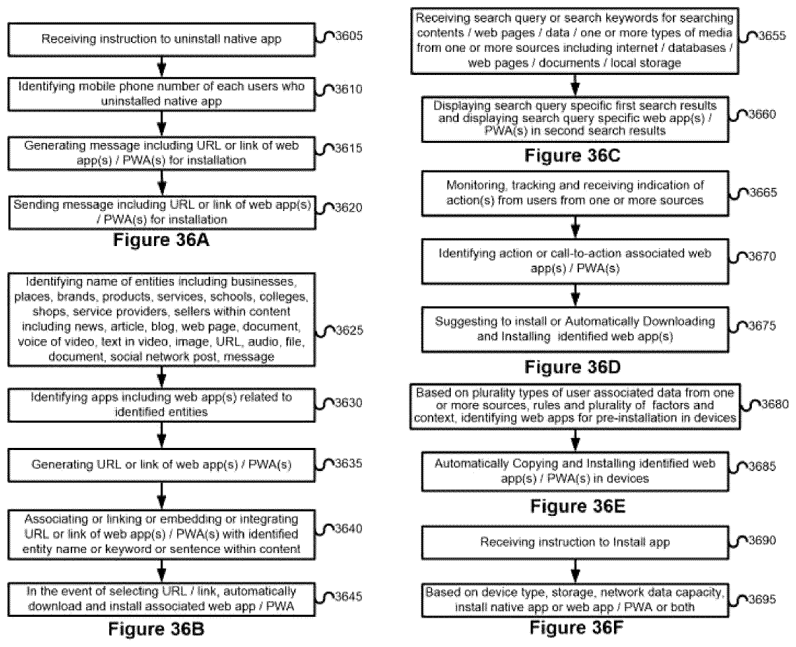

FIG. 35 (A) illustrates flowcharts for describing installing native app associated or web app or progressive web app (PWA) or service worker or replication worker enabled web app or progressive web app (PWA). At step 3505, identifying installed or opened native app associated web app/PWA. At step 3510, automatically/concurrently downloading and installing native app associated web app/PWA.

FIG. 35 (B) illustrates flowcharts for describing installing native app associated or web app or progressive web app (PWA) or service worker or replication worker enabled web app or progressive web app (PWA). At step 3605, receive instruction to install native app. At step 3610, install native app/identifying native app associated web app/PWA. At step 3615, automatically/concurrently downloading and installing native app associated web app/PWA.

FIG. 35 (C) illustrates flowcharts for describing installation of contextual website associated applications including service worker or replication worker enabled web app or progressive web app (PWA). At step 3530, identifying Web Site/Domain name based on identifying user visit at said website or domain, particular time spent on website, conducted transaction, conducted call to action including purchase, reading of article, registration, login or membership, wherein identifying website or domain associated user activities, actions, call-to-actions, transactions via linked or connected or integrated system, component, plug-ins and service. At step 3535, identifying Web Site associated web apps/PWA. At step 3540, automatically download and install Web Site associated web apps/PWA.

FIG. 35 (D) illustrates flowcharts for describing installing applications including service worker or replication worker enabled web app or progressive web app (PWA) based on triggering of one or more types of triggers or rules. At step 3555, monitoring, tracking and identifying network or internet data condition or strength or speed or status. At step 3560, in the event of identifying a particular threshold of network condition or strength or speed, automatically open selected native app associated web app/PWA or download, install and open native app associated web app/PWA.

FIG. 35 (E) illustrates flowcharts for identifying contextual applications including service worker or replication worker enabled web app or progressive web app (PWA). At step 3565, identifying phone numbers, incoming communications including phones, SMS, Messages, Emails associated entities including business(es). At step 3570, identifying each entity including business(es) associated web apps/PWAs. At step 3575, automatically downloading and installing identified web app(s)/PWA(s).

FIG. 35 (F) illustrates flowcharts for installing uninstalled native app associated service worker or replication worker enabled web app or progressive web app (PWA). At step 3580, receive instruction to uninstall native apps. At step 3585, identifying uninstalled native app associated web app/PWA. At step 3590, automatically download and install native app associated web app/PWA.

FIG. 36 (A) illustrates flowcharts describing sent generated messages for installing service worker or replication worker enabled web app or progressive web app (PWA) to users who uninstalled native app(s). At step 3605, receive instruction to uninstall native apps. At step 3610, identify the mobile phone number of each user who uninstalled native app. At step 3615, generate a message including a uniform resource locator (URL) or link of web app(s)/PWA(s) for installation. At step 3620, send a message including a uniform resource locator (URL) or link of web app(s)/PWA(s) for installation.

FIG. 36 (B) illustrates flowcharts describing identifying unique named entities within contents, data, media, web pages, documents, files, video, audio, voice, uniform resource locator (URL), images, messages, posts and folders and identifying associated service worker or replication worker enabled web app or progressive web app (PWA) and embedding or linking uniform resource locator (URL) or link of identified service worker or replication worker enabled web app or progressive web app (PWA) with identified keywords including named entities and enabling viewing user to selecting keyword(s) or keyword(s) associated embedded URL or link to download, installs and open service worker or replication worker enabled web app or progressive web app (PWA). At step 3625, identifying name of entities including businesses, places, brands, products, services, schools, colleges, shops, service providers, person, firm, organization, sellers within content including news, article, blog, web page, document, voice of video, text in video, image, uniform resource locator (URL), audio, file, document, social network post, message. At step 3630, identifying apps including web app(s) related to identified entities. At step 3635, generating a uniform resource locator (URL) or link of web app(s)/PWA(s). At step 3640, associating or linking or embedding or integrating URL or link of web app(s)/PWA(s) with identified entity name or keyword or sentence within content. At step 3645, in the event of selecting uniform resource locator (URL)/link, automatically download and install associated web app/PWA.

FIG. 36 (C) illustrates flowcharts describing displaying search query specific search results and displaying search query specific service worker or replication worker enabled web app or progressive web app (PWA) results. At step 3655, receive search query or search keywords for searching contents/web pages/data/one or more types of media from one or more sources including internet/databases/web pages/documents/local storage. At step 3660, displaying search query specific first search results and displaying search query specific web app(s)/PWA(s) in second search results. In an embodiment enabling searching or viewing user to select one or more web apps/PWAs from search results.

FIG. 36 (D) illustrates flowcharts describing installing user actions or call-to-actions associated service worker or replication worker enabled web apps or progressive web apps (PWAs). At step 3665, monitoring, tracking and receiving indication of action(s) from users from one or more sources including websites, web pages, applications, search results, messages, push notifications, posts, one or more types of contents or media, wherein actions comprises taking of photos, listing of music, viewing of videos, reading of contents, web pages, blogs, documents, and messages receiving and sending of communications including phone or voice call, messages, SMS, and emails, conducting of transactions including buying, ordering, booking, subscribing, reserving tables, getting appointments, registering, become members, log-in, following, reacting (like, dislike, comment) on posts or contents, visiting of places, viewing place(s) details on maps, consuming on-demand services, scanning of objects or QR codes, searching as per search queries (requirements, tasks, transaction intention—purchase, order, book, subscribe products/services/brands/companies/firms/schools/colleges, action or activity intention—view, read, listen, cat, play, learn, participate, shopping, visit places). At step 3670, identifying action or call-to-action associated web app(s)/PWA(s). At step 3675, manually or automatically downloading and installing identified web app(s).

FIG. 36 (E) illustrates flowcharts describing mass installation (pre-installed) of service worker or replication worker enabled web apps or progressive web apps (PWAs) in one or more types of smart devices including smart phones, personal computers, tablets, laptops, digital watches. At step 3680, based on plurality types of user associated data from one or more sources, rules and plurality of factors and context (as discussed in FIG. 34), identifying web apps for pre-installation in devices. At step 3680, automatically copying and installing identified web app(s)/PWA(s) including service worker or replication worker enabled web apps or progressive web apps (PWAs) in smart devices.

FIG. 36 (F) illustrates flowcharts describing in the event of receiving instruction to install an application, based on plurality of rules, factors and triggers, identifying installing of native application or service worker or replication worker enabled web app or progressive web app (PWA) or both. At step 3690, receiving instruction to install a particular application. At step 3695, based on user device type, storage, network data strength or plan or speed, installing either native application or installing service worker or replication worker enabled web app or progressive web app (PWA) or both.

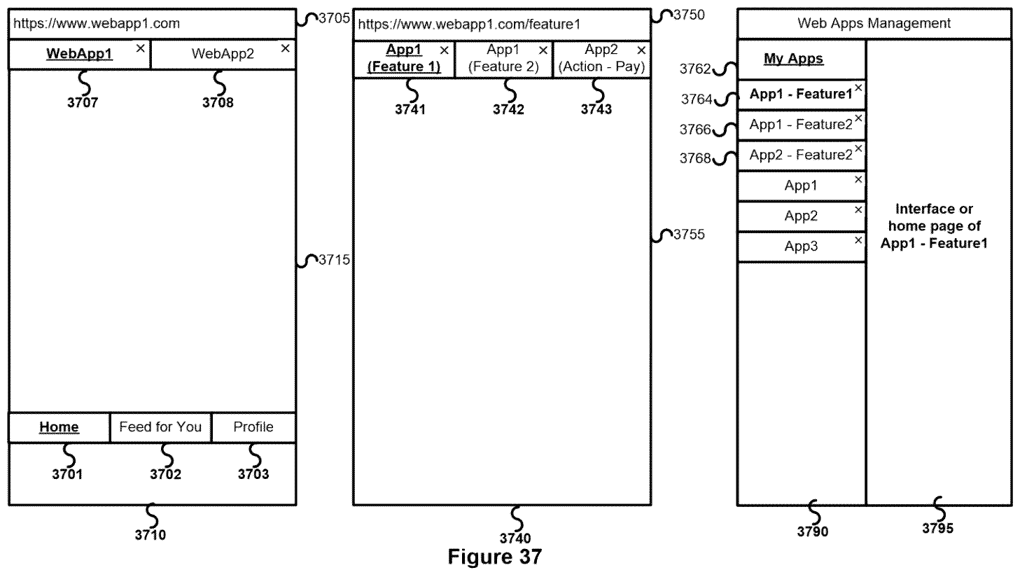

FIG. 37 illustrates app browser or tabular interface or application or user interface or application or parent application, wherein user can search, match, select from one or more types of lists including search result, suggested, bookmarked, liked, frequently used, most ranked or popular or picked or useful, sponsored, used by contacts or connections, visited place associated, used or like to use brands, products and services, interacted or liked entities associated, visited places associated, tasks, activities specific apps, select from categories directories, progressive web application (PWA) or installable web application or service worker or replication worker enabled web app or progressive web app (PWA) or action or feature of web application or particular page of app page or interface of web application and automatically downloading, installing and opening service worker or replication worker enabled web app or progressive web app (PWA).

In an embodiment user can open one or more service worker or replication worker enabled web apps or progressive web apps (PWAs) 3707/3708 and select particular (e.g., first) service worker or replication worker enabled web app or progressive web app (PWA) and navigating different features 3701/3702/3703 of selected first web app in single tab 3707. User can select second service worker or replication worker enabled web app or progressive web app (PWA) 3708 in other tab related to second service worker or replication worker enabled web app or progressive web app (PWA) and access features or app pages or web pages related to second service worker or replication worker enabled web app or progressive web app (PWA). In an embodiment in the event of entering web app uniform resource locator (URL) 3705 in service worker or replication worker enabled web app or progressive web app (PWA) browser or application or user interface, automatically downloading, installing and opening in tab said entered uniform resource locator (URL) 3705 related web application 3707/3708 in associated tab 3707/3708.

In another embodiment enabling developer to prepare one or more features of service worker or replication worker enabled web app or progressive web app (PWA) related single package or different packages or bundles for enabling users to install part or particular or one or more features or actions or call-to-actions or page(s) or interface(s) or app page(s) of web application.

In another embodiment automatically install one or more features or actions or call-to-actions or page(s) or interface(s) or app page(s) of service worker or replication worker enabled web app or progressive web app (PWA) based on monitored and tracked current location of user device, identified current location associated identified place, identified current location associated identified place associated identified type of activities or actions, identified place associated identified logged past activities or actions, type of transactions (purchase, subscribe, book, appointment, book) and associated ranks, identified task, search query, voice search query, requirements based on user related data from one or more sources including user provided or updated and user related data from one or more linked or connected systems, servers, devices, applications, websites and databases. In another embodiment, automatically install and open in tab(s) of app browser 3740 one or more installed web applications or features of web applications 3741/3742/3743.

In an embodiment in the event of entering web app uniform resource locator (URL) 3750 in service worker or replication worker enabled web app or progressive web app (PWA) browser or application or user interface 3740, automatically downloading, installing and opening in tab said entered uniform resource locator (URL) 3750 related particular feature or action or call-to-action or page or interface or app page of web application 3741/3742/3743 in associated tab 3741/3742/3743.

In another embodiment enabling developer of service worker or replication worker enabled web app or progressive web app (PWA) linking via URL or integrating via APIs, one or more web applications and one or more features or actions or interfaces or pages of one or more web applications for workflow, tasks, activities, projects, collaborative or series of tasks related to particular project, plan, business. For example, cab service provider, when commuter reach at destination automatically provide destination place or location related one or more features of one or more applications including book hotel, order food, make payment, provide independent feedback or review, shop products in cab and pick at/from destination related particular store(s), book ticket, reserve table. In another embodiment user can manually view, view app listing details or app profile, select, open (3795), close, minimize, maximize, order, sort, filter, rank, import, share URL(s) or link(s), categories installed 3762/376/3766/3768 (3790) or search, select from search results, directories, lists and view details, select, download, install, uninstall or remove, update, upgrade one or more one or more web applications and one or more features or actions or interfaces or pages of one or more web applications (service worker/replication worker enabled) from one or more sources via one or more mediums. In an embodiment automatically open web app/PWA after installing web app/PWA.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof. Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

1-37. (canceled)

38. A method for information processing, comprising:
a) executing an application program in the running environment, the execution of the application program starting a replication logic process and a first presentation process corresponding to a first view interface of the application program;
b) receiving by the replication logic process, request to access uniform resource locator (URLs) or link(s) of first view interface associated content, files and resources or request to access data;
c) retrieving by the replication logic process, requested URL or link or matched URL or link associated data, content and resources including URL or link of first view interface associated data, content and resources or requested data from local storage or from server or one or more sources based on first replication logic configuration settings of the first view interface;
d) storing or updating, by the replication logic process, retrieved requested URL or link or matched URL or link associated data, content and resources including URL or link of first view interface associated data, content and resources or requested data from server or one or more sources based on first replication logic configuration settings of the first view interface;
e) acquiring, in the replication logic process, first interface data of the first view interface;
f) transferring via the running environment, initial first interface data of the first view interface from the replication logic process that generates the initial first interface data based on first replication logic configuration settings of the first view interface to the first presentation process, wherein further comprising: transferring via the running environment, updated data for a portion of the first view interface from the replication logic process to the first presentation process; and
g) rendering in the first presentation process, the first view interface according to the initial first interface data of the first view interface, wherein further comprising: re-rendering, in the first presentation process, the portion of the first view interface according to the updated data for the portion of the first view interface.

39. The method of claim 38, further comprising:
a) acquiring, in the replication logic process, an event that triggers a switching from the first view interface to a second view interface;
b) receiving by the replication logic process, request to access URL or link including URL or link of second view interface associated data, content and resources or request to access data;
c) retrieving by the replication logic process, requested URL or link or matched URL or link associated data, content and resources including URL or link of second view interface associated data, content and resources or requested data from local storage or from server or one or more sources based on second replication logic configuration settings of the second view interface;
d) storing or updating, by the replication logic process, retrieved requested URL or link or matched URL or link associated data, content and resources including URL or link of second view interface associated data, content and resources or requested data from server or one or more sources based on second replication logic configuration settings of the second view interface;
e) acquiring, in the replication logic process, second interface data of the second view interface;
f) transferring, via the running environment, the second interface data of the second view interface from the replication logic process to a second presentation process corresponding to the second view interface, the execution of the application program in the running environment starting the second presentation process after the first presentation process starts; and
g) rendering, in the second presentation process, the second view interface according to the second interface data of the second view interface.

40. The method of claim 38, further comprising: acquiring, in the running environment, generated global replication logic configuration settings of the application program based on a program identifier of the application program; starting, in the running environment, the logic process and the first view process according to the generated global replication logic configuration settings of the application program; registering, in the logic process, the first generated replication logic configuration settings of the first view page when the logic process of the application program starts; acquiring, in the logic process, the initial first page data of the first view page, according to the generated first replication logic configuration settings, after completion of an initialization in the first view process; and sending, via the running environment, the initial first page data of the first view page, from the logic process to the first view process corresponding to the first view page.

41. The method of claim 38 wherein
a) identifying domain or website uniform resource locator (URL) specific static contents and dynamic data;
b) applying configured one or more types of file and data replication and synchronization models and associated rules related to static contents and dynamic data;
c) receiving and storing static contents in key (request) and values (response) form and dynamic data;
d) receiving request, by the client component, to access uniform resource locator (URL) or link specific web page;
e) identifying, by the client component, requested URL or link specific static contents and dynamic data;
f) generating web page based on requested URL or link specific identified static contents and dynamic data; and
g) rendering web page.

42. The method of claim 38 wherein
a) identifying any types of digital contents or data including selected or automatically identified static contents and dynamic data related to web app for fetching and caching;
b) accessing defined fetching and caching strategy, rules, patterns related visual program including parameters associated values and data replication models related configuration settings;
c) generating code based on defined fetching and caching strategy, rules, patterns related visual program including parameters associated values and data replication models related configuration settings, wherein enabling to edit and merge different generated codes related to different defined fetching and caching strategy, rules, patterns related visual program including parameters associated values and data replication models related configuration settings; and
d) generating file including Service Worker JavaScript file based on generated or edited code wherein registering the service worker; in the event of installing service worker, executing said generated file associated code; based on executed code, accessing or retrieving cached or fetching and caching static contents and dynamic data from client, server or other one or more sources.

43. The method of claim 42 wherein
a) receiving from visual graphical user interface, configuration of caching and fetching of contents and data rules, settings and associated values for selected parameters;
b) generating code for program logic process based on received configuration of caching and fetching of contents and data rules, settings and associated values for selected parameters;
c) executing an application program in the running environment, the execution of the application program starting a program logic process and a first presentation process corresponding to a first view interface of the application program;
d) receiving by the program logic process, request to access URL or link including URL or link of first view interface associated data, content and resources or request to access data;
e) retrieving by the program logic process, requested URL or link or matched URL or link associated data, content and resources including URL or link of first view interface associated data, content and resources or requested data from local storage or from server or one or more sources based on first program logic code of the first view interface;
f) storing or updating, by the program logic process, retrieved requested URL or link or matched URL or link associated data, content and resources including URL or link of first view interface associated data, content and resources or requested data from server or one or more sources based on first program logic code of the first view interface;
g) acquiring, in the program logic process, first interface data of the first view interface;
h) transferring via the running environment, initial first interface data of the first view interface from the program logic process that generates the initial first interface data based on first program logic code of the first view interface to the first presentation process, wherein further comprising: transferring via the running environment, updated data for a portion of the first view interface from the program logic process to the first presentation process; and
i) rendering in the first presentation process, the first view interface according to the initial first interface data of the first view interface, wherein further comprising: re-rendering, in the first presentation process, the portion of the first view interface according to the updated data for the portion of the first view interface.

44. The method of claim 43, further comprising:
a) receiving from visual graphical user interface, configuration of caching and fetching of contents and data rules, settings and associated values for selected parameters;
b) generating code for program logic process based on received configuration of caching and fetching of contents and data rules, settings and associated values for selected parameters;
c) acquiring, in the program logic process, an event that triggers a switching from the first view interface to a second view interface;
d) receiving by the program logic process, request to access URL or link including URL or link of second view interface associated data, content and resources or request to access data;
e) retrieving by the program logic process, requested URL or link or matched URL or link associated data, content and resources including URL or link of second view interface associated data, content and resources or requested data from local storage or from server or one or more sources based on second program logic code of the second view interface;
f) storing or updating, by the program logic process, retrieved requested URL or link or matched URL or link associated data, content and resources including URL or link of second view interface associated data, content and resources or requested data from server or one or more sources based on second program logic code of the second view interface;
g) acquiring, in the program logic process, second interface data of the second view interface;
h) transferring, via the running environment, the second interface data of the second view interface from the program logic process to a second presentation process corresponding to the second view interface, the execution of the application program in the running environment starting the second presentation process after the first presentation process starts; and
i) rendering, in the second presentation process, the second view interface according to the second interface data of the second view interface.

45. The method of claim 44, further comprising: acquiring, in the running environment, generated global configuration codes of the application program based on a program identifier of the application program; starting, in the running environment, the logic process and the first view process according to the generated global configuration codes of the application program; registering, in the logic process, the first generated logic code of the first view page when the logic process of the application program starts; acquiring, in the logic process, the initial first page data of the first view page, according to the generated first logic code, after completion of an initialization in the first view process; and sending, via the running environment, the initial first page data of the first view page, from the logic process to the first view process corresponding to the first view page.

46. The method of claim 45, further comprising: starting, in the running environment, the logic process according to a generated global logic code in the generated global configuration codes of the application program; and starting, in the running environment that is provided by the execution of the application program, the first view process according to a global feature of the first view page that is defined by generated global page configuration codes in the generated global configuration codes of the application program, the generated global page configuration codes defining global features for view pages of the application program.

47. The method of claim 42 wherein
a) identifying any types of digital contents or data including selected or automatically identified static contents and dynamic data related to web app for fetching and caching;
b) accessing fetching and caching strategies, rules, patterns, visual program configuration settings including parameters associated values and fetching and caching strategy and rule or visual program associated defined files and data replication models; and
c) generating configuration file based on fetching and caching strategies, rules, patterns, visual program configuration settings including parameters associated values and fetching and caching strategy and rule or visual program associated defined files and data replication models.

48. A system for information processing, comprising:
a) execute an application program in the running environment, the execution of the application program starting a replication logic process and a first presentation process corresponding to a first view interface of the application program;
b) receive by the replication logic process, request to access uniform resource locator (URLs) or link(s) of first view interface associated content, files and resources or request to access data;
c) retrieve by the replication logic process, requested URL or link or matched URL or link associated data, content and resources including URL or link of first view interface associated data, content and resources or requested data from local storage or from server or one or more sources based on first replication logic configuration settings of the first view interface;
d) store or update, by the replication logic process, retrieved requested URL or link or matched URL or link associated data, content and resources including URL or link of first view interface associated data, content and resources or requested data from server or one or more sources based on first replication logic configuration settings of the first view interface;
e) acquire, in the replication logic process, first interface data of the first view interface;
f) transfer via the running environment, initial first interface data of the first view interface from the replication logic process that generates the initial first interface data based on first replication logic configuration settings of the first view interface to the first presentation process, wherein further comprising: transferring via the running environment, updated data for a portion of the first view interface from the replication logic process to the first presentation process; and
g) render in the first presentation process, the first view interface according to the initial first interface data of the first view interface, wherein further comprising: re-rendering, in the first presentation process, the portion of the first view interface according to the updated data for the portion of the first view interface.

49. The system of claim 48, further comprising:
a) acquire, in the replication logic process, an event that triggers a switching from the first view interface to a second view interface;
b) receive by the replication logic process, request to access URL or link including URL or link of second view interface associated data, content and resources or request to access data;
c) retrieve by the replication logic process, requested URL or link or matched URL or link associated data, content and resources including URL or link of second view interface associated data, content and resources or requested data from local storage or from server or one or more sources based on second replication logic configuration settings of the second view interface;
d) store or update, by the replication logic process, retrieved requested URL or link or matched URL or link associated data, content and resources including URL or link of second view interface associated data, content and resources or requested data from server or one or more sources based on second replication logic configuration settings of the second view interface;
e) acquire, in the replication logic process, second interface data of the second view interface;
f) transfer, via the running environment, the second interface data of the second view interface from the replication logic process to a second presentation process corresponding to the second view interface, the execution of the application program in the running environment starting the second presentation process after the first presentation process starts; and
g) render, in the second presentation process, the second view interface according to the second interface data of the second view interface.

50. The system of claim 48, further comprising: acquire, in the running environment, generated global replication logic configuration settings of the application program based on a program identifier of the application program; start, in the running environment, the logic process and the first view process according to the generated global replication logic configuration settings of the application program; register, in the logic process, the first generated replication logic configuration settings of the first view page when the logic process of the application program starts; acquire, in the logic process, the initial first page data of the first view page, according to the generated first replication logic configuration settings, after completion of an initialization in the first view process; and send, via the running environment, the initial first page data of the first view page, from the logic process to the first view process corresponding to the first view page.

51. The system of claim 48 wherein
a) identify domain or website uniform resource locator (URL) specific static contents and dynamic data;
b) apply configured one or more types of file and data replication and synchronization models and associated rules related to static contents and dynamic data;
c) receive and store static contents in key (request) and values (response) form and dynamic data;
d) receive request, by the client component, to access uniform resource locator (URL) or link specific web page;
e) identify, by the client component, requested URL or link specific static contents and dynamic data;
f) generate web page based on requested URL or link specific identified static contents and dynamic data; and
g) render web page.

52. The system of claim 48 wherein
a) identify any types of digital contents or data including selected or automatically identified static contents and dynamic data related to web app for fetching and caching;
b) access defined fetching and caching strategy, rules, patterns related visual program including parameters associated values and data replication models related configuration settings;
c) generate code based on defined fetching and caching strategy, rules, patterns related visual program including parameters associated values and data replication models related configuration settings, wherein enable to edit and merge different generated codes related to different defined fetching and caching strategy, rules, patterns related visual program including parameters associated values and data replication models related configuration settings; and
d) generate file including Service Worker JavaScript file based on generated or edited code, wherein register the service worker; in the event of installing service worker, execute said generated file associated code; based on executed code, access or retrieve cached or fetching and caching static contents and dynamic data from client, server or other one or more sources.

53. The system of claim 52 wherein
a) receive from visual graphical user interface, configuration of caching and fetching of contents and data rules, settings and associated values for selected parameters;
b) generate code for program logic process based on received configuration of caching and fetching of contents and data rules, settings and associated values for selected parameters;
c) execute an application program in the running environment, the execution of the application program starting a program logic process and a first presentation process corresponding to a first view interface of the application program;
d) receive by the program logic process, request to access URL or link including URL or link of first view interface associated data, content and resources or request to access data;
e) retrieve by the program logic process, requested URL or link or matched URL or link associated data, content and resources including URL or link of first view interface associated data, content and resources or requested data from local storage or from server or one or more sources based on first program logic code of the first view interface;
f) store or update, by the program logic process, retrieved requested URL or link or matched URL or link associated data, content and resources including URL or link of first view interface associated data, content and resources or requested data from server or one or more sources based on first program logic code of the first view interface;
g) acquire, in the program logic process, first interface data of the first view interface;
h) transfer via the running environment, initial first interface data of the first view interface from the program logic process that generates the initial first interface data based on first program logic code of the first view interface to the first presentation process, wherein further comprising: transferring via the running environment, updated data for a portion of the first view interface from the program logic process to the first presentation process; and
i) render in the first presentation process, the first view interface according to the initial first interface data of the first view interface, wherein further comprising: re-rendering, in the first presentation process, the portion of the first view interface according to the updated data for the portion of the first view interface.

54. The system of claim 53, further comprising:
a) receive from visual graphical user interface, configuration of caching and fetching of contents and data rules, settings and associated values for selected parameters;
b) generate code for program logic process based on received configuration of caching and fetching of contents and data rules, settings and associated values for selected parameters;
c) acquire, in the program logic process, an event that triggers a switching from the first view interface to a second view interface;
d) receive by the program logic process, request to access URL or link including URL or link of second view interface associated data, content and resources or request to access data;
e) retrieve by the program logic process, requested URL or link or matched URL or link associated data, content and resources including URL or link of second view interface associated data, content and resources or requested data from local storage or from server or one or more sources based on second program logic code of the second view interface;
f) store or update, by the program logic process, retrieved requested URL or link or matched URL or link associated data, content and resources including URL or link of second view interface associated data, content and resources or requested data from server or one or more sources based on second program logic code of the second view interface;
g) acquire, in the program logic process, second interface data of the second view interface;
h) transfer, via the running environment, the second interface data of the second view interface from the program logic process to a second presentation process corresponding to the second view interface, the execution of the application program in the running environment starting the second presentation process after the first presentation process starts; and
i) render, in the second presentation process, the second view interface according to the second interface data of the second view interface.

55. The system of claim 54, further comprising: acquire, in the running environment, generated global configuration codes of the application program based on a program identifier of the application program; start, in the running environment, the logic process and the first view process according to the generated global configuration codes of the application program; register, in the logic process, the first generated logic code of the first view page when the logic process of the application program starts; acquire, in the logic process, the initial first page data of the first view page, according to the generated first logic code, after completion of an initialization in the first view process; and send, via the running environment, the initial first page data of the first view page, from the logic process to the first view process corresponding to the first view page.

56. The system of claim 55, further comprising: start, in the running environment, the logic process according to a generated global logic code of the application program; and start, in the running environment that is provided by the execution of the application program, the first view process according to a global feature of the first view page that is defined by generated global page configuration codes of the application program, the generated global page configuration codes defining global features for view pages of the application program.

57. The system of claim 52 wherein
a) identify any types of digital contents or data including selected or automatically identified static contents and dynamic data related to web app for fetching and caching;
b) access fetching and caching strategies, rules, patterns, visual program configuration settings including parameters associated values and fetching and caching strategy and rule or visual program associated defined files and data replication models; and
c) generate configuration file based on fetching and caching strategies, rules, patterns, visual program configuration settings including parameters associated values and fetching and caching strategy and rule or visual program associated defined files and data replication models.
